(19) United States
(12) Patent Application Publication
(10) Pub. No.: US 2026/0037721 A1
(43) Pub. Date: Feb. 5, 2026

(54) ACCOUNT MANAGEMENT

(71) Applicant: Apple Inc., Cupertino, CA (US)

(72) Inventors: Thomas J. MILLER, San Jose, CA (US); Ryan H. DEPAOLA, San Francisco, CA (US); Allie M. PERRY, San Jose, CA (US); Matthew C. SANDERS, Santa Clara, CA (US)

(21) Appl. No.: 19/355,959

(22) Filed: Oct. 10, 2025

Related U.S. Application Data
(63) Continuation of application No. 18/195,855, filed on May 10, 2023.
(60) Provisional application No. 63/340,916, filed on May 11, 2022.
(60) Provisional application No. 63/349,137, filed on Jun. 5, 2022.
(60) Provisional application No. 63/404,172, filed on Sep. 6, 2022.

(51) Int. Cl. G06F 40/174; G06F 3/04842; G06Q 20/10; G06Q 20/36; G06Q 20/38; G06Q 20/40

(52) U.S. Cl. CPC G06F 40/174; G06F 3/04842; G06Q 20/10; G06Q 20/36; G06Q 20/3821; G06Q 20/4014

(57) ABSTRACT

The present disclosure generally relates to account management. In some examples, an account is provisioned onto the computer system. In some examples, an account is used for performing an autofill operation. In some examples, order information is presented to the user. In some examples, input is received to apply future rewards to a specified account. In some examples, awards are displayed.

### CROSS-REFERENCE TO RELATED APPLICATIONS

This application is a Continuation of U.S. Non-Provisional patent application Ser. No. 18/195,855, entitled “ACCOUNT MANAGEMENT,” filed on May 10, 2023, which claims priority to U.S. Provisional Patent Application Ser. No. 63/340,916, entitled “ACCOUNT MANAGEMENT,” filed on May 11, 2022, U.S. Provisional Patent Application Ser. No. 63/349,137, filed Jun. 5, 2022, titled “ACCOUNT MANAGEMENT,” and U.S. Provisional Patent Application Ser. No. 63/404,172, filed Sep. 6, 2022, titled “ACCOUNT MANAGEMENT,” the contents of which are each hereby incorporated by reference in their entirety.

### FIELD

The present disclosure relates generally to computer user interfaces, and more specifically to techniques for managing accounts.

### BACKGROUND

Electronic devices often include account information for various accounts. The account information of the various accounts can made available for use in various ways, such as through submission via a website and/or transmission via near-field communications.

### BRIEF SUMMARY

Some techniques for managing accounts using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing accounts. Such methods and interfaces optionally complement or replace other methods for managing accounts. Such methods and interfaces reduce the cognitive burden on a user and produce a more efficient human-machine interface. For battery-operated computing devices, such methods and interfaces conserve power and increase the time between battery charges.

Example methods are described herein. An example method includes, at a computer system that is in communication with a display generation component and one or more input devices: concurrently displaying, via the display generation component, a portion of a first visual representation corresponding to a first asset account that has been provisioned onto an electronic wallet of the computer system and a portion of a second visual representation, different from the first visual representation, corresponding to a second asset account that has been provisioned onto an electronic wallet of the computer system and that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account: in accordance with a determination that a set of virtual account criteria are met, wherein a first virtual account criterion of the set of virtual account criteria is met when a virtual account feature is not enabled for the first asset account, displaying, via the display generation component, a first selectable user interface object for initiating a process to enable the virtual account feature for the first asset account, wherein: when the virtual account feature is not enabled for the first asset account, the computer system automatically uses the same credential information for consecutive transactions performed using the first asset account, and when the virtual account feature is enabled for the first asset account, the computer system automatically uses different credential information for consecutive transactions performed using the first asset account; and in accordance with a determination that the set of virtual account criteria are not met, forgoing display of the first selectable user interface object for initiating a process to enable the virtual account feature for the first asset account; while displaying, via the display generation component, the first selectable user interface object displayed in response to receiving selection of the first visual representation, receiving, via the one or more input devices, selection of the first selectable user interface object; and in response to receiving selection of the first selectable user interface object, initiating a process to enable the virtual account feature for the first asset account.

An example method includes, at a computer system that is in communication with a display generation component and one or more input devices: displaying, via the display generation component, a provisioning user interface that includes: an indication that one or more accounts are enabled for performing an application autofill operation at the computer system and are not provisioned onto an electronic wallet of the computer system; and a first selectable user interface object for initiating a process to provision the one or more accounts onto the electronic wallet of the computer system; receiving, via the one or more input devices, selection of the first selectable user interface object; in response to receiving selection of the first selectable user interface object, initiating a process to provision a first account of the one or more accounts onto the electronic wallet of the computer system, wherein the process to provision the first account of the one or more accounts onto the electronic wallet of the computer system uses at least some account information about the first account, wherein the account information is stored for use in the application autofill operation; and subsequent to receiving selection of the first selectable user interface object, provisioning the first account onto the electronic wallet of the computer system using at least some account information about the first account, wherein the account information is stored for use in the application autofill operation.

An example method includes, at a computer system that is in communication with a display generation component and one or more input devices: displaying, via the display generation component, a plurality of selectable user interface objects, including: a first selectable user interface object that corresponds to a first account that is provisioned onto an electronic wallet of the computer system; and a second selectable user interface object that corresponds to a second account, different from the first account, that is enabled for performing an application autofill operation at the computer system and is not provisioned onto an electronic wallet of the computer system; receiving, via the one or more input devices, a user input selecting one of the plurality of selectable user interface objects; and in response to receiving the user input selecting one of the plurality of selectable user interface objects: in accordance with a determination that the user input corresponds to selection of the first selectable user interface object, initiating a process to perform an autofill operation to populate one or more fields using credentials of the first account, wherein credentials of the first account populated into a first field of the one or more fields are visually obfuscated; and in accordance with a determination that the user input corresponds to selection of the second selectable user interface object, initiating a process to perform an autofill operation to populate one or more fields using credentials of the second account, wherein credentials of the second account populated into a first field of the one or more fields are not visually obfuscated.

An example method includes, at a computer system that is in communication with a display generation component, one or more input devices, and one or more communication radios: displaying, via the display generation component, a user interface of an electronic wallet application that includes concurrent display of a plurality of selectable user interface objects, including: a first selectable user interface object that corresponds to a first account that is provisioned onto an electronic wallet of the computer system, wherein the computer system is configured to perform, using near-field communication via the one or more communication radios, transfers using the first account; a second selectable user interface object that corresponds to a second account, different from the first account, that is provisioned onto the electronic wallet of the computer system, wherein the computer system is configured to perform, using near-field communication via the one or more communication radios, transfers using the second account; and an order tracking user interface object for tracking order statuses; receiving a first user input selecting one of the plurality of selectable user interface objects; in response to receiving the first user input selecting one of the plurality of selectable user interface objects: in accordance with a determination that the first user input corresponds to selection of the first selectable user interface object, ceasing to display the second selectable user interface object and displaying, via the display generation component, information about one or more transfers performed using the first account; and in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant; while displaying the plurality of summaries of orders, receiving, via the one or more input devices, a second user input selecting one of the plurality of summaries of orders; and in response to receiving the second user input selecting one of the plurality of summaries of orders: in accordance with a determination that the second user input corresponds to selection of the first summary of the first order, displaying, via the display generation component and using a predefined arrangement, order tracking details of the first order; and in accordance with a determination that the second user input corresponds to selection of the second summary of the second order, displaying, via the display generation component and using the predefined arrangement, order tracking details of the second order.

An example method includes, at a computer system that is in communication with a display generation component, one or more input devices, and one or more communication radios, displaying, via the display generation component, a plurality of selectable user interface options for applying future rewards of a first asset account, including: a first selectable option for applying the future rewards of the first asset account to a second asset account, wherein the computer system is configured to perform, using near-field communication via the one or more communication radios, transfers using the second asset account that is different from the first asset account; and a second selectable option for applying the future rewards of the first asset account to a third asset account that is different from the first asset account and the second asset account; receiving, via the one or more input devices, a first user input selecting one of the plurality of selectable user interface options for applying future rewards of the first asset account to a respective asset account; in response to receiving the first user input selecting one of the plurality of selectable user interface options: in accordance with a determination that the first user input corresponds to selection of the first selectable option, initiating a process for applying future rewards of the first asset account to the second asset account; and in accordance with a determination that the first user input corresponds to selection of the second selectable option, initiating a process for applying future rewards of the first asset account to the third asset account; subsequent to completing the process for applying future rewards of the first asset account to a respective account, performing, using near-field communication via the one or more communication radios, a transfer using the first asset account, wherein a reward based on the transfer using the first asset account is applied to the respective account; and displaying, via the display generation component, a balance of the respective account that includes the applied reward.

An example method includes, at a computer system that is in communication with a display generation component and one or more communication radios, concurrently displaying, via the display generation component: a total amount of lifetime reward received for a first asset account that is provisioned onto an electronic wallet of the computer system, wherein the first asset account and a second asset account have been provisioned onto an electronic wallet of the computer system; and a visual object corresponding to the total amount of lifetime reward received for the first asset account, wherein a first portion of the visual object that corresponds to a first type of reward received for the first asset account is visually differentiated from a second portion of the visual object that corresponds to a second type of reward received for the first asset account, wherein: an area of the first portion of the visual object is a first size that is based on an amount of the first type of reward received relative to the total amount of lifetime reward received for the first asset account, and an area of the second portion of the visual object is a second size that is based on an amount of the second type of reward received relative to the total amount of lifetime reward received for the first asset account; subsequent to concurrently displaying the total amount of lifetime reward received for the first asset account and the visual object corresponding to the total amount of lifetime reward received for the first asset account: performing, via the one or more communication radios, a first transfer using the first asset account; and performing, via the one or more communication radios, a second transfer using the second asset account; and subsequent to performing the first transfer and the second transfer, concurrently displaying, via the display generation component: the total amount of lifetime reward received for the first asset account, wherein the total amount of lifetime reward is updated to include a reward received based on the first transfer without including any reward received based on the second transfer; and the visual object corresponding to the updated total amount of lifetime reward received for the first asset account, wherein: the area of the first portion of the visual object is updated to a third size that is larger than the first size, the third size being based on the reward received based on the first transfer corresponding to the first type of reward; and the area of the second portion of the visual object is updated to a fourth size that is smaller than the second size, the fourth size being based on the reward received based on the first transfer not corresponding to the second type of reward.

Example E non-transitory computer-readable storage media are described herein. An example non-transitory computer-readable storage medium stores one or more programs configured to be executed by one or more processors of a computer system that is in communication with a display generation component and one or more input devices and includes instructions for: concurrently displaying, via the display generation component, a portion of a first visual representation corresponding to a first asset account that has been provisioned onto an electronic wallet of the computer system and a portion of a second visual representation, different from the first visual representation, corresponding to a second asset account that has been provisioned onto an electronic wallet of the computer system and that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account: in accordance with a determination that a set of virtual account criteria are met, wherein a first virtual account criterion of the set of virtual account criteria is met when a virtual account feature is not enabled for the first asset account, displaying, via the display generation component, a first selectable user interface object for initiating a process to enable the virtual account feature for the first asset account, wherein: when the virtual account feature is not enabled for the first asset account, the computer system automatically uses the same credential information for consecutive transactions performed using the first asset account, and when the virtual account feature is enabled for the first asset account, the computer system automatically uses different credential information for consecutive transactions performed using the first asset account; and in accordance with a determination that the set of virtual account criteria are not met, forgoing display of the first selectable user interface object for initiating a process to enable the virtual account feature for the first asset account; while displaying, via the display generation component, the first selectable user interface object displayed in response to receiving selection of the first visual representation, receiving, via the one or more input devices, selection of the first selectable user interface object; and in response to receiving selection of the first selectable user interface object, initiating a process to enable the virtual account feature for the first asset account.

An example non-transitory computer-readable storage medium stores one or more programs configured to be executed by one or more processors of a computer system that is in communication with a display generation component and one or more input devices and includes instructions for: displaying, via the display generation component, a provisioning user interface that includes: an indication that one or more accounts are enabled for performing an application autofill operation at the computer system and are not provisioned onto an electronic wallet of the computer system; and a first selectable user interface object for initiating a process to provision the one or more accounts onto the electronic wallet of the computer system; receiving, via the one or more input devices, selection of the first selectable user interface object; in response to receiving selection of the first selectable user interface object, initiating a process to provision a first account of the one or more accounts onto the electronic wallet of the computer system, wherein the process to provision the first account of the one or more accounts onto the electronic wallet of the computer system uses at least some account information about the first account, wherein the account information is stored for use in the application autofill operation; and subsequent to receiving selection of the first selectable user interface object, provisioning the first account onto the electronic wallet of the computer system using at least some account information about the first account, wherein the account information is stored for use in the application autofill operation.

An example non-transitory computer-readable storage medium stores one or more programs configured to be executed by one or more processors of a computer system that is in communication with a display generation component and one or more input devices and includes instructions for: displaying, via the display generation component, a plurality of selectable user interface objects, including: a first selectable user interface object that corresponds to a first account that is provisioned onto an electronic wallet of the computer system; and a second selectable user interface object that corresponds to a second account, different from the first account, that is enabled for performing an application autofill operation at the computer system and is not provisioned onto an electronic wallet of the computer system; receiving, via the one or more input devices, a user input selecting one of the plurality of selectable user interface objects; and in response to receiving the user input selecting one of the plurality of selectable user interface objects: in accordance with a determination that the user input corresponds to selection of the first selectable user interface object, initiating a process to perform an autofill operation to populate one or more fields using credentials of the first account, wherein credentials of the first account populated into a first field of the one or more fields are visually obfuscated; and in accordance with a determination that the user input corresponds to selection of the second selectable user interface object, initiating a process to perform an autofill operation to populate one or more fields using credentials of the second account, wherein credentials of the second account populated into a first field of the one or more fields are not visually obfuscated.

An example non-transitory computer-readable storage medium stores one or more programs configured to be executed by one or more processors of a computer system that is in communication with a display generation component, one or more input devices, and one or more communication radios and includes instructions for: displaying, via the display generation component, a user interface of an electronic wallet application that includes concurrent display of a plurality of selectable user interface objects, including: a first selectable user interface object that corresponds to a first account that is provisioned onto an electronic wallet of the computer system, wherein the computer system is configured to perform, using near-field communication via the one or more communication radios, transfers using the first account; a second selectable user interface object that corresponds to a second account, different from the first account, that is provisioned onto the electronic wallet of the computer system, wherein the computer system is configured to perform, using near-field communication via the one or more communication radios, transfers using the second account; and an order tracking user interface object for tracking order statuses; receiving a first user input selecting one of the plurality of selectable user interface objects; in response to receiving the first user input selecting one of the plurality of selectable user interface objects: in accordance with a determination that the first user input corresponds to selection of the first selectable user interface object, ceasing to display the second selectable user interface object and displaying, via the display generation component, information about one or more transfers performed using the first account; and in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant; while displaying the plurality of summaries of orders, receiving, via the one or more input devices, a second user input selecting one of the plurality of summaries of orders; and in response to receiving the second user input selecting one of the plurality of summaries of orders: in accordance with a determination that the second user input corresponds to selection of the first summary of the first order, displaying, via the display generation component and using a predefined arrangement, order tracking details of the first order; and in accordance with a determination that the second user input corresponds to selection of the second summary of the second order, displaying, via the display generation component and using the predefined arrangement, order tracking details of the second order.

An example non-transitory computer-readable storage medium stores one or more programs configured to be executed by one or more processors of a computer system that is in communication with a display generation component, one or more input devices, and one or more communication radios and includes instructions for: displaying, via the display generation component, a plurality of selectable user interface options for applying future rewards of a first asset account, including: a first selectable option for applying the future rewards of the first asset account to a second asset account, wherein the computer system is configured to perform, using near-field communication via the one or more communication radios, transfers using the second asset account that is different from the first asset account; and a second selectable option for applying the future rewards of the first asset account to a third asset account that is different from the first asset account and the second asset account; receiving, via the one or more input devices, a first user input selecting one of the plurality of selectable user interface options for applying future rewards of the first asset account to a respective asset account; in response to receiving the first user input selecting one of the plurality of selectable user interface options: in accordance with a determination that the first user input corresponds to selection of the first selectable option, initiating a process for applying future rewards of the first asset account to the second asset account; and in accordance with a determination that the first user input corresponds to selection of the second selectable option, initiating a process for applying future rewards of the first asset account to the third asset account; subsequent to completing the process for applying future rewards of the first asset account to a respective account, performing, using near-field communication via the one or more communication radios, a transfer using the first asset account, wherein a reward based on the transfer using the first asset account is applied to the respective account; and displaying, via the display generation component, a balance of the respective account that includes the applied reward.

An example non-transitory computer-readable storage medium stores one or more programs configured to be executed by one or more processors of a computer system that is in communication with a display generation component and one or more communication radios and amount of lifetime reward received for a first asset account that is provisioned onto an electronic wallet of the computer system, wherein the first asset account and a second asset account have been provisioned onto an electronic wallet of the computer system; and a visual object corresponding to the total amount of lifetime reward received for the first asset account, wherein a first portion of the visual object that corresponds to a first type of reward received for the first asset account is visually differentiated from a second portion of the visual object that corresponds to a second type of reward received for the first asset account, wherein: an area of the first portion of the visual object is a first size that is based on an amount of the first type of reward received relative to the total amount of lifetime reward received for the first asset account, and an area of the second portion of the visual object is a second size that is based on an amount of the second type of reward received relative to the total amount of lifetime reward received for the first asset account; subsequent to concurrently displaying the total amount of lifetime reward received for the first asset account and the visual object corresponding to the total amount of lifetime reward received for the first asset account: performing, via the one or more communication radios, a first transfer using the first asset account; and performing, via the one or more communication radios, a second transfer using the second asset account; and subsequent to performing the first transfer and the second transfer, concurrently displaying, via the display generation component: the total amount of lifetime reward received for the first asset account, wherein the total amount of lifetime reward is updated to include a reward received based on the first transfer without including any reward received based on the second transfer; and the visual object corresponding to the updated total amount of lifetime reward received for the first asset account, wherein: the area of the first portion of the visual object is updated to a third size that is larger than the first size, the third size being based on the reward received based on the first transfer corresponding to the first type of reward; and the area of the second portion of the visual object is updated to a fourth size that is smaller than the second size, the fourth size being based on the reward received based on the first transfer not corresponding to the second type of reward.

Example transitory computer-readable storage media are described herein. An example transitory computer-readable storage medium stores one or more programs configured to be executed by one or more processors of a computer system that is in communication with a display generation component and one or more input devices and includes instructions for: concurrently displaying, via the display generation component, a portion of a first visual representation corresponding to a first asset account that has been provisioned onto an electronic wallet of the computer system and a portion of a second visual representation, different from the first visual representation, corresponding to a second asset account that has been provisioned onto an electronic wallet of the computer system and that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account: in accordance with a determination that a set of virtual account criteria are met, wherein a first virtual account criterion of the set of virtual account criteria is met when a virtual account feature is not enabled for the first asset account, displaying, via the display generation component, a first selectable user interface object for initiating a process to enable the virtual account feature for the first asset account, wherein: when the virtual account feature is not enabled for the first asset account, the computer system automatically uses the same credential information for consecutive transactions performed using the first asset account, and when the virtual account feature is enabled for the first asset account, the computer system automatically uses different credential information for consecutive transactions performed using the first asset account; and in accordance with a determination that the set of virtual account criteria are not met, forgoing display of the first selectable user interface object for initiating a process to enable the virtual account feature for the first asset account; while displaying, via the display generation component, the first selectable user interface object displayed in response to receiving selection of the first visual representation, receiving, via the one or more input devices, selection of the first selectable user interface object; and in response to receiving selection of the first selectable user interface object, initiating a process to enable the virtual account feature for the first asset account.

An example transitory computer-readable storage medium stores one or more programs configured to be executed by one or more processors of a computer system that is in communication with a display generation component and one or more input devices and includes instructions for: displaying, via the display generation component, a provisioning user interface that includes: an indication that one or more accounts are enabled for performing an application autofill operation at the computer system and are not provisioned onto an electronic wallet of the computer system; and a first selectable user interface object for initiating a process to provision the one or more accounts onto the electronic wallet of the computer system; receiving, via the one or more input devices, selection of the first selectable user interface object; in response to receiving selection of the first selectable user interface object, initiating a process to provision a first account of the one or more accounts onto the electronic wallet of the computer system, wherein the process to provision the first account of the one or more accounts onto the electronic wallet of the computer system uses at least some account information about the first account, wherein the account information is stored for use in the application autofill operation; and subsequent to receiving selection of the first selectable user interface object, provisioning the first account onto the electronic wallet of the computer system using at least some account information about the first account, wherein the account information is stored for use in the application autofill operation.

An example transitory computer-readable storage medium stores one or more programs configured to be executed by one or more processors of a computer system that is in communication with a display generation component and one or more input devices and includes instructions for: displaying, via the display generation component, a plurality of selectable user interface objects, including: a first selectable user interface object that corresponds to a first account that is provisioned onto an electronic wallet of the computer system; and a second selectable user interface object that corresponds to a second account, different from the first account, that is enabled for performing an application autofill operation at the computer system and is not provisioned onto an electronic wallet of the computer system; receiving, via the one or more input devices, a user input selecting one of the plurality of selectable user interface objects; and in response to receiving the user input selecting one of the plurality of selectable user interface objects: in accordance with a determination that the user input corresponds to selection of the first selectable user interface object, initiating a process to perform an autofill operation to populate one or more fields using credentials of the first account, wherein credentials of the first account populated into a first field of the one or more fields are visually obfuscated; and in accordance with a determination that the user input corresponds to selection of the second selectable user interface object, initiating a process to perform an autofill operation to populate one or more fields using credentials of the second account, wherein credentials of the second account populated into a first field of the one or more fields are not visually obfuscated.

An example transitory computer-readable storage medium stores one or more programs configured to be executed by one or more processors of a computer system that is in communication with a display generation component, one or more input devices, and one or more communication radios and includes instructions for: displaying, via the display generation component, a user interface of an electronic wallet application that includes concurrent display of a plurality of selectable user interface objects, including: a first selectable user interface object that corresponds to a first account that is provisioned onto an electronic wallet of the computer system, wherein the computer system is configured to perform, using near-field communication via the one or more communication radios, transfers using the first account; a second selectable user interface object that corresponds to a second account, different from the first account, that is provisioned onto the electronic wallet of the computer system, wherein the computer system is configured to perform, using near-field communication via the one or more communication radios, transfers using the second account; and an order tracking user interface object for tracking order statuses; receiving a first user input selecting one of the plurality of selectable user interface objects; in response to receiving the first user input selecting one of the plurality of selectable user interface objects: in accordance with a determination that the first user input corresponds to selection of the first selectable user interface object, ceasing to display the second selectable user interface object and displaying, via the display generation component, information about one or more transfers performed using the first account; and in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant; while displaying the plurality of summaries of orders, receiving, via the one or more input devices, a second user input selecting one of the plurality of summaries of orders; and in response to receiving the second user input selecting one of the plurality of summaries of orders: in accordance with a determination that the second user input corresponds to selection of the first summary of the first order, displaying, via the display generation component and using a predefined arrangement, order tracking details of the first order; and in accordance with a determination that the second user input corresponds to selection of the second summary of the second order, displaying, via the display generation component and using the predefined arrangement, order tracking details of the second order.

An example transitory computer-readable storage medium stores one or more programs configured to be executed by one or more processors of a computer system that is in communication with a display generation component, one or more input devices, and one or more communication radios and includes instructions for: displaying, via the display generation component, a plurality of selectable user interface options for applying future rewards of a first asset account, including: a first selectable option for applying the future rewards of the first asset account to a second asset account, wherein the computer system is configured to perform, using near-field communication via the one or more communication radios, transfers using the second asset account that is different from the first asset account; and a second selectable option for applying the future rewards of the first asset account to a third asset account that is different from the first asset account and the second asset account; receiving, via the one or more input devices, a first user input selecting one of the plurality of selectable user interface options for applying future rewards of the first asset account to a respective asset account; in response to receiving the first user input selecting one of the plurality of selectable user interface options: in accordance with a determination that the first user input corresponds to selection of the first selectable option, initiating a process for applying future rewards of the first asset account to the second asset account; and in accordance with a determination that the first user input corresponds to selection of the second selectable option, initiating a process for applying future rewards of the first asset account to the third asset account; subsequent to completing the process for applying future rewards of the first asset account to a respective account, performing, using near-field communication via the one or more communication radios, a transfer using the first asset account, wherein a reward based on the transfer using the first asset account is applied to the respective account; and displaying, via the display generation component, a balance of the respective account that includes the applied reward.

An example transitory computer-readable storage medium stores one or more programs configured to be executed by one or more processors of a computer system that is in communication with a display generation component and one or more communication radios and amount of lifetime reward received for a first asset account that is provisioned onto an electronic wallet of the computer system, wherein the first asset account and a second asset account have been provisioned onto an electronic wallet of the computer system; and a visual object corresponding to the total amount of lifetime reward received for the first asset account, wherein a first portion of the visual object that corresponds to a first type of reward received for the first asset account is visually differentiated from a second portion of the visual object that corresponds to a second type of reward received for the first asset account, wherein: an area of the first portion of the visual object is a first size that is based on an amount of the first type of reward received relative to the total amount of lifetime reward received for the first asset account, and an area of the second portion of the visual object is a second size that is based on an amount of the second type of reward received relative to the total amount of lifetime reward received for the first asset account; subsequent to concurrently displaying the total amount of lifetime reward received for the first asset account and the visual object corresponding to the total amount of lifetime reward received for the first asset account: performing, via the one or more communication radios, a first transfer using the first asset account; and performing, via the one or more communication radios, a second transfer using the second asset account; and subsequent to performing the first transfer and the second transfer, concurrently displaying, via the display generation component: the total amount of lifetime reward received for the first asset account, wherein the total amount of lifetime reward is updated to include a reward received based on the first transfer without including any reward received based on the second transfer; and the visual object corresponding to the updated total amount of lifetime reward received for the first asset account, wherein: the area of the first portion of the visual object is updated to a third size that is larger than the first size, the third size being based on the reward received based on the first transfer corresponding to the first type of reward; and the area of the second portion of the visual object is updated to a fourth size that is smaller than the second size, the fourth size being based on the reward received based on the first transfer not corresponding to the second type of reward.

Example computer systems are described herein. An example computer system is configured to communicate with a display generation component and one or more input devices and includes: one or more processors; and memory storing one or more programs configured to be executed by the one or more processors, the one or more programs including instructions for: concurrently displaying, via the display generation component, a portion of a first visual representation corresponding to a first asset account that has been provisioned onto an electronic wallet of the computer system and a portion of a second visual representation, different from the first visual representation, corresponding to a second asset account that has been provisioned onto an electronic wallet of the computer system and that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account: in accordance with a determination that a set of virtual account criteria are met, wherein a first virtual account criterion of the set of virtual account criteria is met when a virtual account feature is not enabled for the first asset account, displaying, via the display generation component, a first selectable user interface object for initiating a process to enable the virtual account feature for the first asset account, wherein: when the virtual account feature is not enabled for the first asset account, the computer system automatically uses the same credential information for consecutive transactions performed using the first asset account, and when the virtual account feature is enabled for the first asset account, the computer system automatically uses different credential information for consecutive transactions performed using the first asset account; and in accordance with a determination that the set of virtual account criteria are not met, forgoing display of the first selectable user interface object for initiating a process to enable the virtual account feature for the first asset account; while displaying, via the display generation component, the first selectable user interface object displayed in response to receiving selection of the first visual representation, receiving, via the one or more input devices, selection of the first selectable user interface object; and in response to receiving selection of the first selectable user interface object, initiating a process to enable the virtual account feature for the first asset account.

An example computer system is configured to communicate with a display generation component and one or more input devices and includes: one or more processors; and memory storing one or more programs configured to be executed by the one or more processors, the one or more programs including instructions for: displaying, via the display generation component, a provisioning user interface that includes: an indication that one or more accounts are enabled for performing an application autofill operation at the computer system and are not provisioned onto an electronic wallet of the computer system; and a first selectable user interface object for initiating a process to provision the one or more accounts onto the electronic wallet of the computer system; receiving, via the one or more input devices, selection of the first selectable user interface object; in response to receiving selection of the first selectable user interface object, initiating a process to provision a first account of the one or more accounts onto the electronic wallet of the computer system, wherein the process to provision the first account of the one or more accounts onto the electronic wallet of the computer system uses at least some account information about the first account, wherein the account information is stored for use in the application autofill operation; and subsequent to receiving selection of the first selectable user interface object, provisioning the first account onto the electronic wallet of the computer system using at least some account information about the first account, wherein the account information is stored for use in the application autofill operation.

An example computer system is configured to communicate with a display generation component and one or more input devices and includes: one or more processors; and memory storing one or more programs configured to be executed by the one or more processors, the one or more programs including instructions for: displaying, via the display generation component, a plurality of selectable user interface objects, including: a first selectable user interface object that corresponds to a first account that is provisioned onto an electronic wallet of the computer system; and a second selectable user interface object that corresponds to a second account, different from the first account, that is enabled for performing an application autofill operation at the computer system and is not provisioned onto an electronic wallet of the computer system; receiving, via the one or more input devices, a user input selecting one of the plurality of selectable user interface objects; and in response to receiving the user input selecting one of the plurality of selectable user interface objects: in accordance with a determination that the user input corresponds to selection of the first selectable user interface object, initiating a process to perform an autofill operation to populate one or more fields using credentials of the first account, wherein credentials of the first account populated into a first field of the one or more fields are visually obfuscated; and in accordance with a determination that the user input corresponds to selection of the second selectable user interface object, initiating a process to perform an autofill operation to populate one or more fields using credentials of the second account, wherein credentials of the second account populated into a first field of the one or more fields are not visually obfuscated.

An example computer system is configured to communicate with a display generation component, one or more input devices, and one or more communication radios and includes: one or more processors; and memory storing one or more programs configured to be executed by the one or more processors, the one or more programs including instructions for: displaying, via the display generation component, a user interface of an electronic wallet application that includes concurrent display of a plurality of selectable user interface objects, including: a first selectable user interface object that corresponds to a first account that is provisioned onto an electronic wallet of the computer system, wherein the computer system is configured to perform, using near-field communication via the one or more communication radios, transfers using the first account; a second selectable user interface object that corresponds to a second account, different from the first account, that is provisioned onto the electronic wallet of the computer system, wherein the computer system is configured to perform, using near-field communication via the one or more communication radios, transfers using the second account; and an order tracking user interface object for tracking order statuses; receiving a first user input selecting one of the plurality of selectable user interface objects; in response to receiving the first user input selecting one of the plurality of selectable user interface objects: in accordance with a determination that the first user input corresponds to selection of the first selectable user interface object, ceasing to display the second selectable user interface object and displaying, via the display generation component, information about one or more transfers performed using the first account; and in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant; while displaying the plurality of summaries of orders, receiving, via the one or more input devices, a second user input selecting one of the plurality of summaries of orders; and in response to receiving the second user input selecting one of the plurality of summaries of orders: in accordance with a determination that the second user input corresponds to selection of the first summary of the first order, displaying, via the display generation component and using a predefined arrangement, order tracking details of the first order; and in accordance with a determination that the second user input corresponds to selection of the second summary of the second order, displaying, via the display generation component and using the predefined arrangement, order tracking details of the second order.

An example computer system is configured to communicate with a display generation component, one or more input devices, and one or more communication radios and includes: one or more processors; and memory storing one or more programs configured to be executed by the one or more processors, the one or more programs including instructions for: displaying, via the display generation component, a plurality of selectable user interface options for applying future rewards of a first asset account, including: a first selectable option for applying the future rewards of the first asset account to a second asset account, wherein the computer system is configured to perform, using near-field communication via the one or more communication radios, transfers using the second asset account that is different from the first asset account; and a second selectable option for applying the future rewards of the first asset account to a third asset account that is different from the first asset account and the second asset account; receiving, via the one or more input devices, a first user input selecting one of the plurality of selectable user interface options for applying future rewards of the first asset account to a respective asset account; in response to receiving the first user input selecting one of the plurality of selectable user interface options: in accordance with a determination that the first user input corresponds to selection of the first selectable option, initiating a process for applying future rewards of the first asset account to the second asset account; and in accordance with a determination that the first user input corresponds to selection of the second selectable option, initiating a process for applying future rewards of the first asset account to the third asset account; subsequent to completing the process for applying future rewards of the first asset account to a respective account, performing, using near-field communication via the one or more communication radios, a transfer using the first asset account, wherein a reward based on the transfer using the first asset account is applied to the respective account; and displaying, via the display generation component, a balance of the respective account that includes the applied reward.

An example computer system is configured to communicate with a display generation component and one or more communication radios and includes: one or more processors; and memory storing one or more programs configured to be executed by the one or more processors, the one or more programs including instructions for: concurrently displaying, via the display generation component: a total amount of lifetime reward received for a first asset account that is provisioned onto an electronic wallet of the computer system, wherein the first asset account and a second asset account have been provisioned onto an electronic wallet of the computer system; and a visual object corresponding to the total amount of lifetime reward received for the first asset account, wherein a first portion of the visual object that corresponds to a first type of reward received for the first asset account is visually differentiated from a second portion of the visual object that corresponds to a second type of reward received for the first asset account, wherein: an area of the first portion of the visual object is a first size that is based on an amount of the first type of reward received relative to the total amount of lifetime reward received for the first asset account, and an area of the second portion of the visual object is a second size that is based on an amount of the second type of reward received relative to the total amount of lifetime reward received for the first asset account; subsequent to concurrently displaying the total amount of lifetime reward received for the first asset account and the visual object corresponding to the total amount of lifetime reward received for the first asset account: performing, via the one or more communication radios, a first transfer using the first asset account; and performing, via the one or more communication radios, a second transfer using the second asset account; and subsequent to performing the first transfer and the second transfer, concurrently displaying, via the display generation component: the total amount of lifetime reward received for the first asset account, wherein the total amount of lifetime reward is updated to include a reward received based on the first transfer without including any reward received based on the second transfer; and the visual object corresponding to the updated total amount of lifetime reward received for the first asset account, wherein: the area of the first portion of the visual object is updated to a third size that is larger than the first size, the third size being based on the reward received based on the first transfer corresponding to the first type of reward; and the area of the second portion of the visual object is updated to a fourth size that is smaller than the second size, the fourth size being based on the reward received based on the first transfer not corresponding to the second type of reward.

An example computer system is configured to communicate with a display generation component and one or more input devices and includes means for concurrently displaying, via the display generation component, a portion of a first visual representation corresponding to a first asset account that has been provisioned onto an electronic wallet of the computer system and a portion of a second visual representation, different from the first visual representation, corresponding to a second asset account that has been provisioned onto an electronic wallet of the computer system and that is different from the first asset account; means for, while concurrently displaying the portion of the first visual representation and the portion of the second visual representation, receiving, via the one or more input devices, selection of the first visual representation corresponding to the first asset account; means for, in response to receiving selection of the first visual representation corresponding to the first asset account: in accordance with a determination that a set of virtual account criteria are met, wherein a first virtual account criterion of the set of virtual account criteria is met when a virtual account feature is not enabled for the first asset account, displaying, via the display generation component, a first selectable user interface object for initiating a process to enable the virtual account feature for the first asset account, wherein: when the virtual account feature is not enabled for the first asset account, the computer system automatically uses the same credential information for consecutive transactions performed using the first asset account, and when the virtual account feature is enabled for the first asset account, the computer system automatically uses different credential information for consecutive transactions performed using the first asset account; and in accordance with a determination that the set of virtual account criteria are not met, forgoing display of the first selectable user interface object for initiating a process to enable the virtual account feature for the first asset account; means for, while displaying, via the display generation component, the first selectable user interface object displayed in response to receiving selection of the first visual representation, receiving, via the one or more input devices, selection of the first selectable user interface object; and means for, in response to receiving selection of the first selectable user interface object, initiating a process to enable the virtual account feature for the first asset account.

An example computer system is configured to communicate with a display generation component and one or more input devices and includes means for displaying, via the display generation component, a provisioning user interface that includes: an indication that one or more accounts are enabled for performing an application autofill operation at the computer system and are not provisioned onto an electronic wallet of the computer system; and a first selectable user interface object for initiating a process to provision the one or more accounts onto the electronic wallet of the computer system; receiving, via the one or more input devices, selection of the first selectable user interface object; means for, in response to receiving selection of the first selectable user interface object, initiating a process to provision a first account of the one or more accounts onto the electronic wallet of the computer system, wherein the process to provision the first account of the one or more accounts onto the electronic wallet of the computer system uses at least some account information about the first account, wherein the account information is stored for use in the application autofill operation; and means for, subsequent to receiving selection of the first selectable user interface object, provisioning the first account onto the electronic wallet of the computer system using at least some account information about the first account, wherein the account information is stored for use in the application autofill operation.

An example computer system is configured to communicate with a display generation component and one or more input devices and includes means for displaying, via the display generation component, a plurality of selectable user interface objects, including: a first selectable user interface object that corresponds to a first account that is provisioned onto an electronic wallet of the computer system; and a second selectable user interface object that corresponds to a second account, different from the first account, that is enabled for performing an application autofill operation at the computer system and is not provisioned onto an electronic wallet of the computer system; means for receiving, via the one or more input devices, a user input selecting one of the plurality of selectable user interface objects; and means for in response to receiving the user input selecting one of the plurality of selectable user interface objects: in accordance with a determination that the user input corresponds to selection of the first selectable user interface object, initiating a process to perform an autofill operation to populate one or more fields using credentials of the first account, wherein credentials of the first account populated into a first field of the one or more fields are visually obfuscated; and in accordance with a determination that the user input corresponds to selection of the second selectable user interface object, initiating a process to perform an autofill operation to populate one or more fields using credentials of the second account, wherein credentials of the second account populated into a first field of the one or more fields are not visually obfuscated.

An example computer system is configured to communicate with a display generation component, one or more input devices, and one or more communication radios and includes means for displaying, via the display generation component, a user interface of an electronic wallet application that includes concurrent display of a plurality of selectable user interface objects, including: a first selectable user interface object that corresponds to a first account that is provisioned onto an electronic wallet of the computer system, wherein the computer system is configured to perform, using near-field communication via the one or more communication radios, transfers using the first account; a second selectable user interface object that corresponds to a second account, different from the first account, that is provisioned onto the electronic wallet of the computer system, wherein the computer system is configured to perform, using near-field communication via the one or more communication radios, transfers using the second account; and an order tracking user interface object for tracking order statuses; means for receiving a first user input selecting one of the plurality of selectable user interface objects; means for, in response to receiving the first user input selecting one of the plurality of selectable user interface objects: in accordance with a determination that the first user input corresponds to selection of the first selectable user interface object, ceasing to display the second selectable user interface object and displaying, via the display generation component, information about one or more transfers performed using the first account; and in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant; means for, while displaying the plurality of summaries of orders, receiving, via the one or more input devices, a second user input selecting one of the plurality of summaries of orders; and means for, in response to receiving the second user input selecting one of the plurality of summaries of orders: in accordance with a determination that the second user input corresponds to selection of the first summary of the first order, displaying, via the display generation component and using a predefined arrangement, order tracking details of the first order; and in accordance with a determination that the second user input corresponds to selection of the second summary of the second order, displaying, via the display generation component and using the predefined arrangement, order tracking details of the second order.

An example computer system is configured to communicate with a display generation component, one or more input devices, and one or more communication radios and includes means for displaying, via the display generation component, a plurality of selectable user interface options for applying future rewards of a first asset account, including: a first selectable option for applying the future rewards of the first asset account to a second asset account, wherein the computer system is configured to perform, using near-field communication via the one or more communication radios, transfers using the second asset account that is different from the first asset account; and a second selectable option for applying the future rewards of the first asset account to a third asset account that is different from the first asset account and the second asset account; means for receiving, via the one or more input devices, a first user input selecting one of the plurality of selectable user interface options for applying future rewards of the first asset account to a respective asset account; means for, in response to receiving the first user input selecting one of the plurality of selectable user interface options: in accordance with a determination that the first user input corresponds to selection of the first selectable option, initiating a process for applying future rewards of the first asset account to the second asset account; and in accordance with a determination that the first user input corresponds to selection of the second selectable option, initiating a process for applying future rewards of the first asset account to the third asset account; means for, subsequent to completing the process for applying future rewards of the first asset account to a respective account, performing, using near-field communication via the one or more communication radios, a transfer using the first asset account, wherein a reward based on the transfer using the first asset account is applied to the respective account; and means for displaying, via the display generation component, a balance of the respective account that includes the applied reward.

An example computer system is configured to communicate with a display generation component and one or more communication radios and includes means for concurrently displaying, via the display generation component: a total amount of lifetime reward received for a first asset account that is provisioned onto an electronic wallet of the computer system, wherein the first asset account and a second asset account have been provisioned onto an electronic wallet of the computer system; and a visual object corresponding to the total amount of lifetime reward received for the first asset account, wherein a first portion of the visual object that corresponds to a first type of reward received for the first asset account is visually differentiated from a second portion of the visual object that corresponds to a second type of reward received for the first asset account, wherein: an area of the first portion of the visual object is a first size that is based on an amount of the first type of reward received relative to the total amount of lifetime reward received for the first asset account, and an area of the second portion of the visual object is a second size that is based on an amount of the second type of reward received relative to the total amount of lifetime reward received for the first asset account; means for, subsequent to concurrently displaying the total amount of lifetime reward received for the first asset account and the visual object corresponding to the total amount of lifetime reward received for the first asset account: performing, via the one or more communication radios, a first transfer using the first asset account; and performing, via the one or more communication radios, a second transfer using the second asset account; and means for, subsequent to performing the first transfer and the second transfer, concurrently displaying, via the display generation component: the total amount of lifetime reward received for the first asset account, wherein the total amount of lifetime reward is updated to include a reward received based on the first transfer without including any reward received based on the second transfer; and the visual object corresponding to the updated total amount of lifetime reward received for the first asset account, wherein: the area of the first portion of the visual object is updated to a third size that is larger than the first size, the third size being based on the reward received based on the first transfer corresponding to the first type of reward; and the area of the second portion of the visual object is updated to a fourth size that is smaller than the second size, the fourth size being based on the reward received based on the first transfer not corresponding to the second type of reward.

Example computer program products are described herein. An example computer program product includes one or more programs configured to be executed by one or more processors of a computer system that is in communication with a display generation component and one or more input devices, the one or more programs including instructions for: concurrently displaying, via the display generation component, a portion of a first visual representation corresponding to a first asset account that has been provisioned onto an electronic wallet of the computer system and a portion of a second visual representation, different from the first visual representation, corresponding to a second asset account that has been provisioned onto an electronic wallet of the computer system and that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account: in accordance with a determination that a set of virtual account criteria are met, wherein a first virtual account criterion of the set of virtual account criteria is met when a virtual account feature is not enabled for the first asset account, displaying, via the display generation component, a first selectable user interface object for initiating a process to enable the virtual account feature for the first asset account, wherein: when the virtual account feature is not enabled for the first asset account, the computer system automatically uses the same credential information for consecutive transactions performed using the first asset account, and when the virtual account feature is enabled for the first asset account, the computer system automatically uses different credential information for consecutive transactions performed using the first asset account; and in accordance with a determination that the set of virtual account criteria are not met, forgoing display of the first selectable user interface object for initiating a process to enable the virtual account feature for the first asset account; while displaying, via the display generation component, the first selectable user interface object displayed in response to receiving selection of the first visual representation, receiving, via the one or more input devices, selection of the first selectable user interface object; and in response to receiving selection of the first selectable user interface object, initiating a process to enable the virtual account feature for the first asset account.

An example computer program product includes one or more programs configured to be executed by one or more processors of a computer system that is in communication with a display generation component and one or more input devices, the one or more programs including instructions for: displaying, via the display generation component, a provisioning user interface that includes: an indication that one or more accounts are enabled for performing an application autofill operation at the computer system and are not provisioned onto an electronic wallet of the computer system; and a first selectable user interface object for initiating a process to provision the one or more accounts onto the electronic wallet of the computer system; receiving, via the one or more input devices, selection of the first selectable user interface object; in response to receiving selection of the first selectable user interface object, initiating a process to provision a first account of the one or more accounts onto the electronic wallet of the computer system, wherein the process to provision the first account of the one or more accounts onto the electronic wallet of the computer system uses at least some account information about the first account, wherein the account information is stored for use in the application autofill operation; and subsequent to receiving selection of the first selectable user interface object, provisioning the first account onto the electronic wallet of the computer system using at least some account information about the first account, wherein the account information is stored for use in the application autofill operation.

An example computer program product includes one or more programs configured to be executed by one or more processors of a computer system that is in communication with a display generation component and one or more input devices, the one or more programs including instructions for: displaying, via the display generation component, a plurality of selectable user interface objects, including: a first selectable user interface object that corresponds to a first account that is provisioned onto an electronic wallet of the computer system; and a second selectable user interface object that corresponds to a second account, different from the first account, that is enabled for performing an application autofill operation at the computer system and is not provisioned onto an electronic wallet of the computer system; receiving, via the one or more input devices, a user input selecting one of the plurality of selectable user interface objects; and in response to receiving the user input selecting one of the plurality of selectable user interface objects: in accordance with a determination that the user input corresponds to selection of the first selectable user interface object, initiating a process to perform an autofill operation to populate one or more fields using credentials of the first account, wherein credentials of the first account populated into a first field of the one or more fields are visually obfuscated; and in accordance with a determination that the user input corresponds to selection of the second selectable user interface object, initiating a process to perform an autofill operation to populate one or more fields using credentials of the second account, wherein credentials of the second account populated into a first field of the one or more fields are not visually obfuscated.

An example computer program product includes one or more programs configured to be executed by one or more processors of a computer system that is in communication with a display generation component, one or more input devices, and one or more communication radios, the one or more programs including instructions for: displaying, via the display generation component, a user interface of an electronic wallet application that includes concurrent display of a plurality of selectable user interface objects, including: a first selectable user interface object that corresponds to a first account that is provisioned onto an electronic wallet of the computer system, wherein the computer system is configured to perform, using near-field communication via the one or more communication radios, transfers using the first account; a second selectable user interface object that corresponds to a second account, different from the first account, that is provisioned onto the electronic wallet of the computer system, wherein the computer system is configured to perform, using near-field communication via the one or more communication radios, transfers using the second account; and an order tracking user interface object for tracking order statuses; receiving a first user input selecting one of the plurality of selectable user interface objects; in response to receiving the first user input selecting one of the plurality of selectable user interface objects: in accordance with a determination that the first user input corresponds to selection of the first selectable user interface object, ceasing to display the second selectable user interface object and displaying, via the display generation component, information about one or more transfers performed using the first account; and in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant; while displaying the plurality of summaries of orders, receiving, via the one or more input devices, a second user input selecting one of the plurality of summaries of orders; and in response to receiving the second user input selecting one of the plurality of summaries of orders: in accordance with a determination that the second user input corresponds to selection of the first summary of the first order, displaying, via the display generation component and using a predefined arrangement, order tracking details of the first order; and in accordance with a determination that the second user input corresponds to selection of the second summary of the second order, displaying, via the display generation component and using the predefined arrangement, order tracking details of the second order.

An example computer program product includes one or more programs configured to be executed by one or more processors of a computer system that is in communication with a display generation component, one or more input devices, and one or more communication radios, the one or more programs including instructions for: displaying, via the display generation component, a plurality of selectable user interface options for applying future rewards of a first asset account, including: a first selectable option for applying the future rewards of the first asset account to a second asset account, wherein the computer system is configured to perform, using near-field communication via the one or more communication radios, transfers using the second asset account that is different from the first asset account; and a second selectable option for applying the future rewards of the first asset account to a third asset account that is different from the first asset account and the second asset account; receiving, via the one or more input devices, a first user input selecting one of the plurality of selectable user interface options for applying future rewards of the first asset account to a respective asset account; in response to receiving the first user input selecting one of the plurality of selectable user interface options: in accordance with a determination that the first user input corresponds to selection of the first selectable option, initiating a process for applying future rewards of the first asset account to the second asset account; and in accordance with a determination that the first user input corresponds to selection of the second selectable option, initiating a process for applying future rewards of the first asset account to the third asset account; subsequent to completing the process for applying future rewards of the first asset account to a respective account, performing, using near-field communication via the one or more communication radios, a transfer using the first asset account, wherein a reward based on the transfer using the first asset account is applied to the respective account; and displaying, via the display generation component, a balance of the respective account that includes the applied reward.

An example computer program product includes one or more programs configured to be executed by one or more processors of a computer system that is in communication with a display generation component and one or more communication radios, the one or more programs including instructions for: concurrently displaying, via the display generation component: a total amount of lifetime reward received for a first asset account that is provisioned onto an electronic wallet of the computer system, wherein the first asset account and a second asset account have been provisioned onto an electronic wallet of the computer system; and a visual object corresponding to the total amount of lifetime reward received for the first asset account, wherein a first portion of the visual object that corresponds to a first type of reward received for the first asset account is visually differentiated from a second portion of the visual object that corresponds to a second type of reward received for the first asset account, wherein: an area of the first portion of the visual object is a first size that is based on an amount of the first type of reward received relative to the total amount of lifetime reward received for the first asset account, and an area of the second portion of the visual object is a second size that is based on an amount of the second type of reward received relative to the total amount of lifetime reward received for the first asset account; subsequent to concurrently displaying the total amount of lifetime reward received for the first asset account and the visual object corresponding to the total amount of lifetime reward received for the first asset account: performing, via the one or more communication radios, a first transfer using the first asset account; and performing, via the one or more communication radios, a second transfer using the second asset account; and subsequent to performing the first transfer and the second transfer, concurrently displaying, via the display generation component: the total amount of lifetime reward received for the first asset account, wherein the total amount of lifetime reward is updated to include a reward received based on the first transfer without including any reward received based on the second transfer; and the visual object corresponding to the updated total amount of lifetime reward received for the first asset account, wherein: the area of the first portion of the visual object is updated to a third size that is larger than the first size, the third size being based on the reward received based on the first transfer corresponding to the first type of reward; and the area of the second portion of the visual object is updated to a fourth size that is smaller than the second size, the fourth size being based on the reward received based on the first transfer not corresponding to the second type of reward.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing accounts, thereby increasing the effectiveness, efficiency, and user satisfaction with such devices. Such methods and interfaces may complement or replace other methods for managing accounts.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates exemplary devices connected via one or more communication channels, in accordance with some embodiments.

FIGS. 6A-6D illustrate exemplary user interfaces for managing storage account numbers in accordance with some embodiments.

FIGS. 7A-7M illustrate exemplary user interfaces for managing virtual account numbers in accordance with some embodiments.

FIG. 8 is a flow diagram illustrating a method for managing account numbers in accordance with some embodiments.

FIGS. 9A-9C illustrate exemplary user interfaces for provisioning a storage account in accordance with some embodiments.

FIGS. 10A-10H illustrate exemplary user interfaces for provisioning an account in accordance with some embodiments.

FIG. 11 is a flow diagram illustrating a method for provisioning an account in accordance with some embodiments.

FIGS. 12A-12C illustrate exemplary user interfaces for obfuscating credentials of a storage account in accordance with some embodiments.

FIGS. 13A-13J illustrate exemplary user interfaces for obfuscating credentials of an account in accordance with some embodiments.

FIG. 14 is a flow diagram illustrating a method for obfuscating credentials of an account in accordance with some embodiments.

FIGS. 15A-15E illustrate exemplary user interfaces for managing orders in accordance with some embodiments.

FIGS. 16A-16L illustrate exemplary user interfaces for managing orders in accordance with some embodiments.

FIG. 17 is a flow diagram illustrating a method for managing orders in accordance with some embodiments.

FIG. 18 illustrates an exemplary user interface for managing rewards for an account, in accordance with some embodiments.

FIGS. 19A-19W illustrate exemplary user interfaces for managing rewards for an account, in accordance with some embodiments.

FIG. 20 is a flow diagram illustrating a method for managing rewards for an account, in accordance with some embodiments.

FIG. 21 is a flow diagram illustrating a method for managing rewards for an account, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing accounts. Such techniques can reduce the cognitive burden on a user who manage accounts, thereby enhancing productivity. Further, such techniques can reduce processor and battery power otherwise wasted on redundant user inputs.

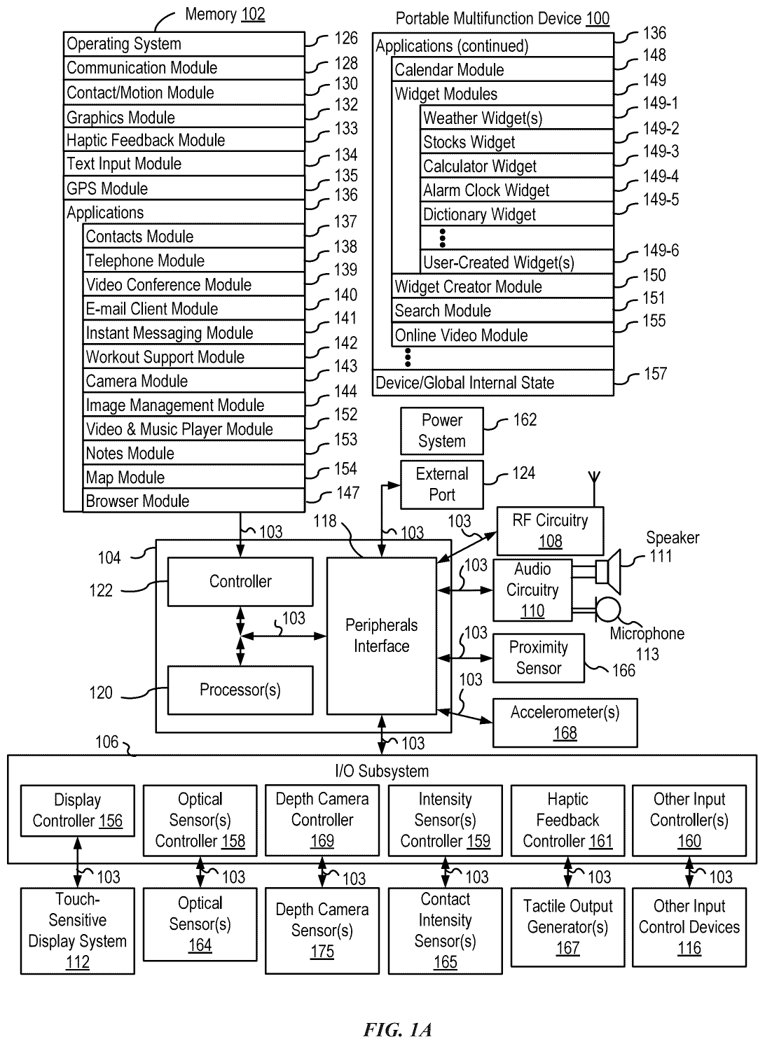

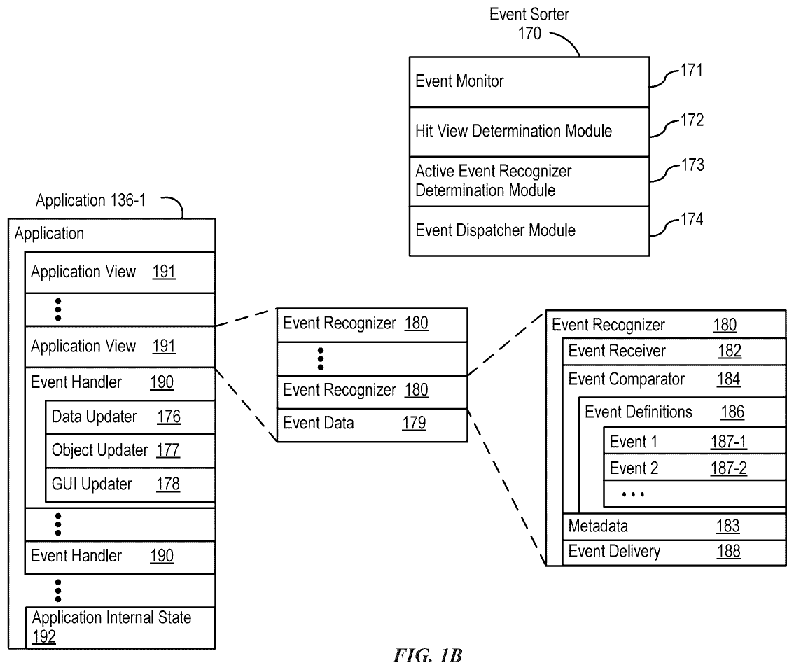

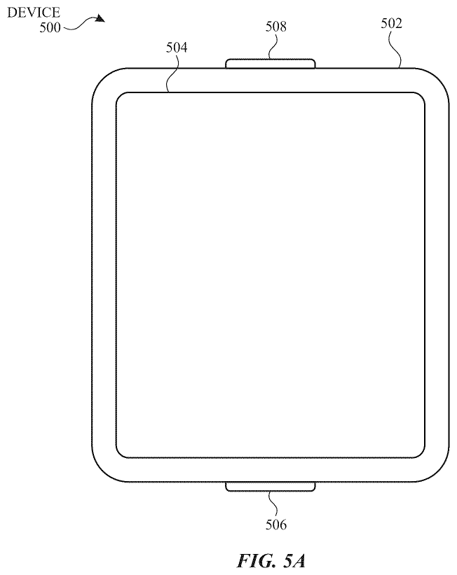

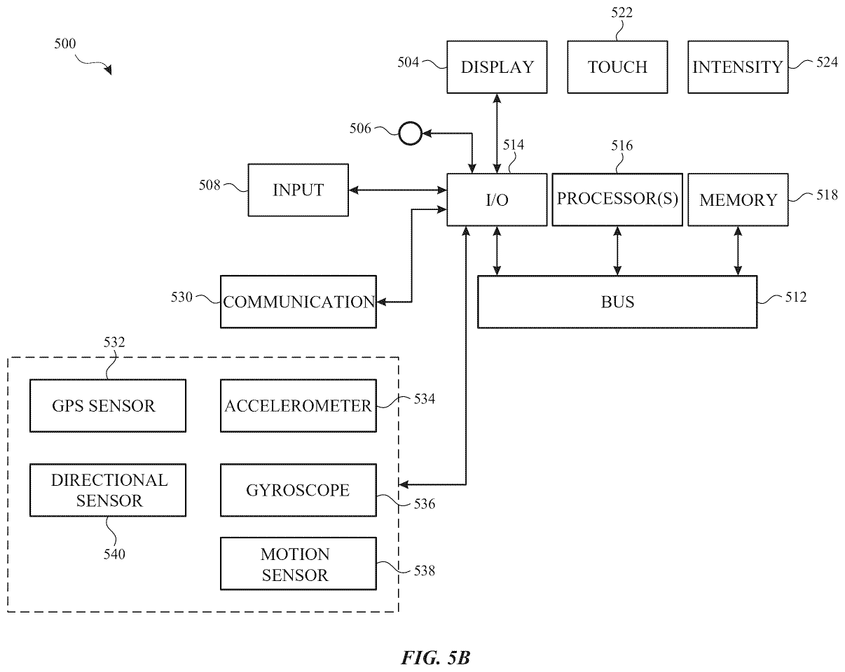

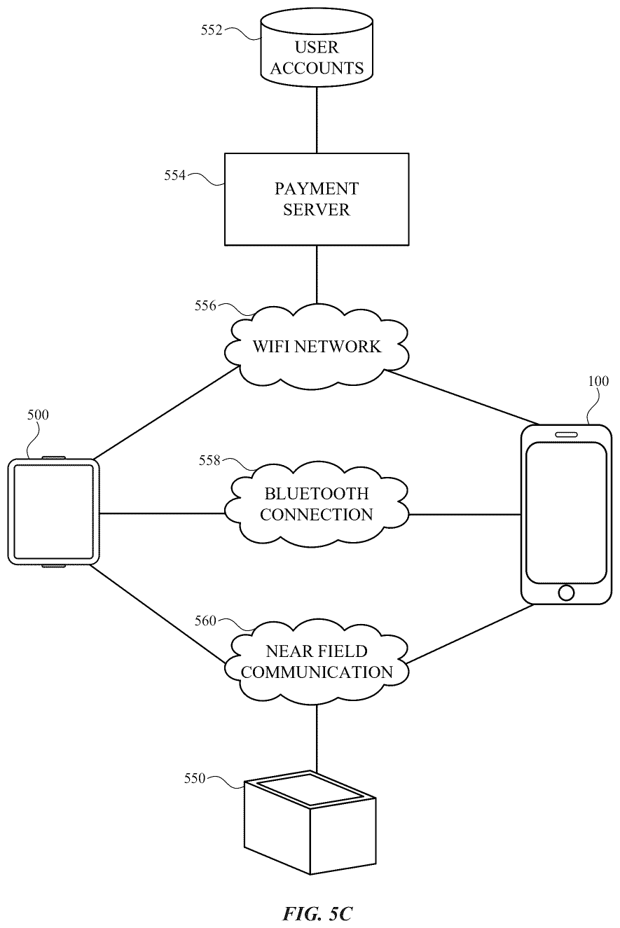

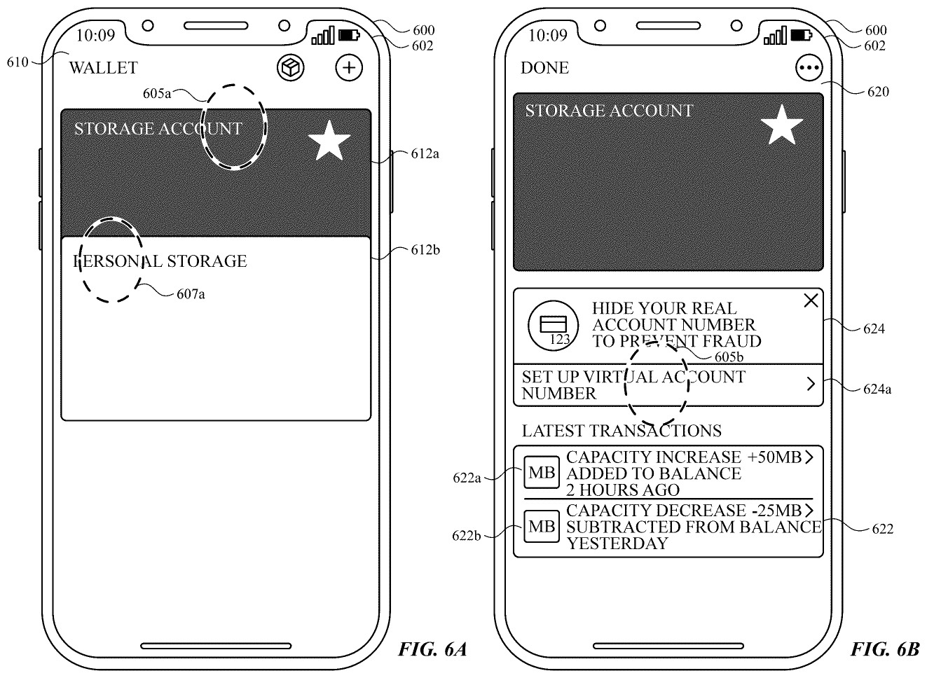

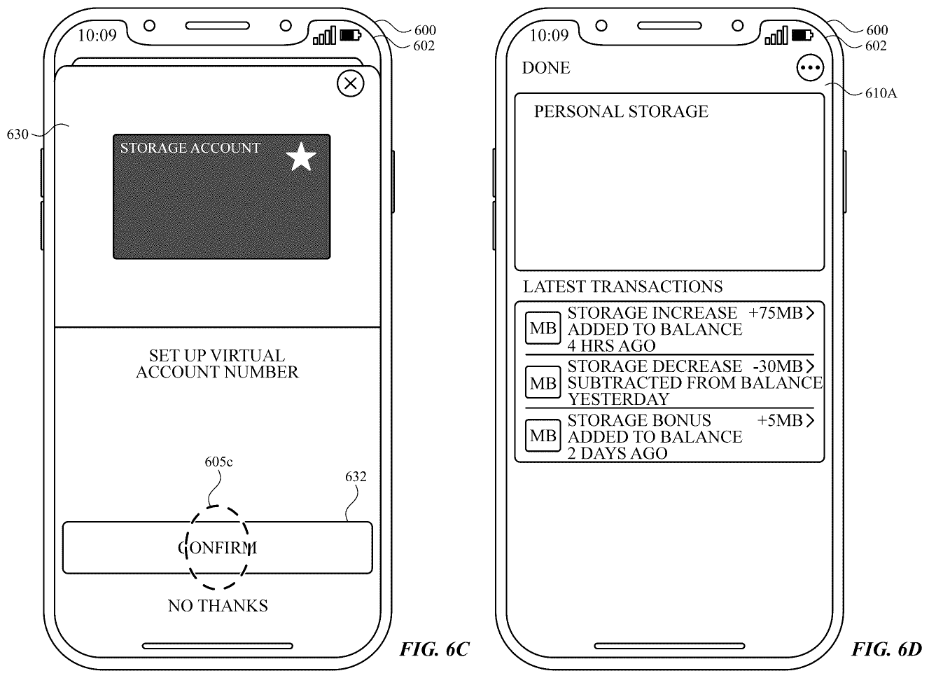

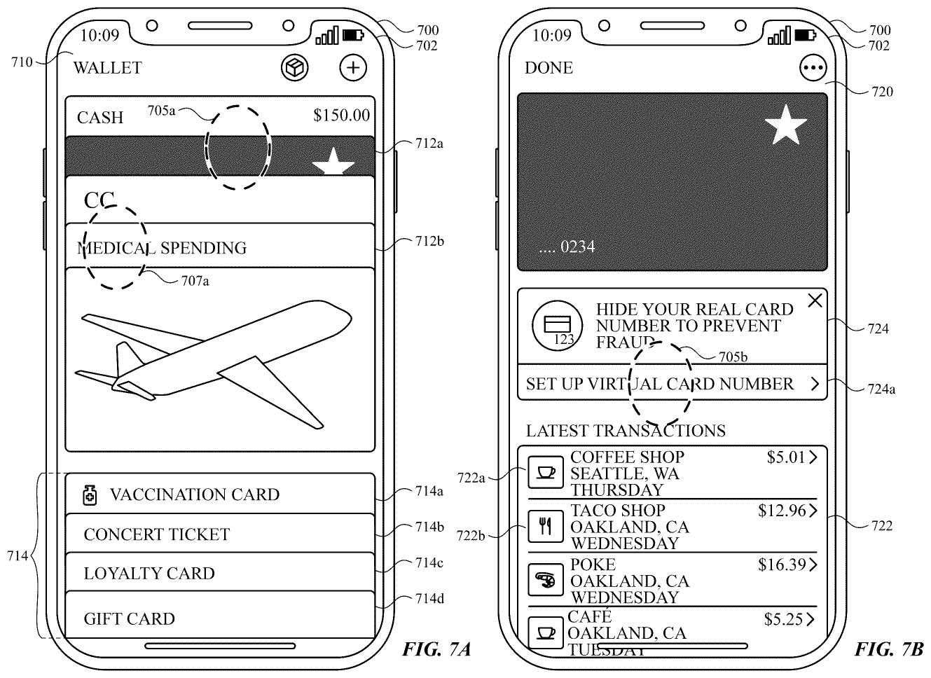

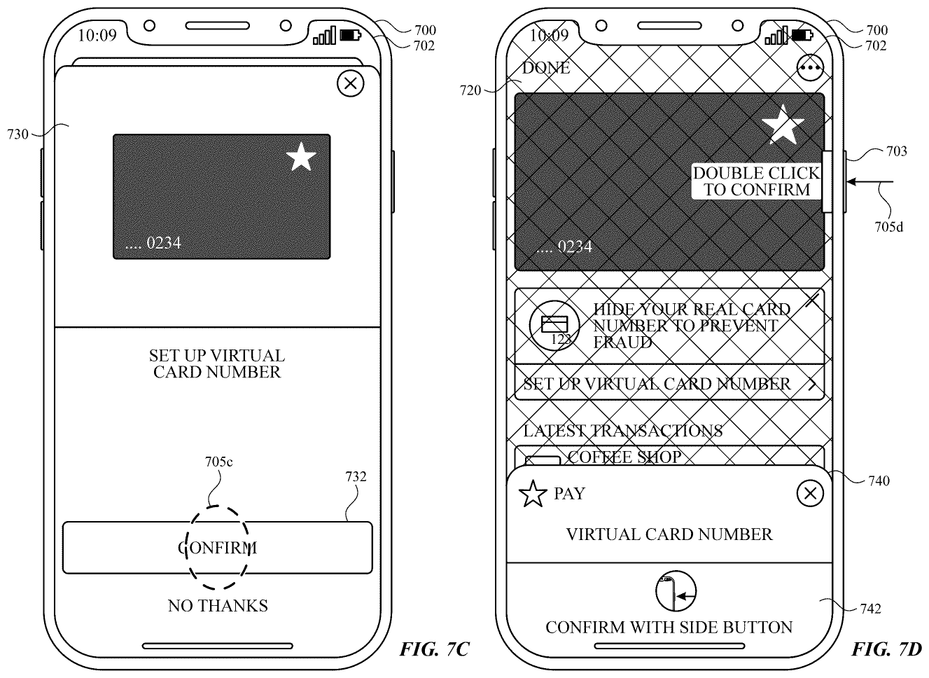

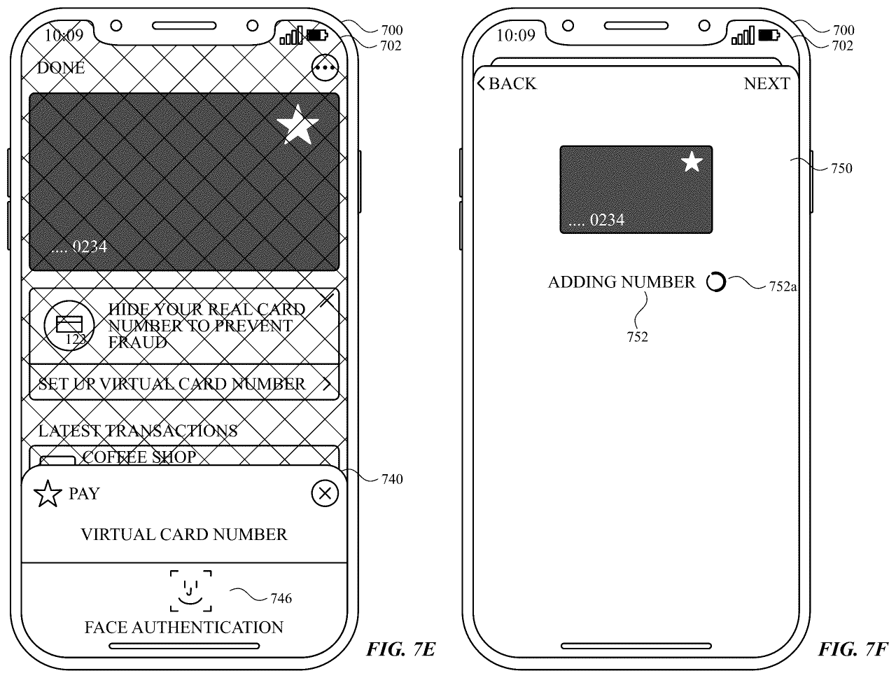

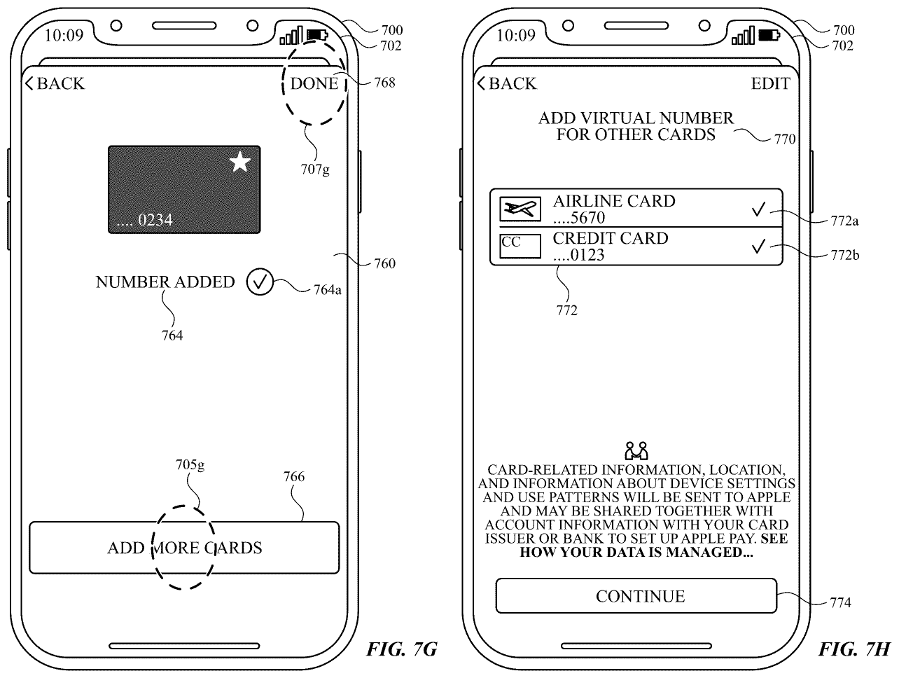

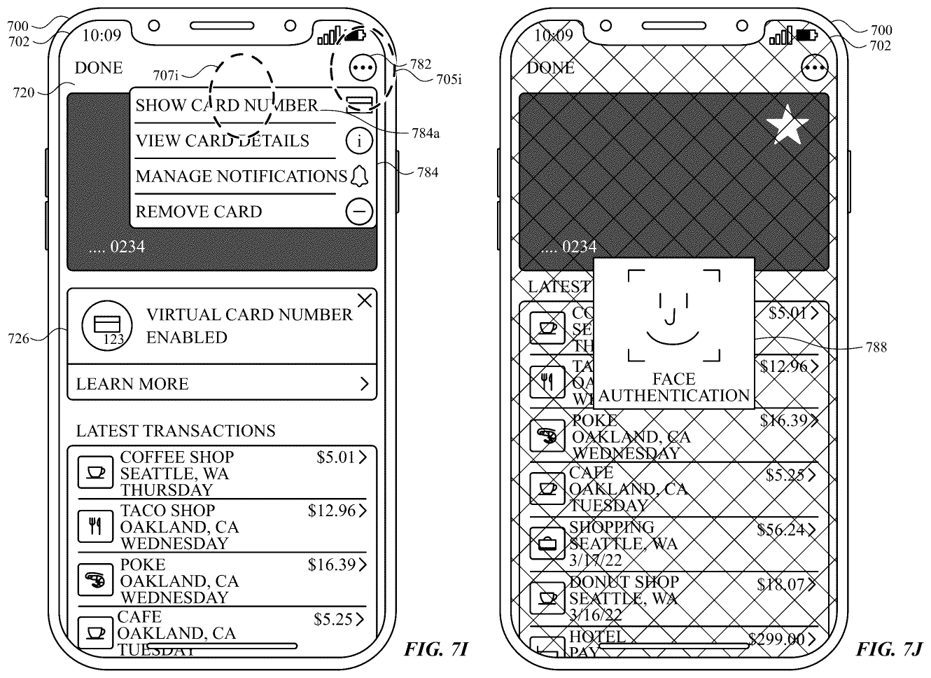

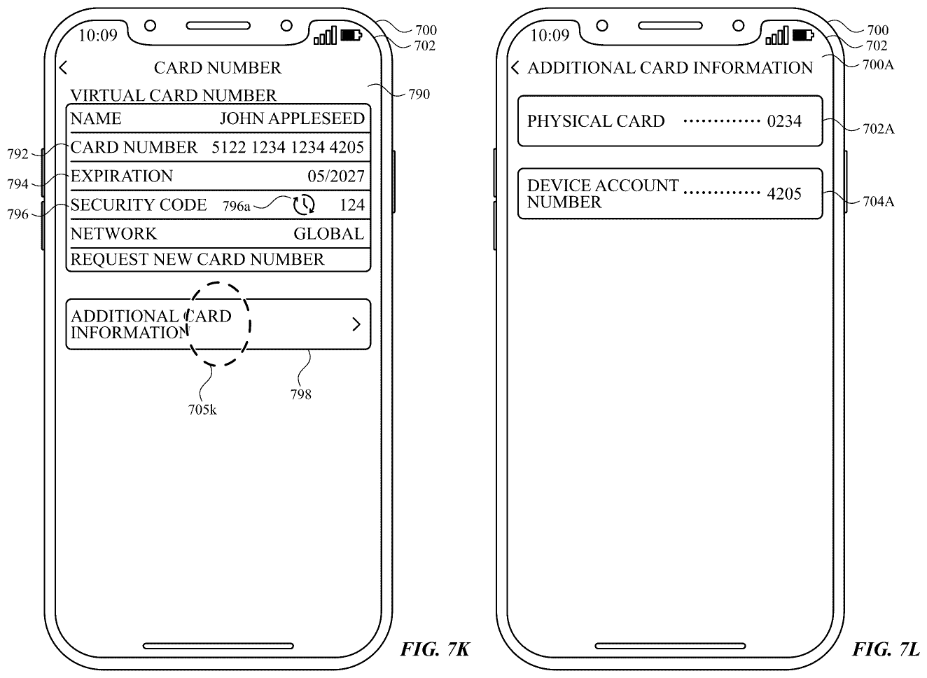

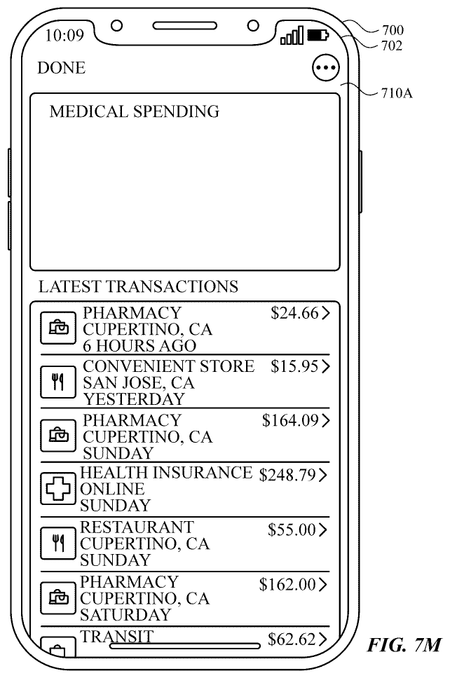

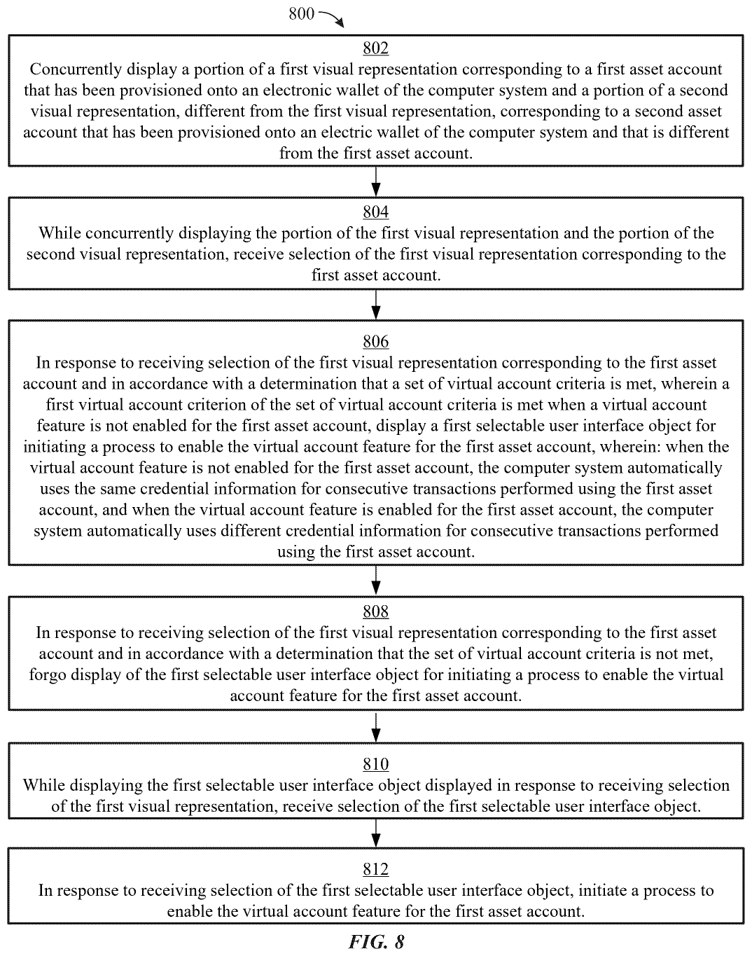

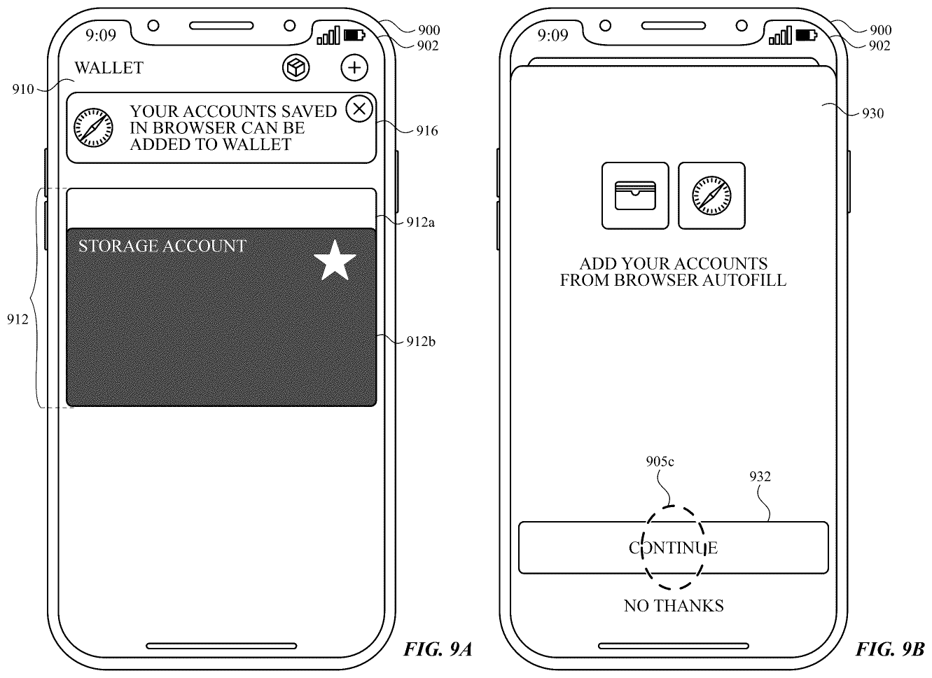

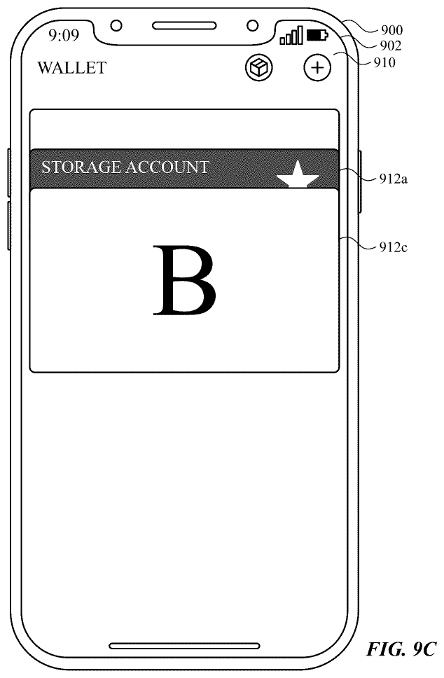

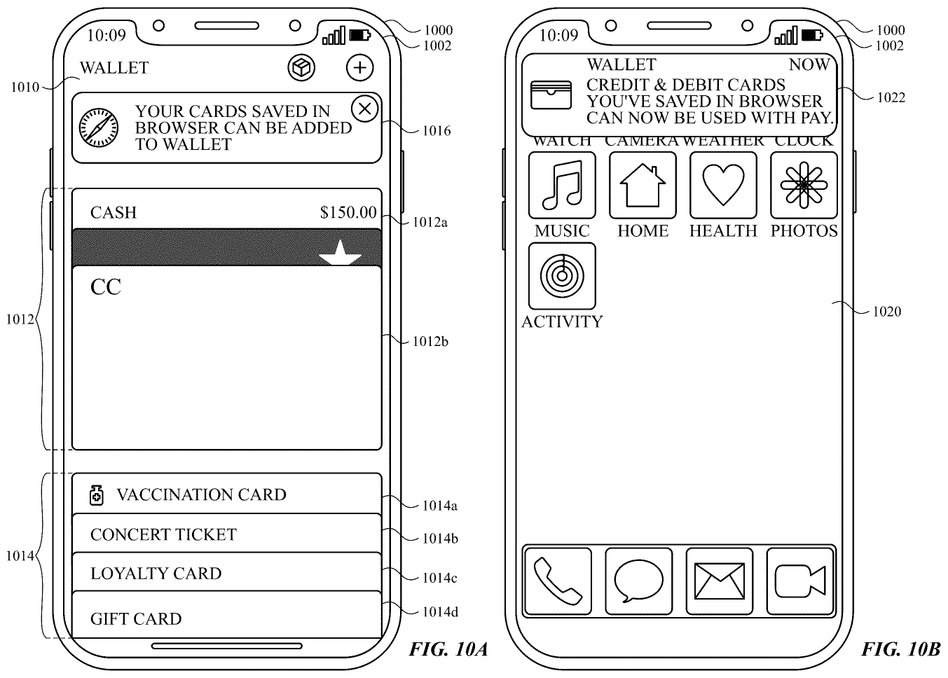

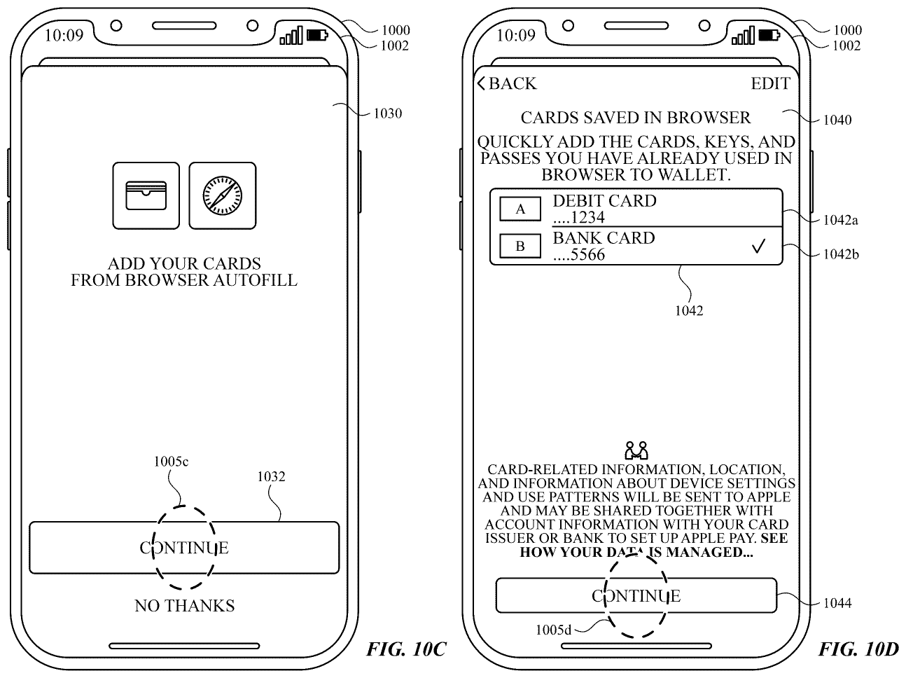

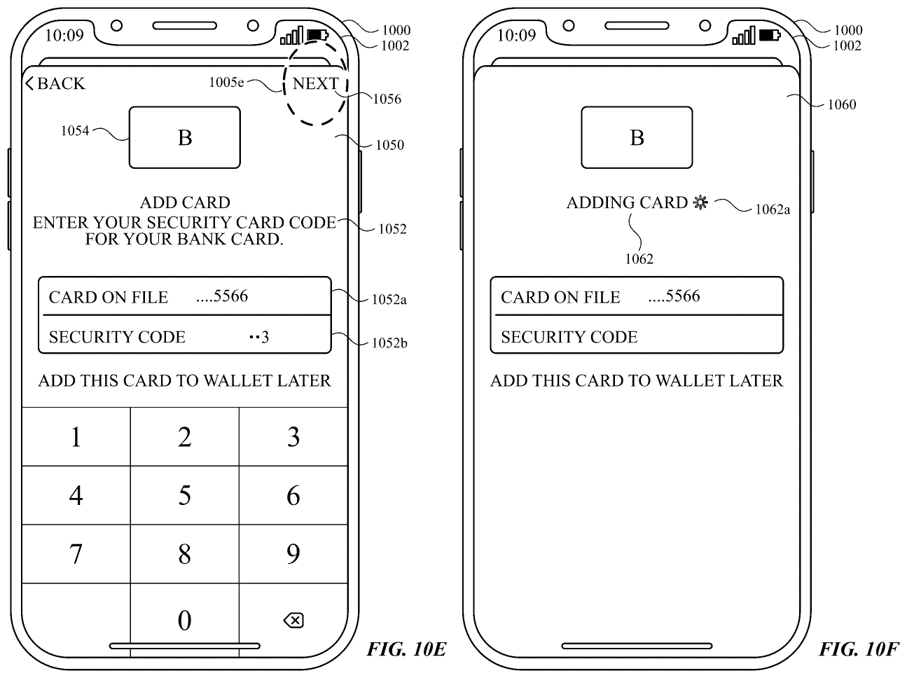

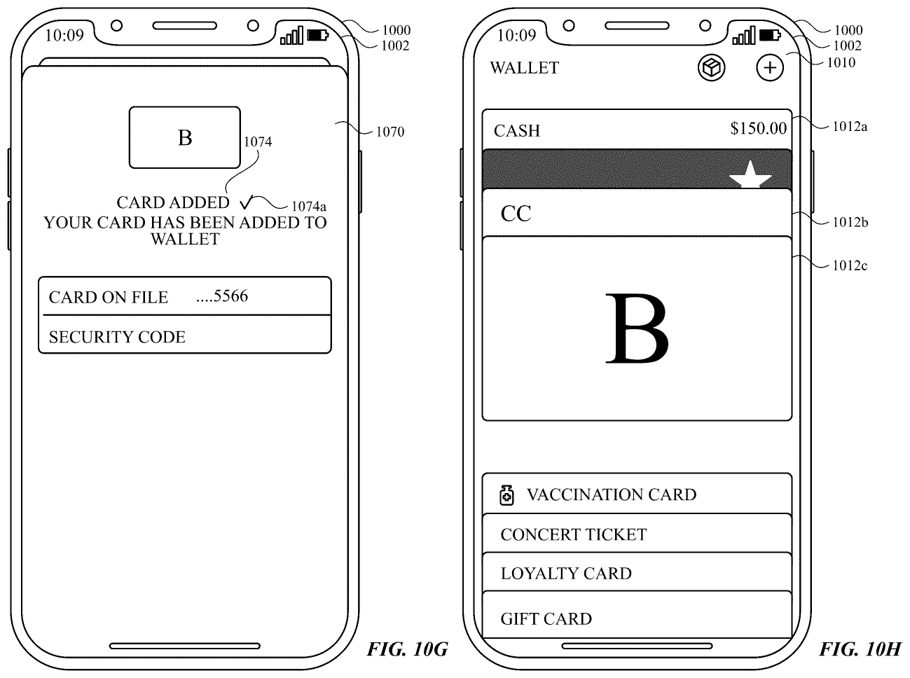

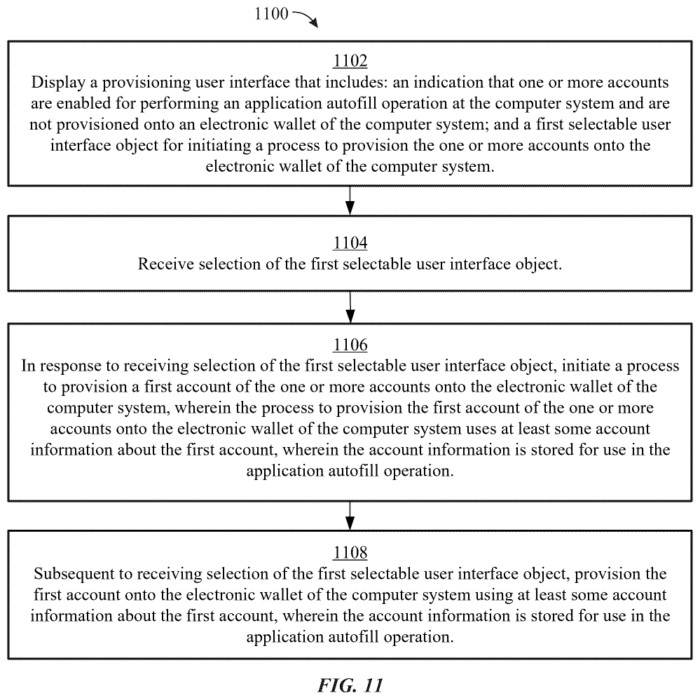

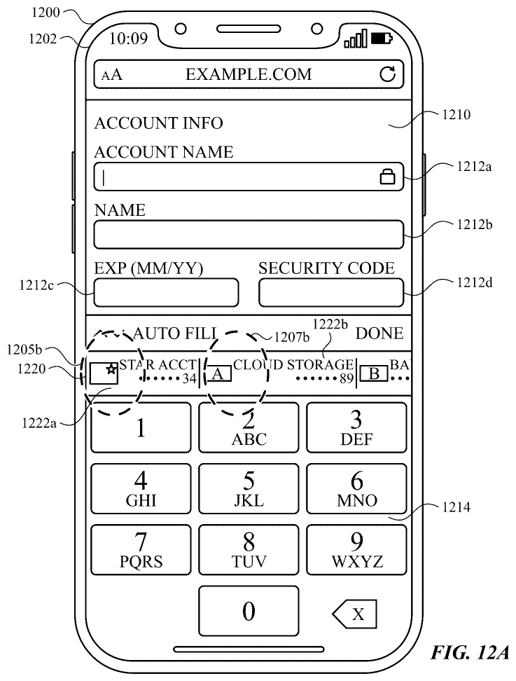

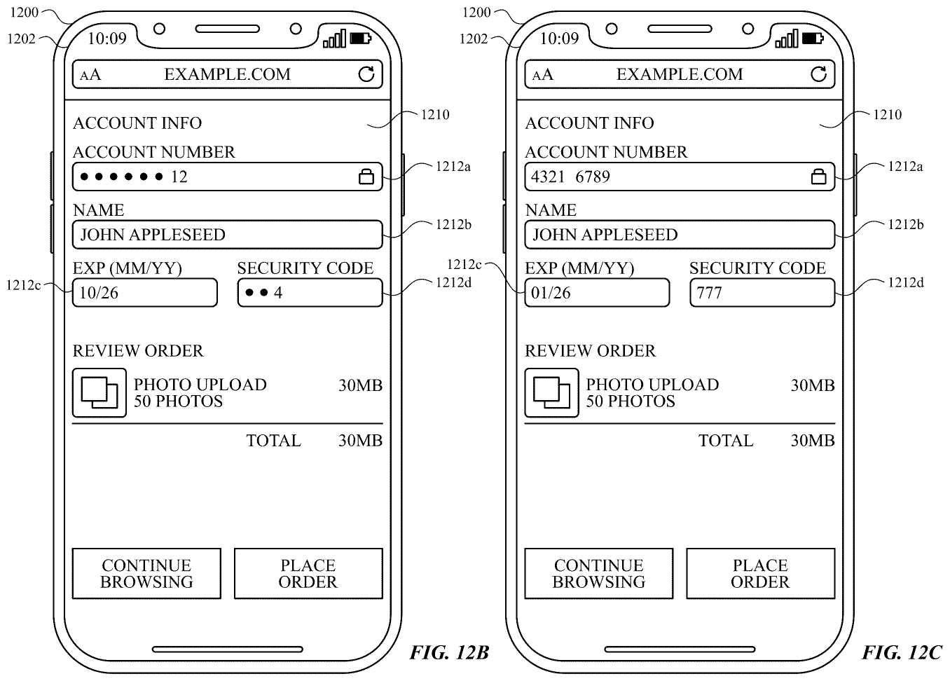

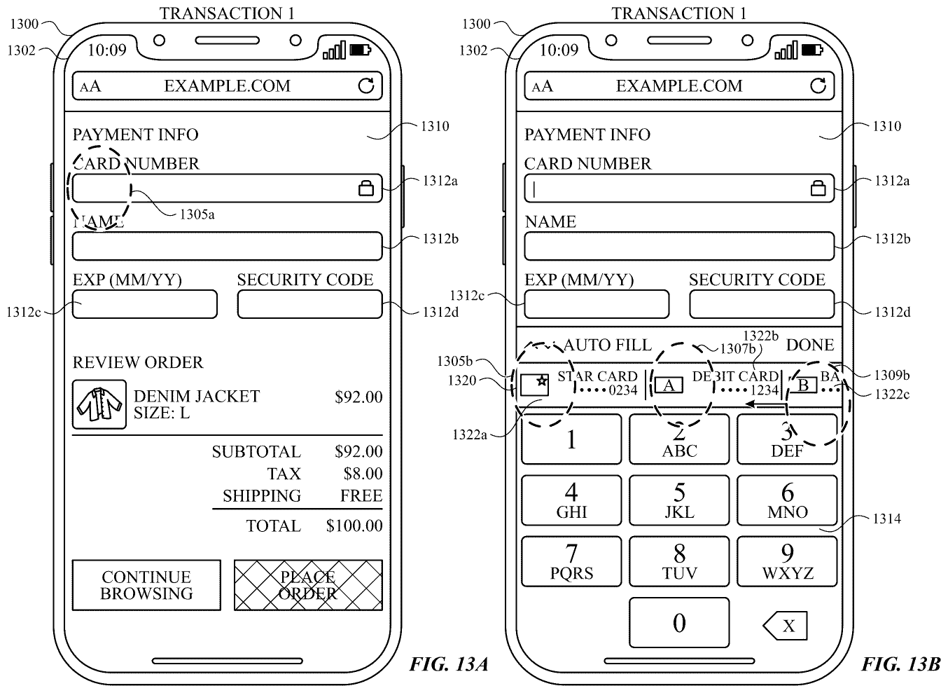

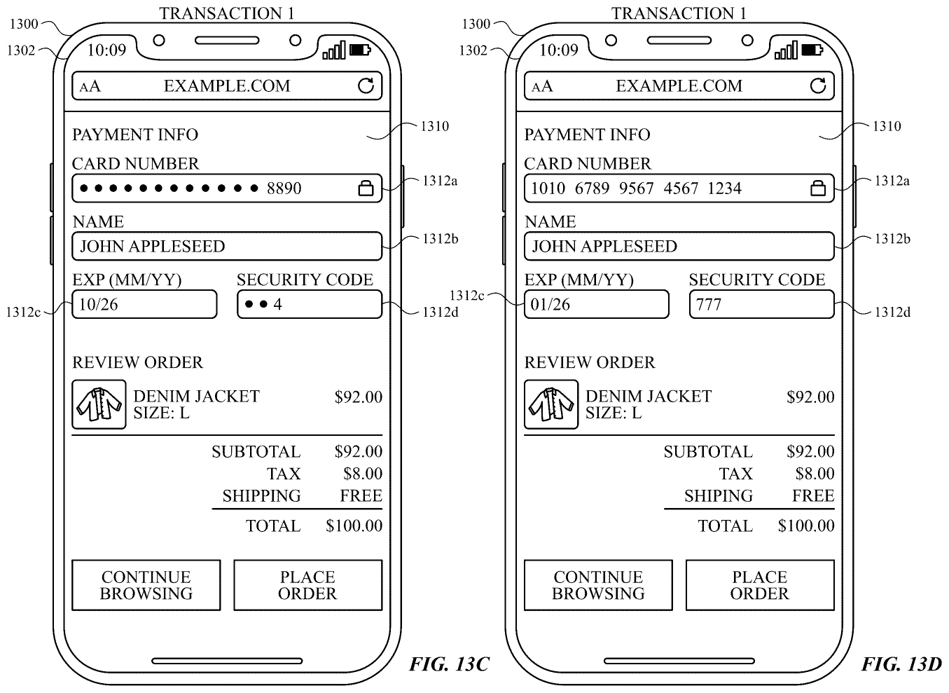

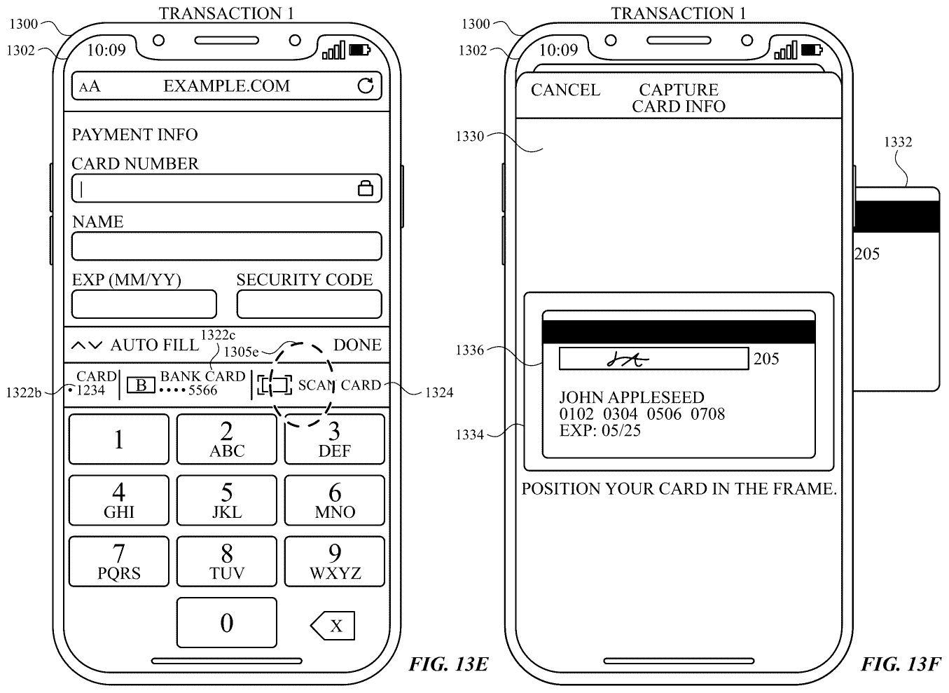

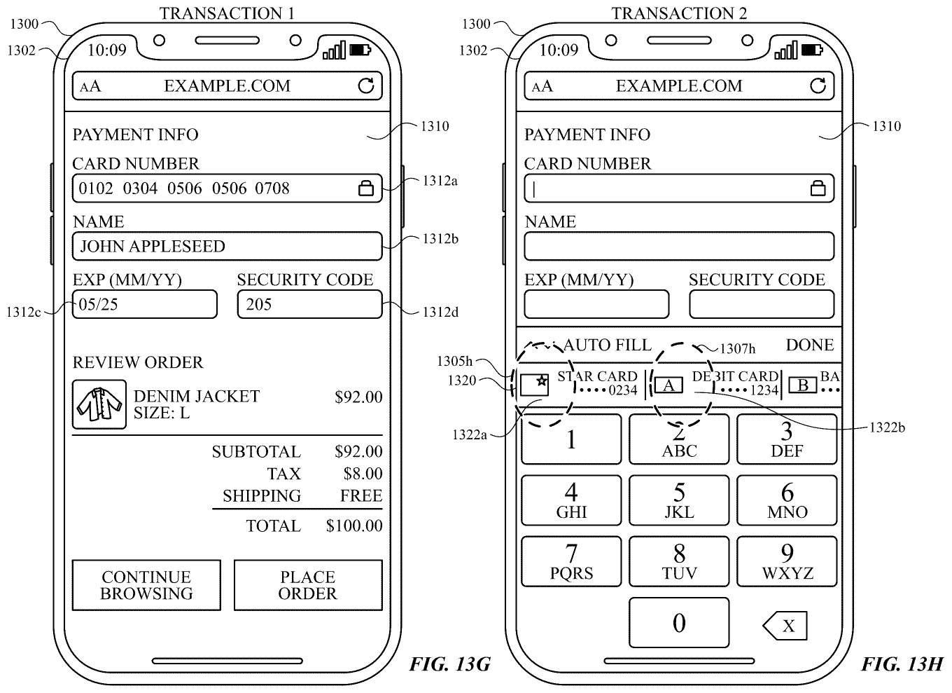

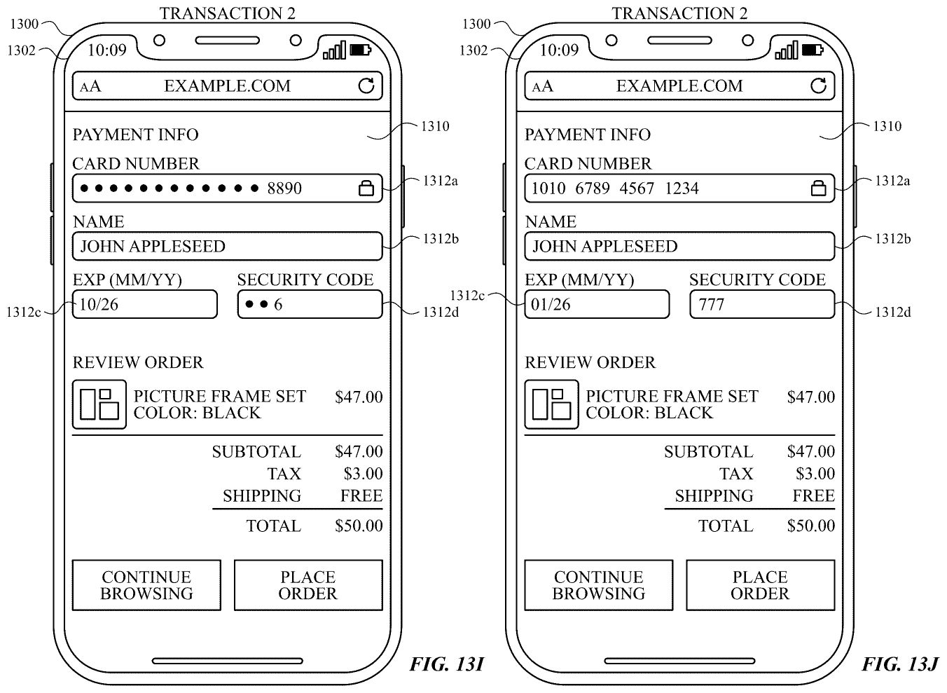

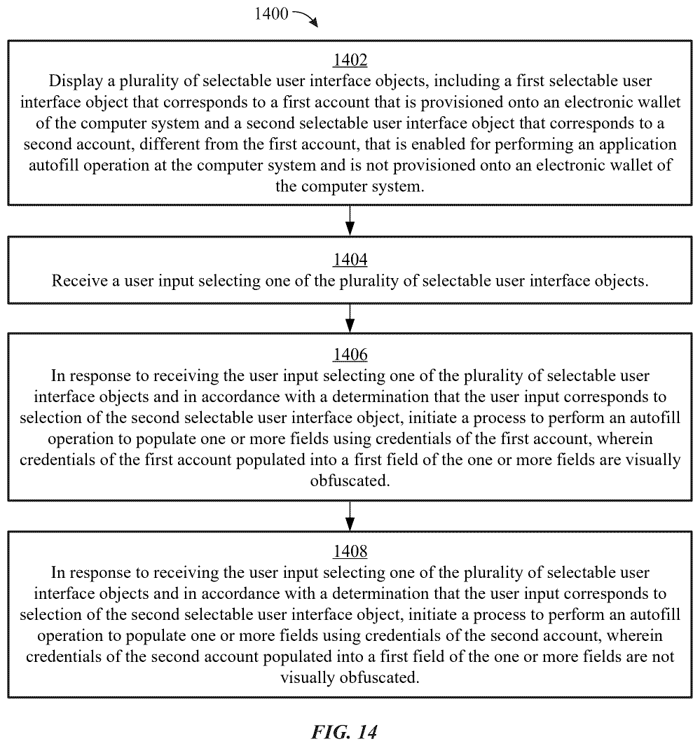

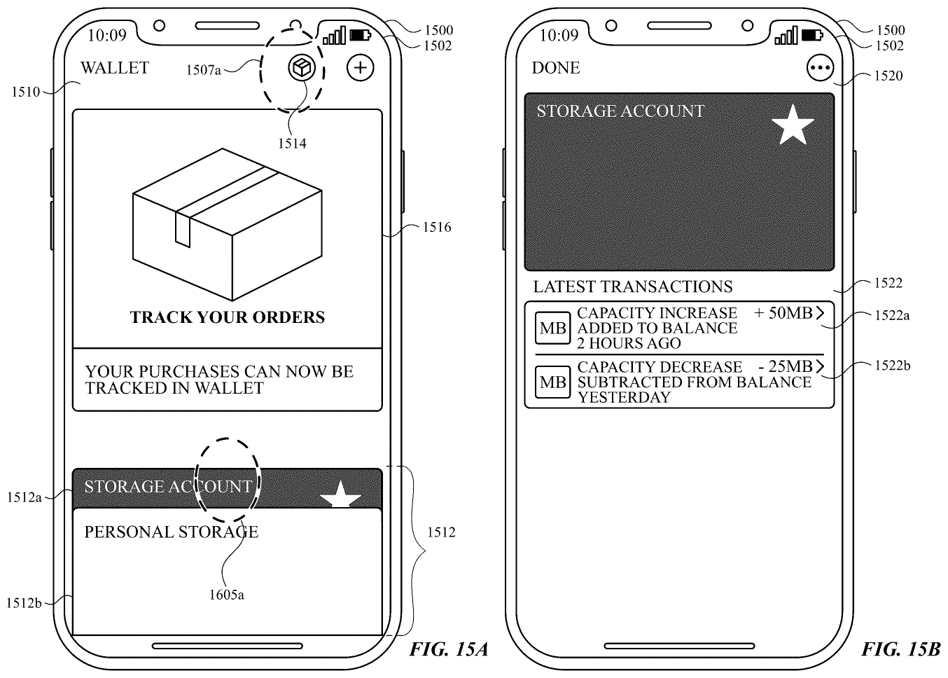

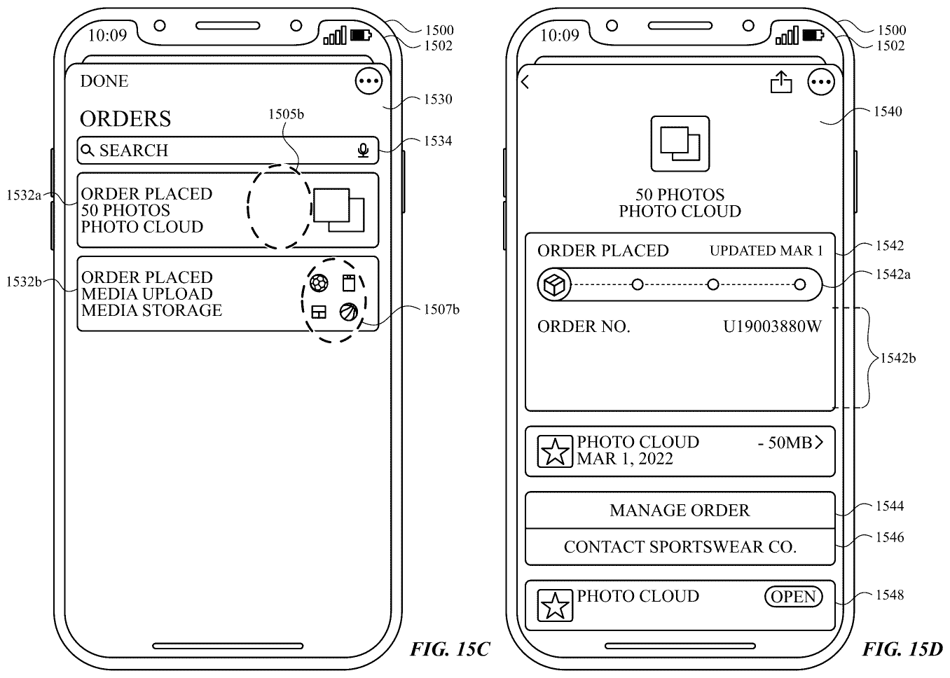

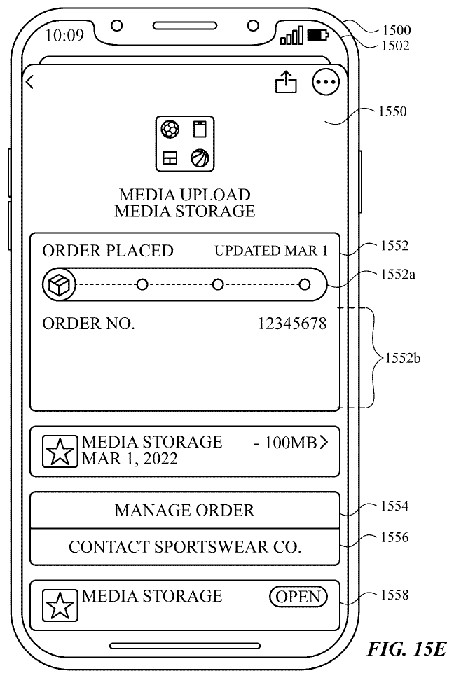

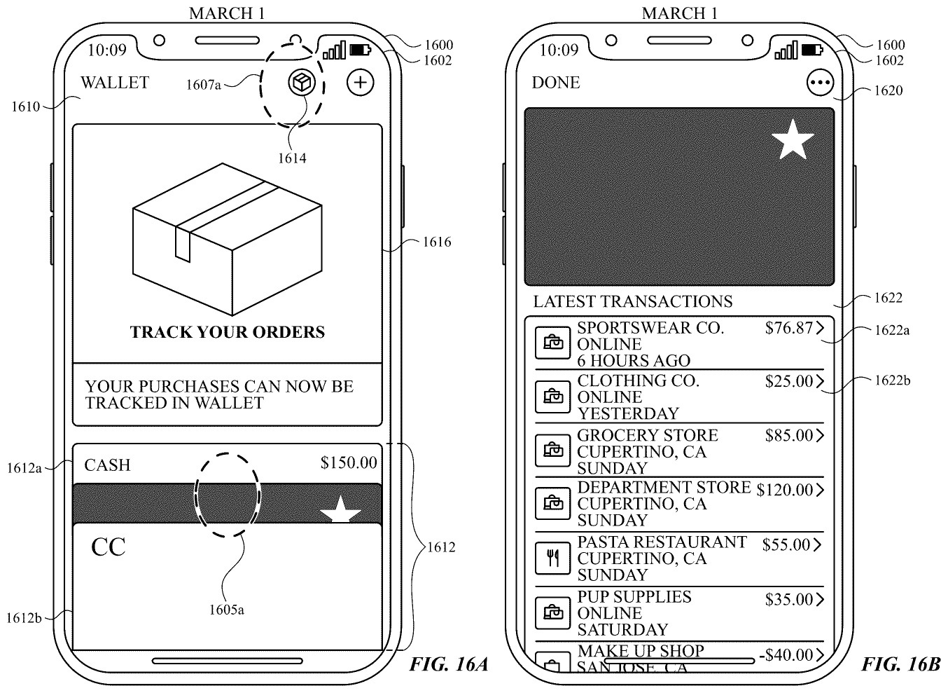

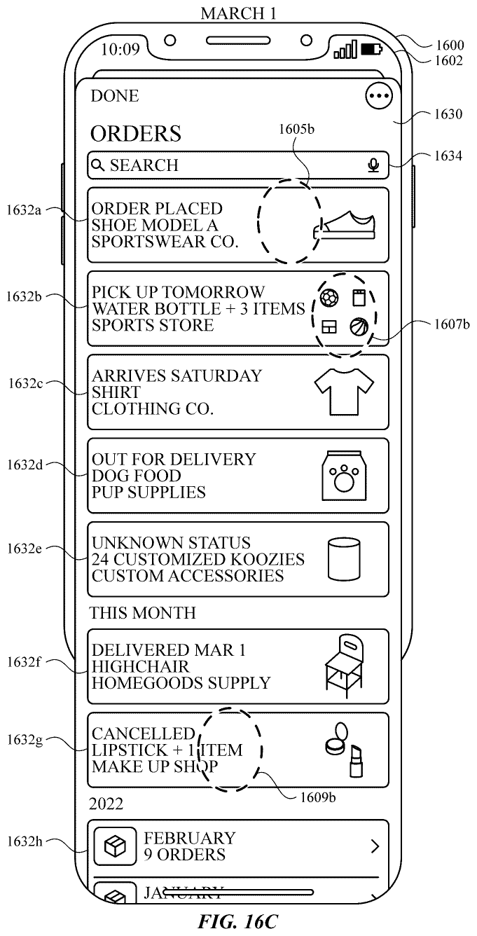

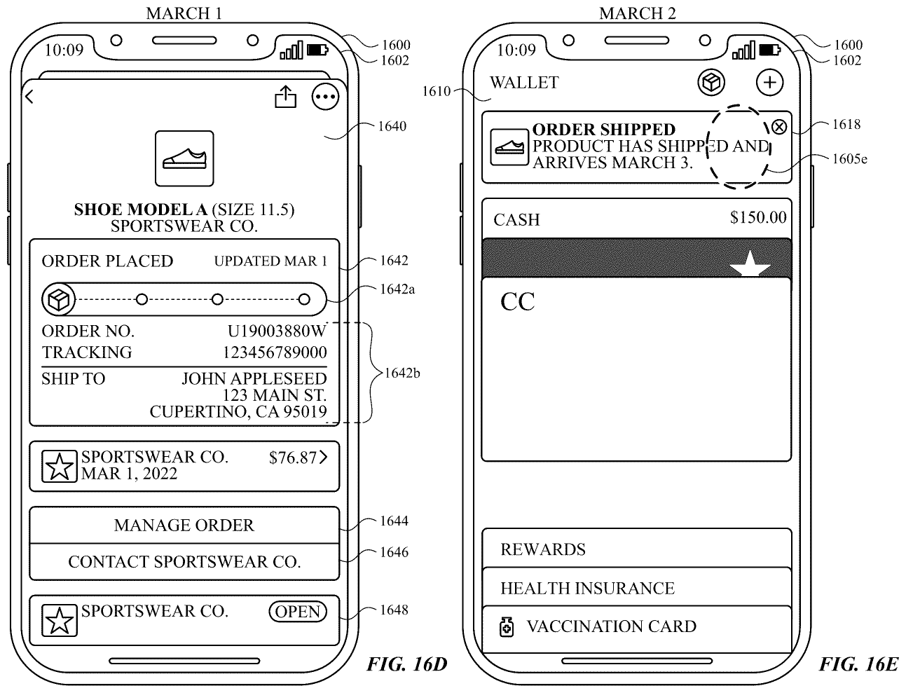

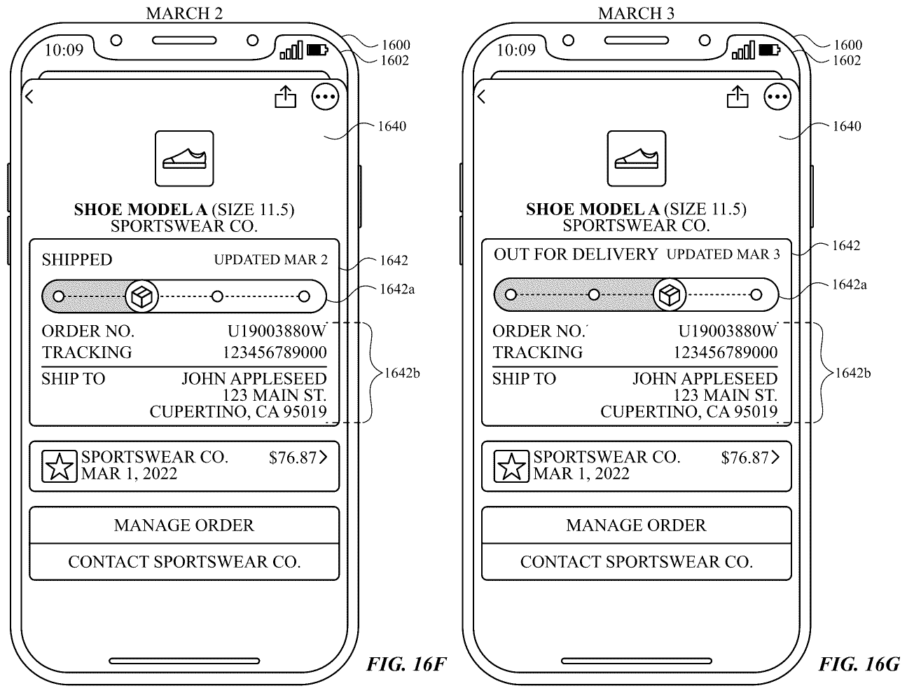

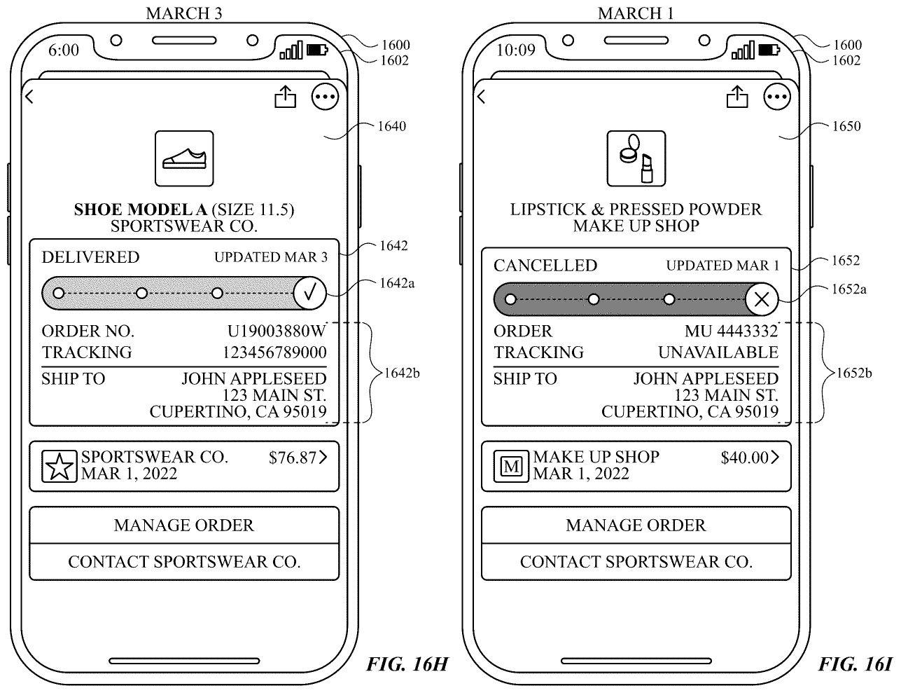

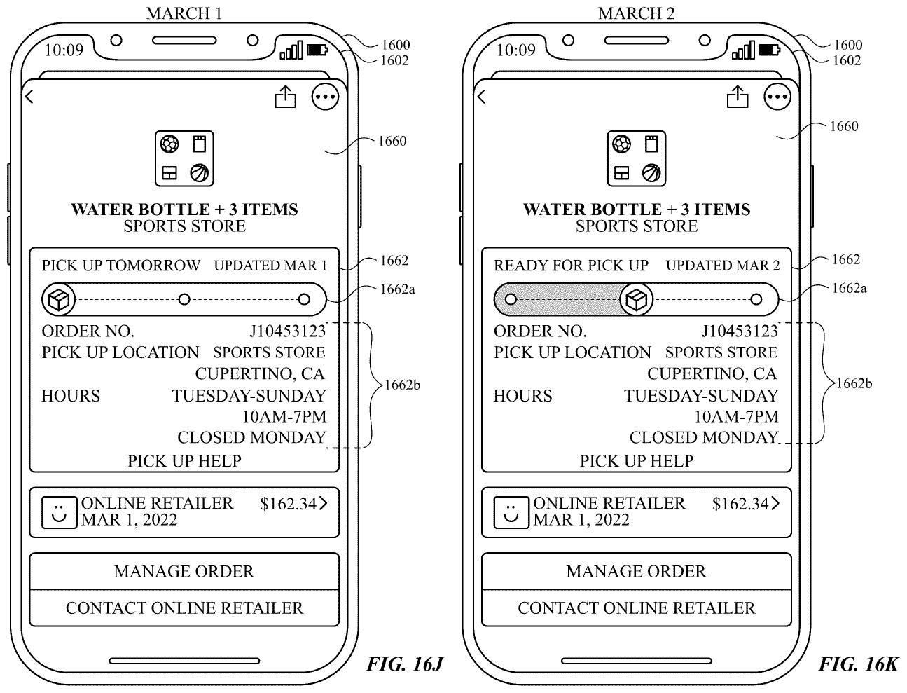

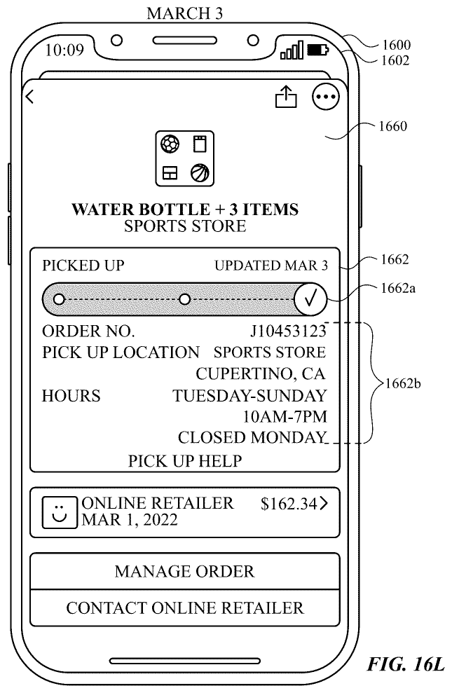

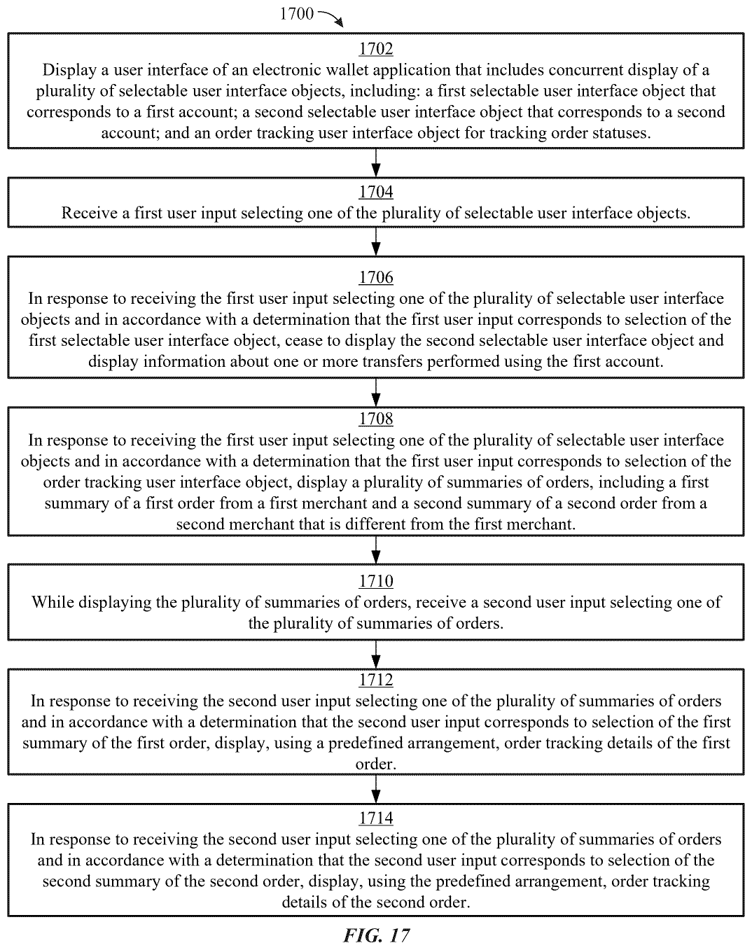

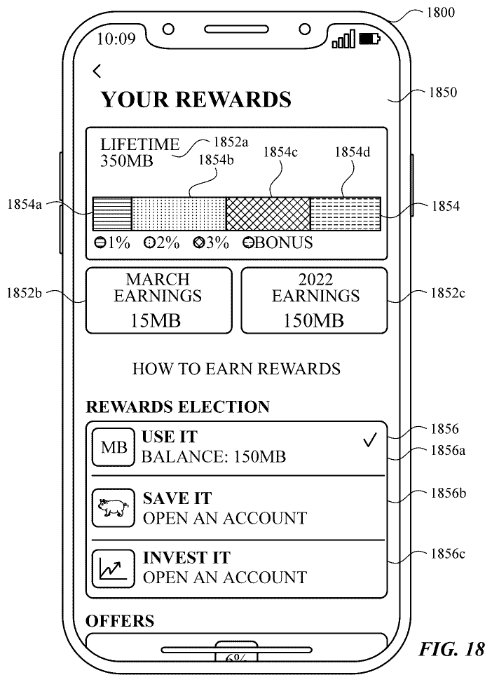

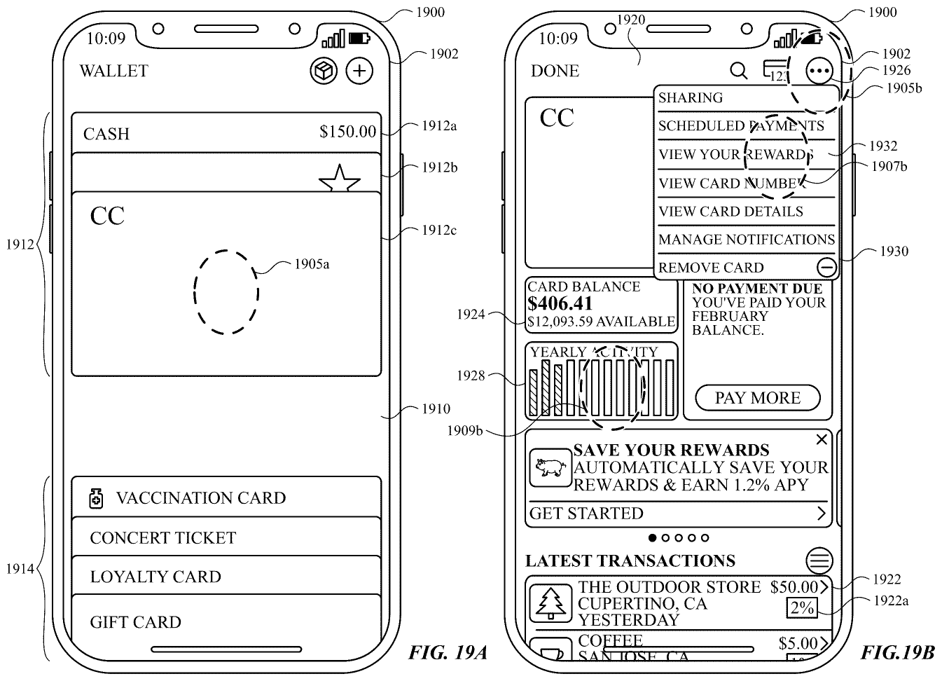

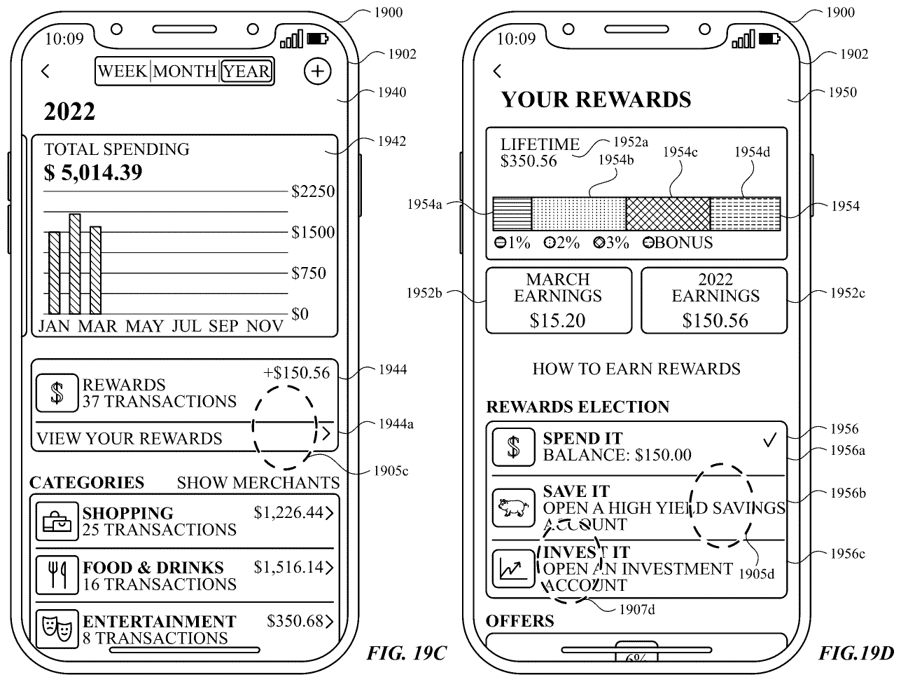

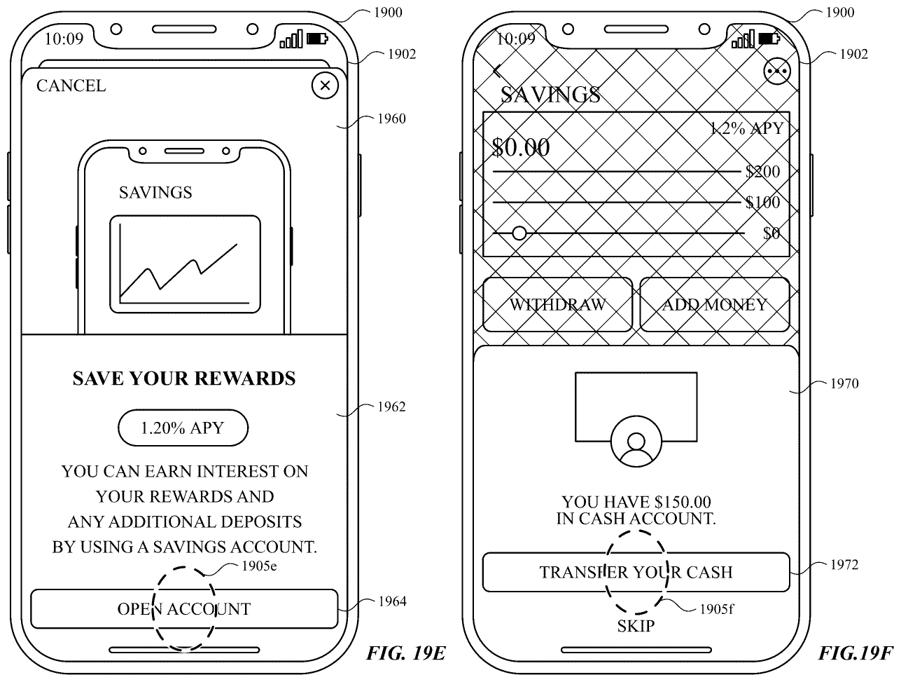

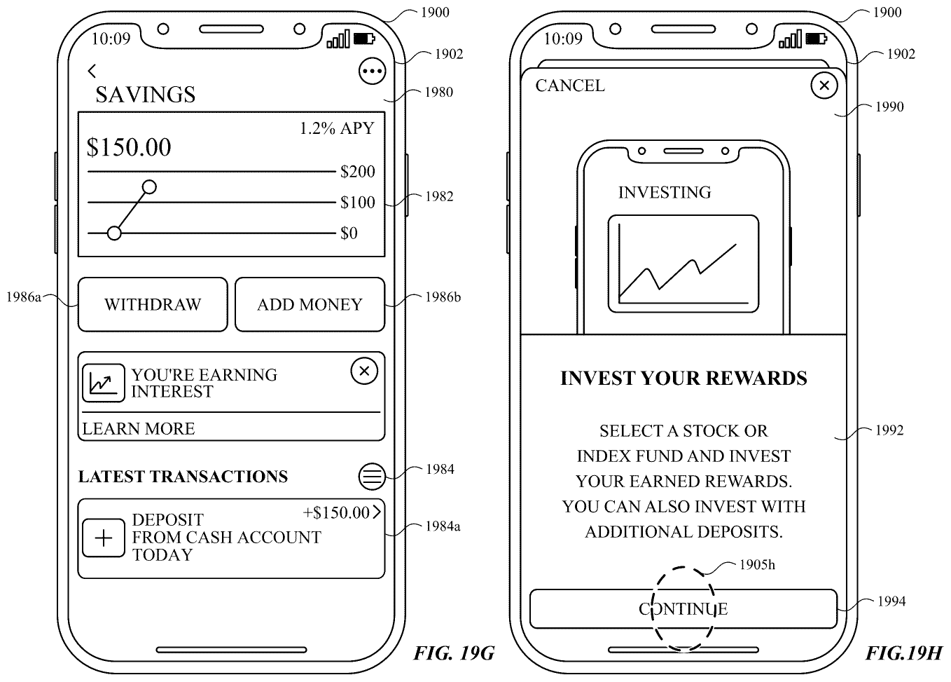

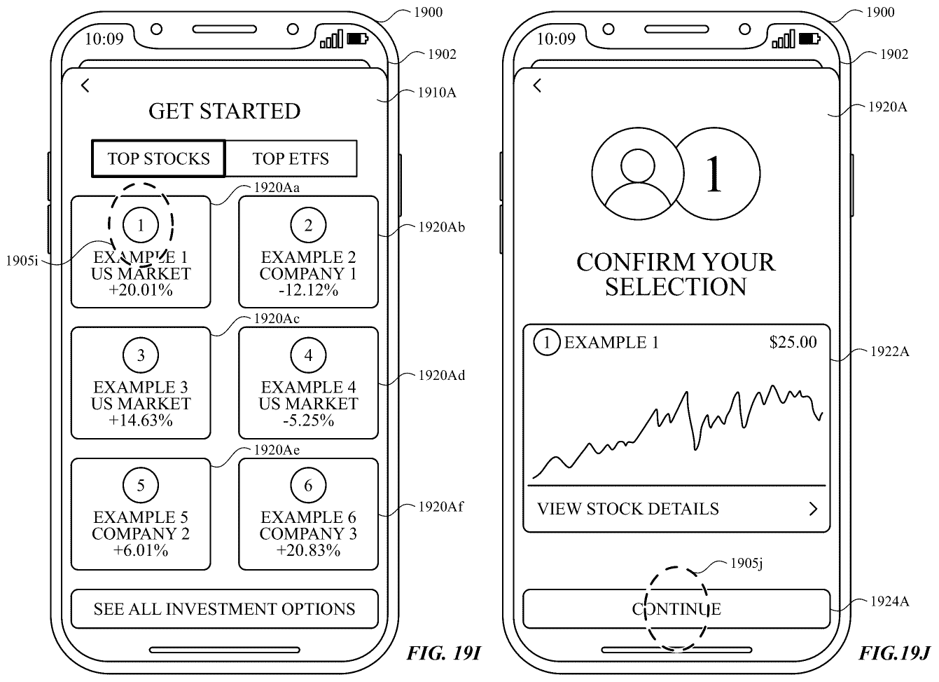

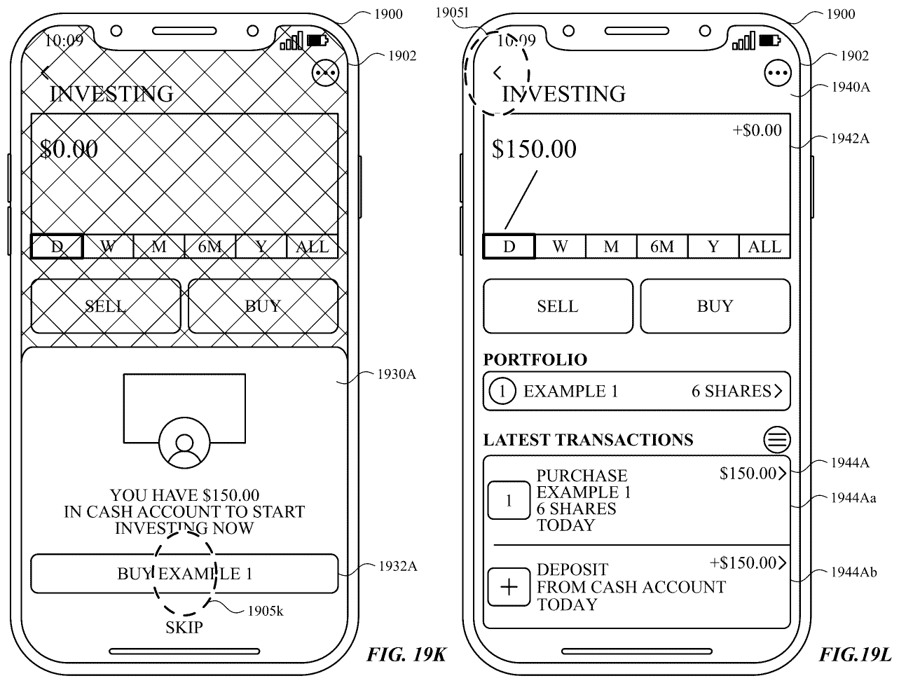

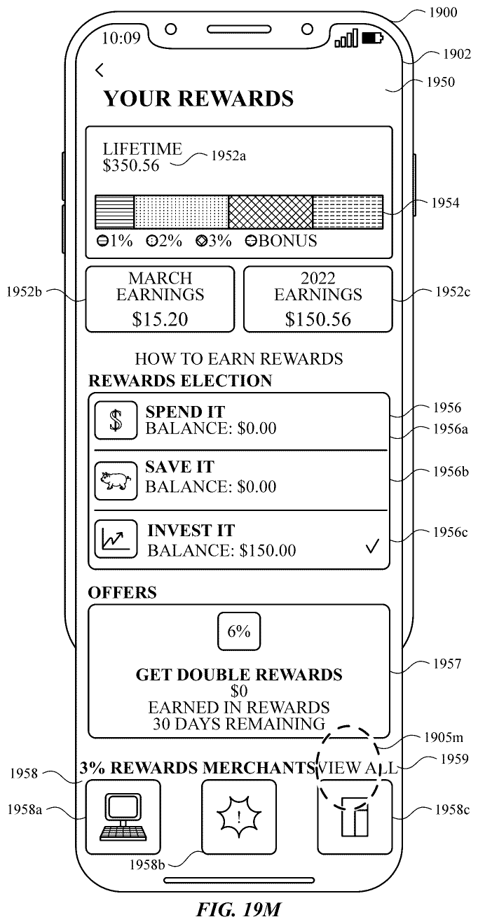

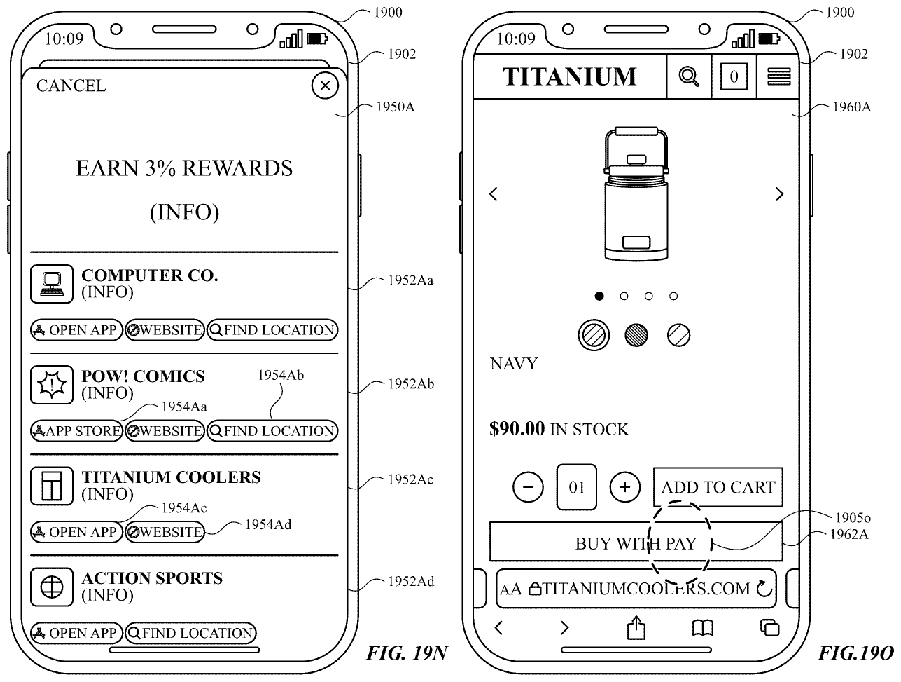

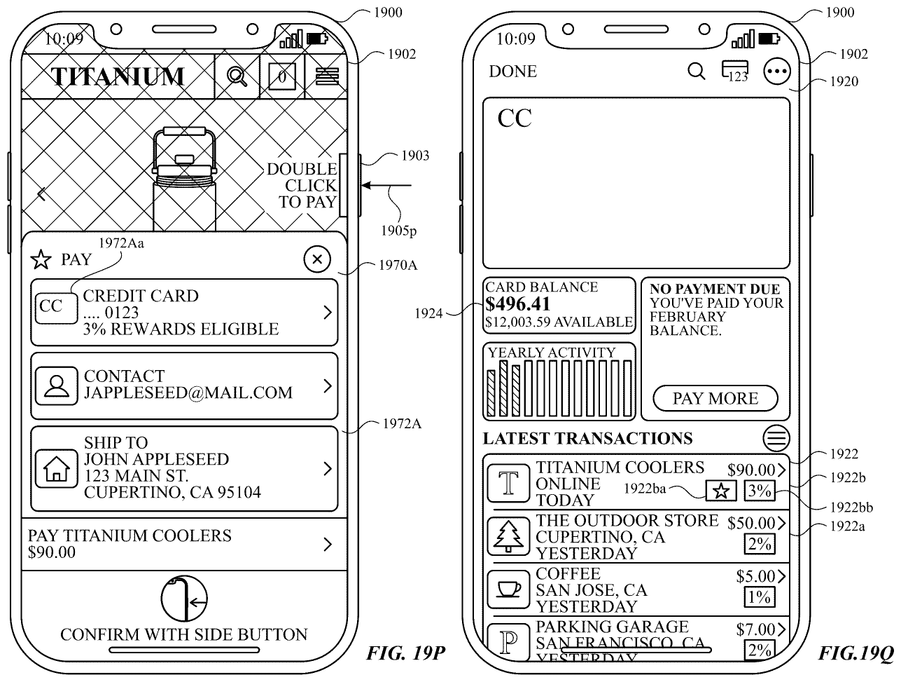

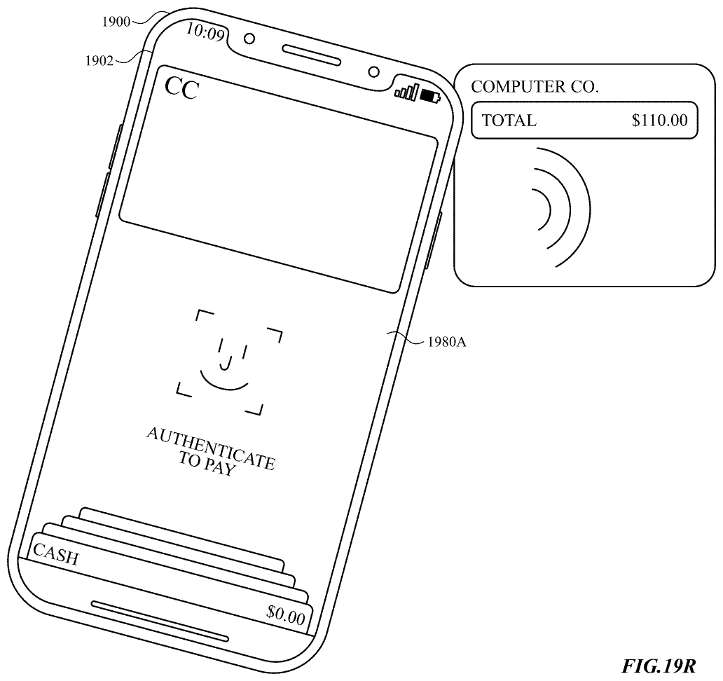

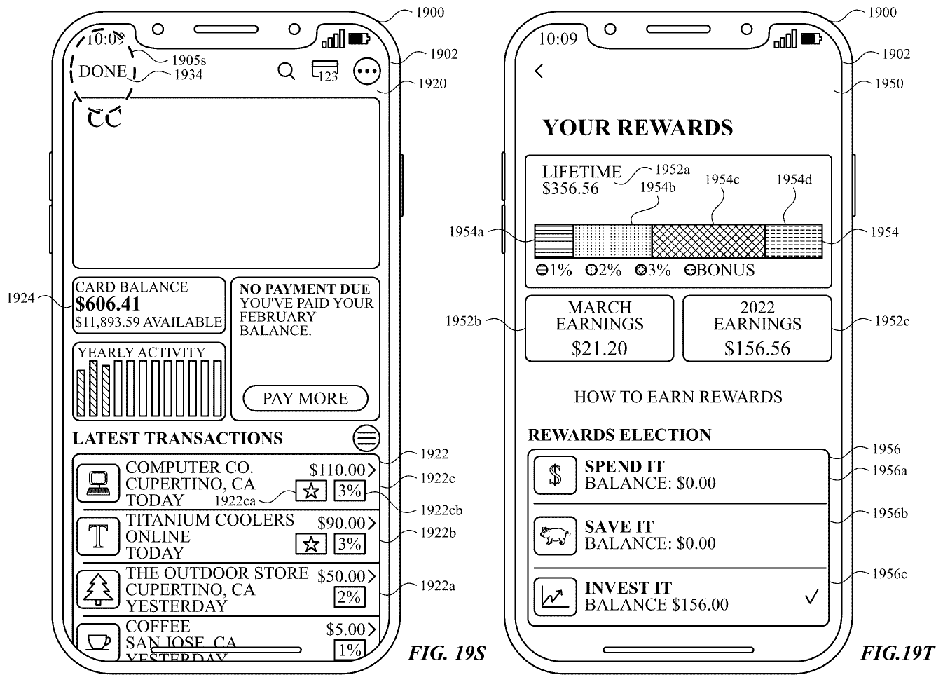

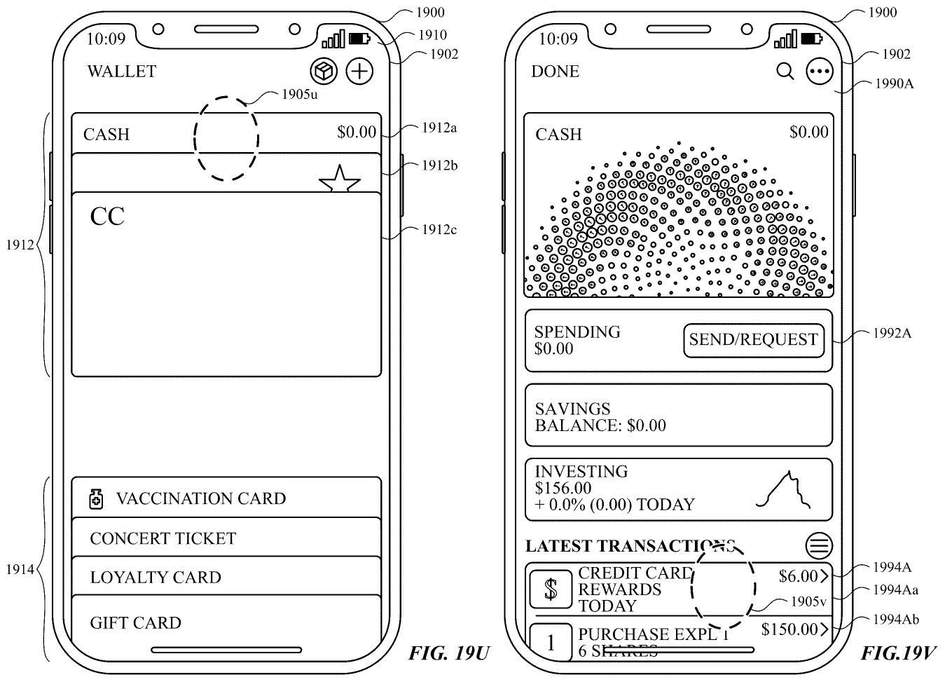

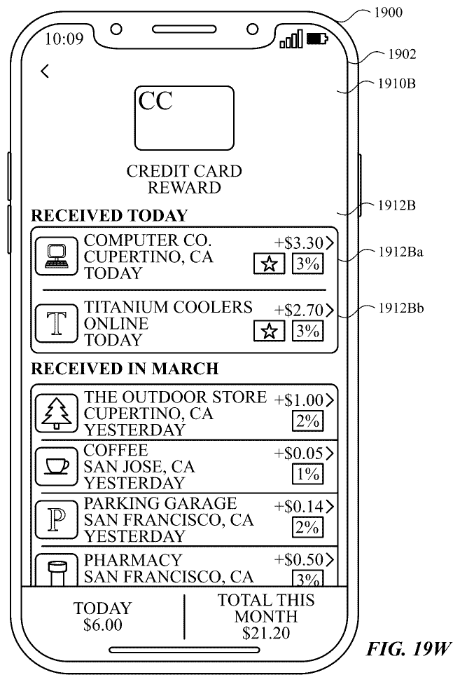

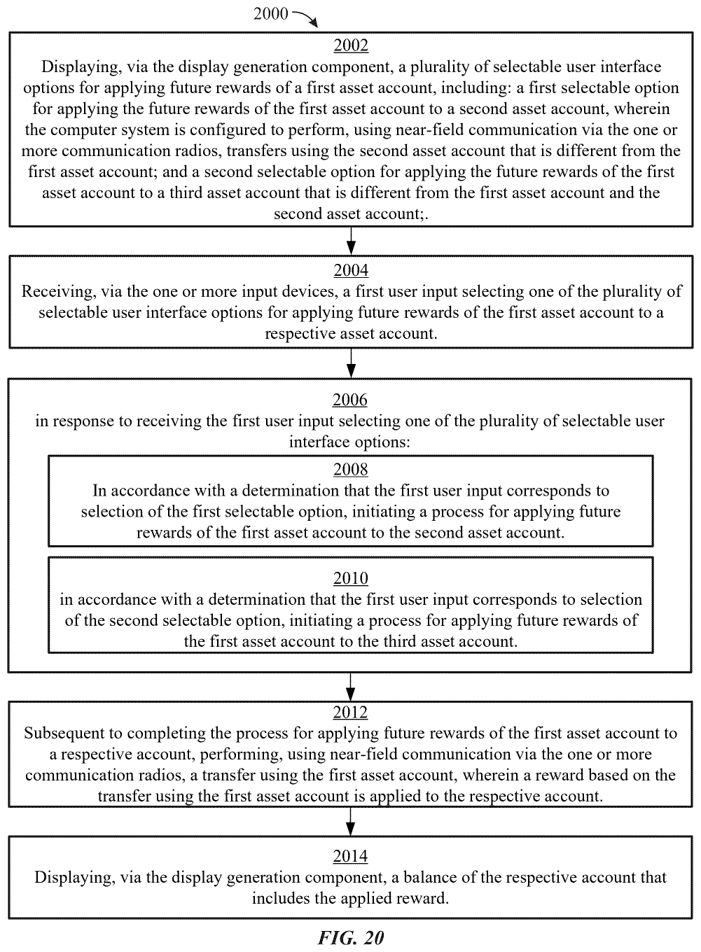

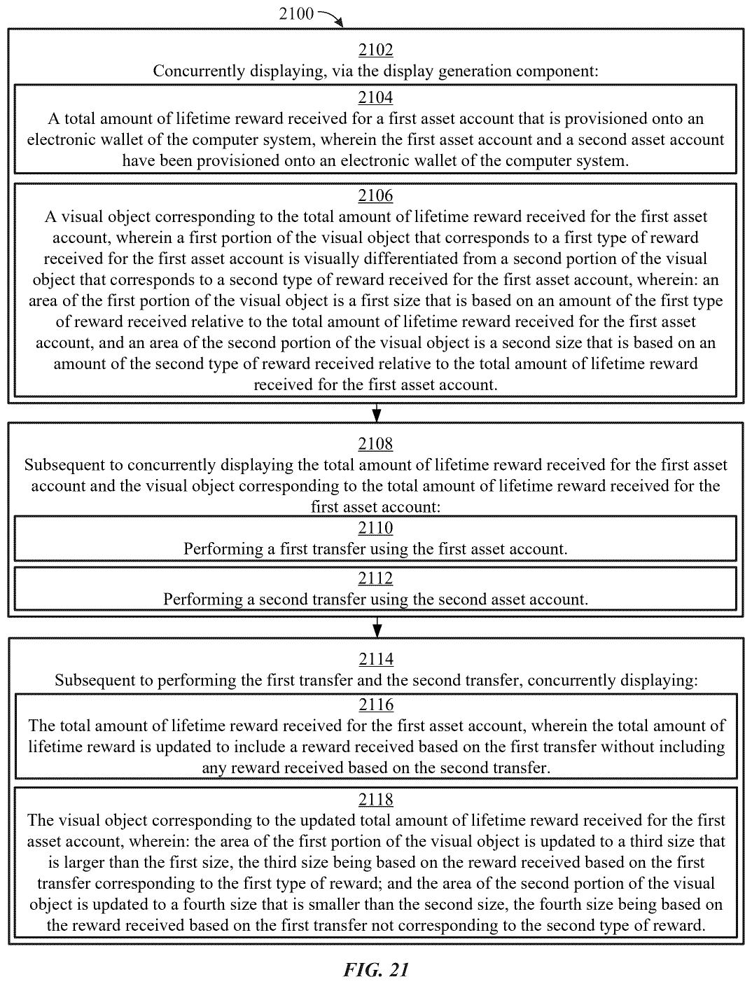

Below, FIGS. 1A-1B, 2, 3, 4A-4B, and 5A-5B provide a description of exemplary devices for performing the techniques for managing event notifications. FIG. 5C illustrates exemplary devices connected via one or more communication channels, in accordance with some embodiments. FIGS. 6A-6D illustrate exemplary user interfaces for managing storage account numbers. FIGS. 7A-7M illustrate exemplary user interfaces for managing virtual account numbers. FIG. 8 is a flow diagram illustrating methods of managing account numbers in accordance with some embodiments. The user interfaces in FIGS. 6A-6D and 7A-7M are used to illustrate the processes described below, including the processes in FIG. 9. FIGS. 9A-9C illustrate exemplary user interfaces for provisioning a storage account. FIGS. 10A-10H illustrate exemplary user interfaces for provisioning an account. FIG. 11 is a flow diagram illustrating methods of provisioning an account in accordance with some embodiments. The user interfaces in FIGS. 9A-9C and 10A-10H are used to illustrate the processes described below, including the processes in FIG. 11. FIGS. 12A-12C illustrate exemplary user interfaces for obfuscating credentials of a storage account. FIGS. 13A-13J illustrate exemplary user interfaces for obfuscating credentials of an account. FIG. 14 is a flow diagram illustrating methods of obfuscating credentials of an account in accordance with some embodiments. The user interfaces in FIGS. 12A-12C and 13A-13J are used to illustrate the processes described below, including the processes in FIG. 14. FIGS. 15A-15E illustrate exemplary user interfaces for managing orders. FIGS. 16A-16L illustrate exemplary user interfaces for managing orders. FIG. 17 is a flow diagram illustrating methods of managing orders in accordance with some embodiments. The user interfaces in FIGS. 15A-15E and 16A-16L are used to illustrate the processes described below, including the processes in FIG. 17. FIG. 18 illustrates an exemplary user interface for managing rewards for an account. FIGS. 19A-19W illustrate exemplary user interfaces for managing rewards for an account. FIG. 20 is a flow diagram illustrating methods of managing rewards for an account in accordance with some embodiments. FIG. 21 is a flow diagram illustrating methods of managing rewards for an account in accordance with some embodiments. The user interfaces in FIGS. 18 and 19A-19W are used to illustrate the processes described below, including the processes in FIG. 20 and FIG. 21.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

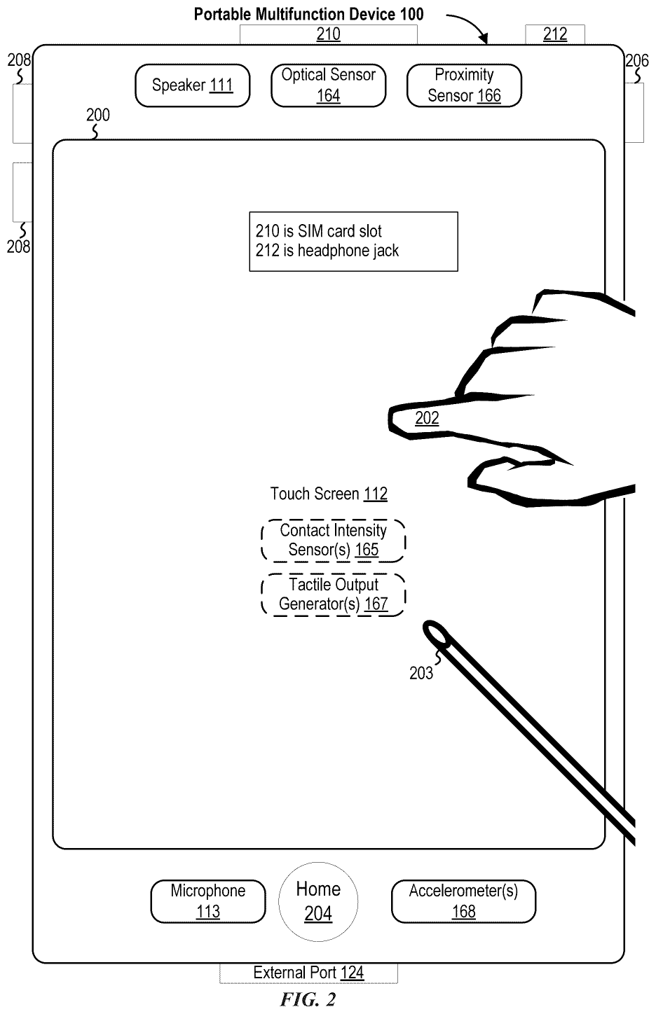

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

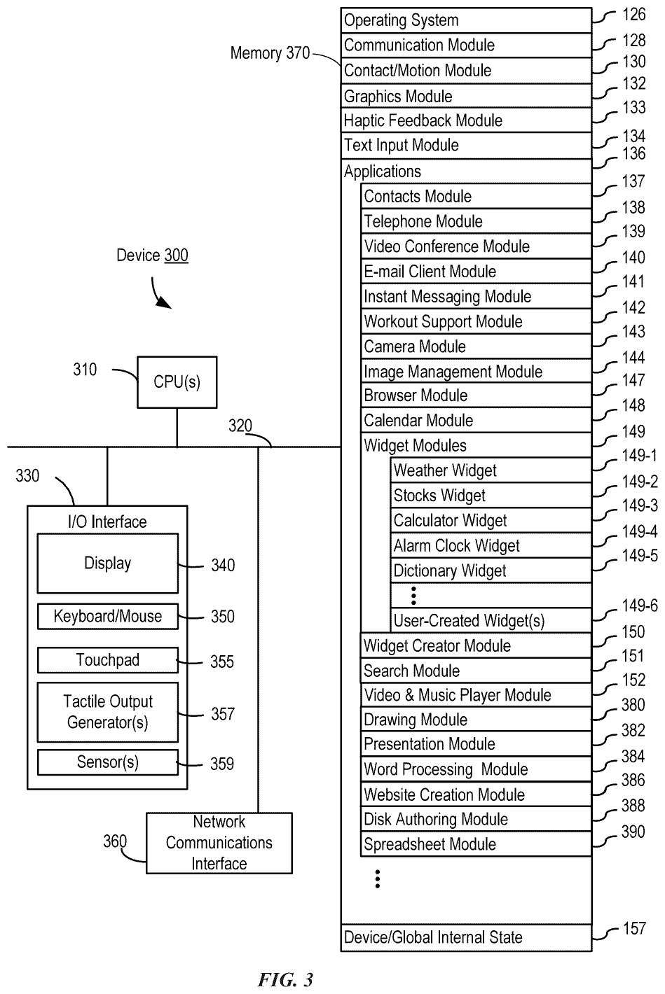

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

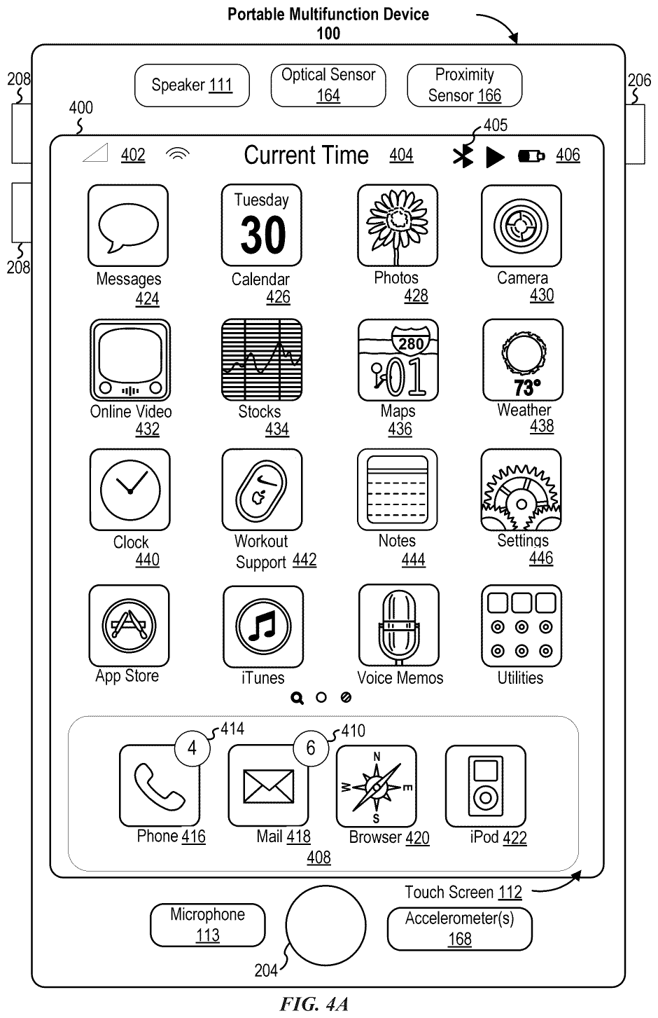

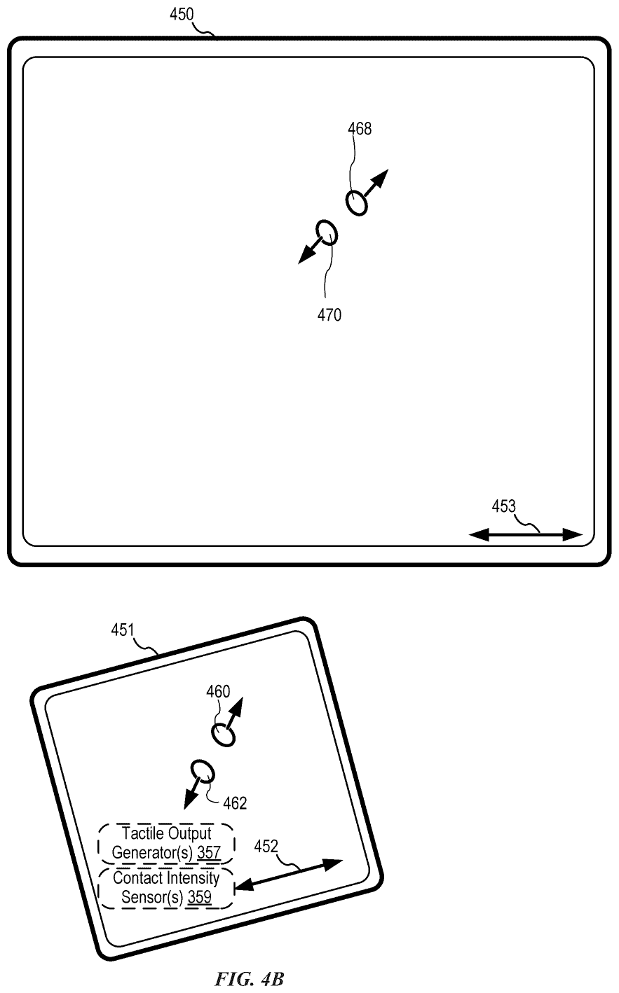

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 800 (FIG. 8), 1100 (FIG. 11), 1400, (FIG. 14), 1700 (FIG. 17), 2000 (FIG. 20), and 2100 (FIG. 21). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates exemplary devices connected via one or more communication channels to participate in a transaction in accordance with some embodiments. One or more exemplary electronic devices (e.g., devices 100, 300, and 500) are configured to optionally detect input (e.g., a particular user input, an NFC field) and optionally transmit payment information (e.g., using NFC). The one or more electronic devices optionally include NFC hardware and are configured to be NFC-enabled.

The electronic devices (e.g., devices 100, 300, and 500) are optionally configured to store payment account information associated with each of one or more payment accounts. Payment account information includes, for example, one or more of: a person's or company's name, a billing address, a login, a password, an account number, an expiration date, a security code, a telephone number, a bank associated with the payment account (e.g., an issuing bank), and a card network identifier. In some embodiments, payment account information includes include an image, such as a picture of a payment card (e.g., taken by the device and/or received at the device). In some embodiments, the electronic devices receive user input including at least some payment account information (e.g., receiving user-entered credit, debit, account, or gift card number and expiration date). In some embodiments, the electronic devices detect at least some payment account information from an image (e.g., of a payment card captured by a camera sensor of the device). In some embodiments, the electronic devices receive at least some payment account information from another device (e.g., another user device or a server). In some embodiments, the electronic device receives payment account information from a server associated with another service for which an account for a user or user device previously made a purchase or identified payment account data (e.g., an app for renting or selling audio and/or video files).

In some embodiments, a payment account is added to an electronic device (e.g., device 100, 300, and 500), such that payment account information is securely stored on the electronic device. In some embodiments, after a user initiates such process, the electronic device transmits information for the payment account to a transaction-coordination server, which then communicates with a server operated by a payment network for the account (e.g., a payment server) to ensure a validity of the information. The electronic device is optionally configured to receive a script from the server that allows the electronic device to program payment information for the account onto the secure element.

In some embodiments, communication among electronic devices 100, 300, and 500 facilitates transactions (e.g., generally or specific transactions). For example, a first electronic device (e.g., 100) can serve as a provisioning or managing device, and can send notifications of new or updated payment account data (e.g., information for a new account, updated information for an existing account, and/or an alert pertaining to an existing account) to a second electronic device (e.g., 500). In another example, a first electronic device (e.g., 100) can send data to a second election device, wherein the data reflects information about payment transactions facilitated at the first electronic device. The information optionally includes one or more of: a payment amount, an account used, a time of purchase, and whether a default account was changed. The second device (e.g., 500) optionally uses such information to update a default payment account (e.g., based on a learning algorithm or explicit user input).

Electronic devices (e.g., 100, 300, 500) are configured to communicate with each other over any of a variety of networks. For example, the devices communicate using a Bluetooth connection 558 (e.g., which includes a traditional Bluetooth connection or a Bluetooth Low Energy connection) or using a WiFi network 556. Communications among user devices are, optionally, conditioned to reduce the possibility of inappropriately sharing information across devices. For example, communications relating to payment information requires that the communicating devices be paired (e.g., be associated with each other via an explicit user interaction) or be associated with a same user account.

In some embodiments, an electronic device (e.g., 100, 300, 500) is used to communicate with a point-of-sale (POS) payment terminal 550, which is optionally NFC-enabled. The communication optionally occurs using a variety of communication channels and/or technologies. In some embodiments, electronic device (e.g., 100, 300, 500) communicates with payment terminal 550 using an NFC channel 560. In some embodiments, payment terminal 550 communicates with an electronic device (e.g., 100, 300, 500) using a peer-to-peer NFC mode. Electronic device (e.g., 100, 300, 500) is optionally configured transmit a signal to payment terminal 550 that includes payment information for a payment account (e.g., a default account or an account selected for the particular transaction).

In some embodiments, proceeding with a transaction includes transmitting a signal that includes payment information for an account, such as a payment account. In some embodiments, proceeding with the transaction includes reconfiguring the electronic device (e.g., 100, 300, 500) to respond as a contactless payment card, such as an NFC-enabled contactless payment card, and then transmitting credentials of the account via NFC, such as to payment terminal 550. In some embodiments, subsequent to transmitting credentials of the account via NFC, the electronic device reconfigures to not respond as a contactless payment card (e.g., requiring authorization before again reconfigured to respond as a contactless payment card via NFC).

In some embodiments, generation of and/or transmission of the signal is controlled by a secure element in the electronic device (e.g., 100, 300, 500). The secure element optionally requires a particular user input prior to releasing payment information. For example, the secure element optionally requires detection that the electronic device is being worn, detection of a button press, detection of entry of a passcode, detection of a touch, detection of one or more option selections (e.g., received while interacting with an application), detection of a fingerprint signature, detection of a voice or voice command, and or detection of a gesture or movement (e.g., rotation or acceleration). In some embodiments, if a communication channel (e.g., an NFC communication channel) with another device (e.g., payment terminal 550) is established within a defined time period from detection of the input, the secure element releases payment information to be transmitted to the other device (e.g., payment terminal 550). In some embodiments, the secure element is a hardware component that controls release of secure information. In some embodiments, the secure element is a software component that controls release of secure information.

In some embodiments, protocols related to transaction participation depend on, for example, device types. For example, a condition for generating and/or transmitting payment information can be different for a wearable device (e.g., device 500) and a phone (e.g., device 100). For example, a generation and/or transmission condition for a wearable device includes detecting that a button has been pressed (e.g., after a security verification), while a corresponding condition for a phone does not require button-depression and instead requires detection of particular interaction with an application. In some embodiments, a condition for transmitting and/or releasing payment information includes receiving particular input on each of multiple devices. For example, release of payment information optionally requires detection of a fingerprint and/or passcode at the device (e.g., device 100) and detection of a mechanical input (e.g., button press) on another device (e.g., device 500).

Payment terminal 550 optionally uses the payment information to generate a signal to transmit to a payment server 554 to determine whether the payment is authorized. Payment server 554 optionally includes any device or system configured to receive payment information associated with a payment account and to determine whether a proposed purchase is authorized. In some embodiments, payment server 554 includes a server of an issuing bank. Payment terminal 550 communicates with payment server 554 directly or indirectly via one or more other devices or systems (e.g., a server of an acquiring bank and/or a server of a card network).

Payment server 554 optionally uses at least some of the payment information to identify a user account from among a database of user accounts (e.g., 552). For example, each user account includes payment information. An account is, optionally, located by locating an account with particular payment information matching that from the POS communication. In some embodiments, a payment is denied when provided payment information is not consistent (e.g., an expiration date does not correspond to a credit, debit or gift card number) or when no account includes payment information matching that from the POS communication.

In some embodiments, data for the user account further identifies one or more restrictions (e.g., credit limits); current or previous balances; previous transaction dates, locations and/or amounts; account status (e.g., active or frozen), and/or authorization instructions. In some embodiments, the payment server (e.g., 554) uses such data to determine whether to authorize a payment. For example, a payment server denies a payment when a purchase amount added to a current balance would result in exceeding an account limit, when an account is frozen, when a previous transaction amount exceeds a threshold, or when a previous transaction count or frequency exceeds a threshold.

In some embodiments, payment server 554 responds to POS payment terminal 550 with an indication as to whether a proposed purchase is authorized or denied. In some embodiments, POS payment terminal 550 transmits a signal to the electronic device (e.g., 100, 300, 500) to identify the result. For example, POS payment terminal 550 sends a receipt to the electronic device (e.g., 100, 300, 500) when a purchase is authorized (e.g., via a transaction-coordination server that manages a transaction app on the user device). In some instances, POS payment terminal 550 presents an output (e.g., a visual or audio output) indicative of the result. Payment can be sent to a merchant as part of the authorization process or can be subsequently sent.

In some embodiments, the electronic device (e.g., 100, 300, 500) participates in a transaction that is completed without involvement of POS payment terminal 550. For example, upon detecting that a mechanical input has been received, a secure element in the electronic device (e.g., 100, 300, 500) releases payment information to allow an application on the electronic device to access the information (e.g., and to transmit the information to a server associated with the application).

Attention is now directed towards embodiments of user interfaces (“UI”) and associated processes that are implemented on an electronic device, such as portable multifunction device 100, device 300, or device 500.

FIGS. 6A-6D illustrate exemplary user interfaces for managing storage account numbers, in accordance with some embodiments. The user interfaces in these figures are used to illustrate the processes described below, including the processes in FIG. 8. In some embodiments, device 600 includes one or more features of devices 100, 300, and/or 500.

In FIG. 6A, electronic device 600 is displaying, on display 602 (e.g., touch screen 702), a user interface 610 of a transfer application (e.g., an electronic wallet application). In some embodiments, user interface 610 includes representations 612 (or portions thereof) corresponding to different accounts (e.g., transfer accounts) provisioned on electronic device 600. As shown, representations 612 include, for instance, representation 612a corresponding to a computer storage management account and representation 612b corresponding to a personal storage account. In some embodiments, representation 612a corresponds to a first-party manufacturer-issued (or branded) computer storage management account.

While displaying user interface 610, device 600 detects selection of representation 612a corresponding to the computer storage management account. In some embodiments, the selection of representation 612a is a tap gesture 605a on representation 612a of the computer storage management account. As shown in FIG. 7B, in response to detecting tap gesture 605a, device 600 displays storage account interface 620.

In some embodiments, storage account interface 620 includes storage transfer history 622, which shows a plurality of recent account activities corresponding to previously requested transfers (e.g., transfers of computer storage resources) associated with the computer storage management account. As an example, transfer history 622 includes a first transfer 622a corresponding to a request to transfer a specified amount (e.g., 50 MB) to the computer storage management account. As another example, transfer history 622 includes a second transfer 622b corresponding to a request to transfer a specified amount (e.g., 25 MB) from the computer storage management account. As shown, first transfer 622a and second transfer 622b of transfer history 622 include respective dates indicating, for example, a date upon which the request for the transfer was made (or when the respective operation was completed).

In some embodiments, storage account interface 620 further includes notification 624 (e.g., based on electronic device 600 determining that the computer storage management account is compatible with a virtual account feature and/or that the virtual account feature is not enabled for the computer storage management account), indicating that a virtual account feature may be enabled for the computer storage management account. In some embodiments, the virtual account feature allows for a virtual account number to be provided to (e.g., assigned to) the computer storage management account such that transfers for the computer storage management account may be made using the virtual account number. In some embodiments, the virtual account feature allows for different account credentials (e.g., account number, account security code) associated with the computer storage management account to be used for successive transfers (e.g., each transfer of a plurality of transfers uses different account credentials). In some embodiments, notification 624 includes setup affordance 624a which, when selected, initiates a process for enabling the virtual account feature for the computer storage management account. For example, while displaying storage account interface 620, device 600 detects selection of setup affordance 624a. In some embodiments, the selection is a tap gesture 605b on setup affordance 624a. As shown in FIG. 6C, in response to detecting tap gesture 605b, device 700 displays setup interface 630. In some embodiments, setup interface 630 is overlaid on storage account interface 620.

Setup interface 630 includes confirmation affordance 632, the selection of which initiates a process to (and/or confirms a user intent to initiate a process to) enable the virtual account feature for the computer storage management account. Thereafter, device 600 performs the process to enable the virtual account feature for the computer storage management account.

With reference to FIG. 6A, in some embodiments, a user may select a representation of a computer storage management account that is not compatible with the virtual account feature. For example, while displaying user interface 610, device 600 detects selection of representation 612b. In some embodiments, the selection of representation 612b is a tap gesture 607a on representation 612b of the transfer account. As shown in FIG. 6D, in response to detecting tap gesture 605a, device 600 displays storage account interface 610A. Because the transfer account corresponding to storage account interface 610A is not compatible with the virtual account feature, device 600 displays storage account interface 610A without a notification (e.g., notification 624) indicating that the virtual account feature may be enabled for the computer storage management account corresponding to storage account interface 610A.

FIGS. 7A-7M illustrate exemplary user interfaces for managing virtual account numbers, in accordance with some embodiments. The user interfaces in these figures are used to illustrate the processes described below, including the processes in FIG. 8. In some embodiments, device 700 includes one or more features of devices 100, 300, and/or 500.

In some embodiments, virtual account numbers described herein are associated with a user account (or multiple user accounts). In some embodiments, the user account is a transfer account. In some embodiments, the transfer account is a first-party transfer account (e.g., a transfer account that is issued or branded by, for example, the manufacturer of the electronic device), and, optionally, provides rewards (e.g., cash back rewards and/or bonus points rewards) based on the amount of transfers (e.g., payment transactions and/or points transfers) made using the transfer account (e.g., cash back rewards that are based on a certain percentage of the value of each transaction) and/or made using a different account. In some embodiments, the transfer account is a points account (e.g., for meal points, for printer credits, and/or for membership points) that provides rewards (e.g., points rewards) based on the amount of points used using the transfer account.

FIGS. 7A-7F illustrate an example for providing a virtual account number for a user account.

FIG. 7A illustrates electronic device 700. In FIG. 7A, electronic device 700 is a portable multifunction device and has one or more components described above in relation to one or more of devices 100, 300, and 500.

In FIG. 7A, electronic device 700 is displaying, on display 702 (e.g., touch screen 702), a user interface 710 of a transfer application (e.g., an electronic wallet application). In some embodiments, user interface 710 includes representations 712 corresponding to different transfer accounts (e.g., payment accounts, such as a third-party credit card account, a debit card account, and/or a stored-value account; points accounts; and/or rewards accounts) provisioned on electronic device 700. As shown, representations 712 include, for instance, a representation 712a corresponding to a transfer account and a representation 712b corresponding to a medical account (e.g., HSA account). In some embodiments, representation 712a corresponds to a first-party transfer account. In some embodiments, user interface 710 includes representations 714 (e.g., representations 714a-714c) corresponding to other various accounts (e.g., transfer accounts, points cards, and/or rewards cards), ID cards (e.g., student ID and/or government-issued ID), and/or tickets (e.g., event ticket and/or boarding pass ticket) provisioned on or otherwise linked to the electronic device 700.

While displaying user interface 710, device 700 detects selection of representation 712a corresponding to the transfer account. In some embodiments, the selection of representation 712a is a tap gesture 705a on representation 712a of the transfer account. As shown in FIG. 7B, in response to detecting tap gesture 705a, device 700 displays transfer account interface 720.

In some embodiments, transfer account interface 720 includes transfer history 722, which shows a plurality of recent account activities corresponding to previously requested transfers (e.g., transfers of funds) associated with the transfer account. As an example, transfer history 722 includes a first transfer 722a corresponding to a request to transfer a specified amount (e.g., $5.01) from the transfer account. As another example, transfer history 722 includes a second transfer 722b corresponding to a request to transfer a specified amount (e.g., $12.96) from the transfer account. As shown, first transfer 722a and second transfer 722b of transfer history 722 include respective dates indicating, for example, a date upon which the request for the transfer was made (or when the respective operation was completed).

In some embodiments, transfer account interface 720 further includes notification 724 (e.g., based on electronic device 700 determining that the transfer account is compatible with the virtual account feature and/or that the virtual account feature is not enabled for the transfer account), indicating that a virtual account feature may be enabled for the transfer account. In some embodiments, the virtual account feature allows for a virtual account number to be provided to (e.g., assigned to) the transfer account such that transactions for the transfer account may be made using the virtual account number. In some embodiments, the virtual account feature allows for different account credentials (e.g., account number, security code, CCV, and/or CVV) associated with the transfer account to be used for successive transfers (e.g., each transfer of a plurality of transfers uses different account credentials). In some embodiments, notification 724 includes setup affordance 724a which, when selected, initiates a process for enabling the virtual account feature for the transfer account. For example, while displaying transfer account interface 720, device 700 detects selection of setup affordance 724a. In some embodiments, the selection is a tap gesture 705b on setup affordance 724a. As shown in FIG. 7C, in response to detecting tap gesture 705b, device 700 displays setup interface 730. In some embodiments, setup interface 730 is overlaid on transfer account interface 720.

Setup interface 730 includes confirmation affordance 732, the selection of which confirms a user intent to initiate a process to enable the virtual account feature for the transfer account. While displaying setup interface 730, device 700 detects selection of confirmation affordance 732. In some embodiments, the selection is a tap gesture 705c on confirmation affordance 732. As shown in FIG. 7D, in response to detecting tap gesture 705c, device 700 displays authentication interface 740. In some embodiments, in response to detecting tap gesture 705c, device 700 displays (e.g., replaces display of setup interface 730 with) transfer account interface 720 and overlays authentication interface 740 on transfer account interface 720.

Authentication interface 740 includes instructions 742 instructing a user to provide an input (e.g., a press of a button on device 700 and/or a double press of a button on device 700) to authorize the enabling the virtual account feature. While displaying authentication interface 740, device 700 detects input 705d (e.g., a double press of button 703), and in response, device 700 authenticates a user of device 700. As shown in FIG. 7E, for example, device 700 modifies authentication user interface to include glyph 746, indicating that device 700 is performing biometric authentication (e.g., facial authentication, fingerprint authentication, and/or iris authentication) of the user.

As shown in FIG. 7F, once a user of device 700 has been authenticated, device 700 displays virtual account number interface 750. Virtual number interface includes status 752, indicating that the virtual account feature is being enabled for the transfer account. Optionally, status 752 includes an animation 752a which serves as a dynamic indicator that the virtual account feature is being enabled.

As shown in FIG. 7G, once the virtual account feature has been enabled for the transfer account, device 700 displays (e.g., replaces display of virtual account number interface 750 with) completion interface 760. In some embodiments, completion interface 760 includes status 764 indicating that the virtual account feature has been enabled for the transfer account. Optionally, status 764 includes indicator 764a (e.g., a checkmark), providing a non-textual indication that the feature has been enabled.

In some embodiments, completion interface 760 includes affordance 766 which, when selected, allows a user to enable a virtual account feature for one or more other transfer accounts. For example, while displaying completion interface 760, device 700 detects selection of affordance 766. In some embodiments, the selection is a tap gesture 705g on affordance 766. As shown in FIG. 7H, in response to detecting selection of affordance 766, device 700 displays account selection interface 770.

Account selection interface 770 includes candidate accounts 772, each of which corresponds to a transfer account provisioned on device 700. In some embodiments, candidate accounts 772 includes only transfer accounts that are compatible with (e.g., eligible for and/or capable of being configured with) the virtual account feature and/or that are not currently enabled for the virtual account feature. While account selection interface 770 is displayed, a user optionally selects any number of candidate accounts 772 (e.g., candidate account 772a and/or candidate account 772b). Thereafter, device 700 detects selection of continue affordance 774, and in response initiates a process to enable the virtual account feature for each selected candidate account. In some embodiments, the virtual account feature is enabled for each selected candidate account serially. In some embodiments, the virtual account feature is enabled for each selected candidate account concurrently.

With reference once again to FIG. 7G, completion interface 760 includes finish affordance 768 which, when selected, causes device 700 to display transfer account interface 720. For example, while displaying completion interface 760, device 700 detects selection of finish affordance 768. In some embodiments, the selection is a tap gesture 707g on finish affordance 768. As shown in FIG. 7I, in response to detecting selection of finish affordance 768, device 700 displays transfer account interface 720.

Because the virtual account feature has been enabled for the transfer account corresponding to transfer account interface 720, device 700 displays, in transfer account interface 720, notification 726 indicating that the virtual account feature has been enabled (e.g., a virtual account number has been provided) for the transfer account (e.g., rather than notification 724).

In some embodiments, a user may wish to access and/or view, for a transfer account, a virtual account number corresponding to the virtual account feature. In some embodiments, a virtual account number is viewed using the transfer account interface 720. By way of example, while displaying transfer account interface 720, device 700 detects selection of menu affordance 780. In some embodiments, the selection is a tap gesture 705i on menu affordance 780. In response to detecting selection of menu affordance 780, device 700 displays menu 784 including information affordance 784a.

While displaying menu 784, device 700 detects selection of information affordance 784a. In some embodiments, the selection is a tap gesture 707i on information affordance 784a. As shown in FIG. 7J, in response to detecting selection of information affordance 784a, device 700 displays authentication glyph 788. In some embodiments, authentication glyph 788 is overlaid on transfer account interface 720.

Generally, authentication glyph (and optionally, one or more other glyphs) is displayed to indicate that device 600 is performing biometric authentication (e.g., facial authentication, fingerprint authentication, and/or iris authentication) of the user. As shown in FIG. 7K, once a user of device 700 has been authenticated, device 700 displays information interface 790. Information interface 790 includes virtual account number 792 and expiration date 794, which, in some embodiments, is an expiration date of virtual account number 792. Information interface 790 further includes security code 796. In some embodiments, security code 796 is a rotating security code (e.g., as indicated by indicator 796A) for virtual account number 792 that changes periodically (e.g., after each transaction using the transfer account and/or once a day).

Information interface 790 further includes account information affordance 798. In response to selection of account information affordance 798, device 700 provides at least a portion of a physical account number for the transfer account and/or at least a portion of a virtual account number for the transfer account. For example, while displaying information interface 790, device 700 detects selection of information affordance 798. In some embodiments, the selection is a tap gesture 705k on information affordance 798. As shown in FIG. 7L, in response to detecting selection of information affordance 798, device 700 displays number interface 700A including physical account number 702A corresponding to the transfer account and virtual account number 704A corresponding to the transfer account. In some embodiments, virtual account number 792 and virtual account 704A are a same virtual account number.

With reference to FIG. 7A, in some embodiments, a user may select a representation of a transfer account that is not compatible with the virtual account feature. For example, while displaying user interface 710, device 700 detects selection of representation 712b. In some embodiments, the selection of representation 712b is a tap gesture 707a on representation 712b of the transfer account. As shown in FIG. 7M, in response to detecting tap gesture 705a, device 700 displays transfer account interface 710A. Because the transfer account corresponding to transfer account interface 710A is not compatible with the virtual account feature, device 700 displays transfer account interface 710A without a notification (e.g., notification 724) indicating that the virtual account feature may be enabled for the transfer account corresponding to transfer account interface 710A.

FIG. 8 is a flow diagram illustrating a method for managing account numbers in accordance with some embodiments. Method 800 is performed at a computer system (e.g., 100, 300, 500, and/or 700) (e.g., a smart watch, a smart phone, a head mounted device (e.g., a head mounted augmented reality and/or extended reality device), a self-motive device and/or system, and/or a personal computer) that is in communication with a display generation component (e.g., an integrated display, a head mounted display system, and/or a display controller) and one or more input devices (e.g., a touch-sensitive surface (e.g., a touchscreen), a mouse, and/or a keyboard). Some operations in method 800 are, optionally, combined, the orders of some operations are, optionally, changed, and some operations are, optionally, omitted.

As described below, method 800 provides an intuitive way for managing account numbers. The method reduces the cognitive burden on a user for managing account numbers, thereby creating a more efficient human-machine interface. For battery-operated computing devices, enabling a user to manage account numbers faster and more efficiently conserves power and increases the time between battery charges.

In some embodiments, the computer system (e.g., 600 and/or 700) concurrently displays (802), via the display generation component (e.g., 602 and/or 702), a portion (e.g., all or less than all) of a first visual representation (e.g., 612a and/or 712a) corresponding to a first asset account (e.g., a memory allocation account, a printing allocation account, a transit system account, a payment account, or a store loyalty account) that has been provisioned onto an electronic wallet of the computer system and a portion (e.g., all or less than all) of a second visual representation (e.g., 612b and/or 712b), different from the first visual representation, corresponding to a second asset account (e.g., a memory allocation account, a printing allocation account, a transit system account, a payment account, or a store loyalty account) that has been provisioned onto an electronic wallet of the computer system and that is different from the first asset account. In some embodiments, the portion of the first visual representation and the portion of the second visual representation are displayed as part of an electronic wallet application of the computer system. In some embodiments, the first asset account and the second asset account belong to a user of the computer system and/or are provisioned onto the computer system. In some embodiments, one or more details of the provisioned asset accounts are stored in a secure element of the computer system as part of the provisioning process. In some embodiments, a secure element is a hardware component (e.g., a secure microcontroller chip) (e.g., of the computer system) configured to securely store data or an algorithm such that the securely stored data is not accessible by the computer system without proper authentication information from a user of the computer system. Keeping the securely stored data in a secure element that is separate from other storage on the computer system prevents access to the securely stored data even if other storage locations on the computer system are compromised (e.g., by malicious code or other attempts to compromise information stored on the computer system). In some embodiments, the secure element provides (or releases) account information (e.g., an account number and/or a transaction-specific dynamic security code). In some examples, the secure element provides (or releases) the account information in response to the computer system receiving authorization, such as a user authentication (e.g., biometric authentication (e.g., fingerprint authentication; facial authentication; iris authentication; passcode authentication)). In some embodiments, the released account information is transferred or transmitted to perform a transfer (e.g., a transfer of assets). In some embodiments, a first selectable user interface object for initiating a process to enable a virtual account feature for the first asset account is not concurrently displayed with the portions of the first and second visual representations of the first and second asset accounts.

In some embodiments, while concurrently displaying the portion of the first visual representation and the portion of the second visual representation, the computer system receives (804), via the one or more input devices, selection (e.g., 605a and/or 705a) of (e.g., via a tap input on and/or via a press-and-hold on) the first visual representation corresponding to the first asset account.

In some embodiments, in response to receiving selection of the first visual representation corresponding to the first asset account, in accordance with a determination that a set of virtual account criteria is met, wherein a first virtual account criterion of the set of virtual account criteria is met when a virtual account feature is not enabled for the first asset account, the computer system displays (806), via the display generation component, a first selectable user interface object (e.g., 624a and/or 724a) for initiating a process to enable the virtual account feature for the first asset account (e.g., without initiating a process to enable the virtual account numbers feature for the second asset account (e.g., the first user interface object is for enabling the feature for only the selected asset account) or with initiating a process to enable the virtual account numbers feature for the second asset account (e.g., the first user interface object is for enabling the feature for multiple (or all) asset accounts provisioned onto the electronic wallet)). In some embodiments, when the virtual account feature is not enabled for the first asset account, the computer system automatically uses (e.g., transmits via short-range communication radio, such as NFC, auto-populates fields, and/or transmits via a wired or wireless communication channel, such as during a transaction conducted over the Internet) the same credential information (e.g., the same account number, the same expiration date, the same account holder name, and/or the same security code) for consecutive (e.g., for two consecutive, for three consecutive, and/or for all transactions) transactions performed using the first asset account. In some embodiments, when the virtual account feature is enabled for the first asset account, the computer system automatically uses (e.g., transmits via short-range communication radio, such as NFC, auto-populates fields, and/or transmits via a wired or wireless communication channel, such as during a transaction conducted over the Internet) different credential information (e.g., different account numbers that correspond to the same account, different expiration dates, different account holder names (e.g., John Doe vs. John H. Doc), and/or different security codes) for consecutive (e.g., for two consecutive, for three consecutive, and/or for all transactions) transactions performed using the first asset account. Automatically displaying the first selectable user interface object for initiating a process to enable the virtual account feature for the first asset account based on the set of virtual account criteria provides the user with visual feedback about whether the set of virtual account criteria has been met, thereby providing the user with improved feedback about the state of the computer system.

In some embodiments, the set of virtual account criteria includes a second virtual account criterion that is met when the first asset account is compatible for use with the virtual account feature. In some embodiments, some asset accounts that are provisioned onto the electronic wallet of the computer system are compatible for use with the virtual account feature and some accounts that are provisioned onto the electronic wallet of the computer system are not compatible for use with the virtual account feature.

In some embodiments, in response to receiving selection of the first visual representation corresponding to the first asset account, in accordance with a determination that the set of virtual account criteria is not met (e.g., the virtual account feature is enabled for the first asset account and/or other criteria of the set of virtual account criteria are not met), the computer system forgoes (808) display of the first selectable user interface object (e.g., forgoes display of 624a and/or 724a) for initiating a process to enable the virtual account feature for the first asset account.

In some embodiments, while displaying, via the display generation component, the first selectable user interface object displayed in response to receiving selection of the first visual representation, the computer system receives (810), via the one or more input devices, selection (e.g., 605b and/or 705b) of the first selectable user interface object.

In some embodiments, in response to receiving selection of the first selectable user interface object, the computer system initiates (812) a process to enable the virtual account feature for the first asset account (e.g., without initiating a process to enable the virtual account numbers feature for the second asset account (e.g., the first user interface object is for enabling the feature for only the selected asset account) or with initiating a process to enable the virtual account numbers feature for the second asset account (e.g., the first user interface object is for enabling the feature for multiple (or all) asset accounts provisioned onto the electronic wallet)). Automatically displaying the first selectable user interface object for initiating a process to enable the virtual account feature for the first asset account based on the set of virtual account criteria provides the user with visual feedback about whether the set of virtual account criteria has been met, thereby providing the user with improved feedback about the state of the computer system.

In some embodiments, the computer system, in response to receiving selection of the first visual representation corresponding to the first asset account and in accordance with a determination that the virtual account feature is enabled for the first asset account, displays, via the display generation component, an indication (e.g., 726) that the virtual account feature is enabled for the first asset account. In some embodiments, in response to receiving selection of the first visual representation corresponding to the first asset account and in accordance with the determination that the virtual account feature is enabled for the first asset account, the computer system displays a selectable user interface object (e.g., “Learn More” of 726) that, when activated provides additional information about the virtual account feature (e.g., indicates what the feature is, how the feature works, and/or how to enable and/or disable the feature). Displaying an indication that the virtual account feature is enabled for the first asset account provides the user with visual feedback that the feature is already enabled, thereby providing the user with improved visual feedback about the state of the computer system.

In some embodiments, the computer system, while the virtual account feature is enabled for the first asset account, receives (e.g., via one or more wireless communication radios, via NFC, via a communication network, and/or via a touch-sensitive surface of the computer system) a first request (e.g., an NFC request and/or a user request) to provide credentials of the first asset account for (e.g., to populate a form and/or fields with credential information) a first asset transfer (e.g., transfer of memory allocation, a transfer of printing allocation, transfer of transit credits, transfer of funds, or a transfer of loyalty account information). In some embodiments, the computer system, in response to receiving the first request to provide credentials of the first asset account for the first asset transfer, provides (e.g., populating a form and/or fields with credential information), using the first asset account, first credentials without providing second credentials that are different from the first credentials. In some embodiments, the computer system, subsequent to providing the first credentials, receiving a second request to provide credentials of the first asset account for a second asset transfer that is different from the first asset transfer. In some embodiments, the computer system, in response to receiving the second request to provide credentials of the first asset account for the second asset transfer, providing (e.g., populating a form and/or fields with credential information), using the first asset account, the second credentials without providing the first credentials. In some embodiments, the computer system provides an account number, an expiration date, an account holder name, and/or a security code for use in asset transfer. In some embodiments, the account number stays the same in successive transactions and the security code changes in successive transactions. In some embodiments, the account number changes in successive transactions and/or the security code changes in successive transactions. Providing different credentials for the same asset account when the virtual account feature is enabled provides increased security by reducing the ability for other parties to access and use valid credentials.

In some embodiments, the computer system, during the process to enable the virtual account feature for the first asset account, receives, via the one or more input devices, one or more user inputs (e.g., 605c, 705c, 705d, and/or authentication information captured during biometric authentication during display of 740) to enable the virtual account feature for the first asset account. In some embodiments, the computer system, in response to receiving the one or more user inputs to enable the virtual account feature for the first asset account, enables the virtual account feature for the first asset account. Enabling the virtual account feature based on user input provides increased security by reducing the ability for other parties to access and use valid credentials.

In some embodiments, the computer system, during the process to enable the virtual account feature for the first asset account, requests authentication. In some embodiments, the computer system receives, via the one or more input devices, authentication information (e.g., biometric authentication information captured during display of 740) (e.g., a passcode, facial authentication information, iris authentication information, and/or fingerprint authentication information, with or without a physical button press after providing the information). In some embodiments, the one or more user inputs to enable the virtual account feature for the first asset account includes the authentication information. In some embodiments, the process to enable the virtual account feature for the first asset account proceeds only if the authentication information matches an enrolled user of the computer system. Requiring user authentication via authentication information to enable the virtual account feature increases the security of the computer system by only enabling the feature with authorization from an authenticated user.

In some embodiments, the computer system, in response to receiving the one or more user inputs to enable the virtual account feature for the first asset account, provides information to an autofill application (e.g., an autofill application of FIG. 13A) (e.g., an autofill application (e.g., a web browser application (of the computer system or of an external device)) that autofills forms and/or another application (of the computer system or of an external device)) to enable the autofill application to use a first autofill option to autofill using the virtual account feature of the first asset account. In some embodiments, the autofill application, once enabled to use the virtual account feature of the first asset account, can autofill credential information for the first asset account that is different for each successive autofill (e.g., a first autofill request results in first credentials based on the first asset account being autofilled and a second autofill request results in second credentials, different from the first credentials, based on the first asset account being autofilled). Enabling an autofill application to automatically autofill credential information for the first asset account based on the virtual account feature being enabled reduces the need for the user to provide additional inputs to enable the autofill application, thereby reducing the number of inputs required.

In some embodiments, the computer system, in response to receiving the one or more user inputs to enable the virtual account feature for the first asset account, removes, from the autofill application (e.g., a web browser application (of the computer system or of an external device) that autofills forms and/or another application (of the computer system or of an external device)), a second autofill option to autofill using the first asset account without the virtual account feature. In some embodiments, before the virtual account feature is enabled for the first asset account, the autofill application present an option for the user to autofill using the first asset account without the virtual account feature (e.g., the same credentials autofill for successive autofill operations (e.g., multiple times or each time)). In some embodiments, once the virtual account feature for the first asset account is enabled, the autofill application replaces the option for the user to autofill using the first asset account without the virtual account feature with an option for the user to autofill using the virtual account feature of the first asset account (e.g., different credentials autofill for successive autofill operations). Removing duplicate autofill options from the autofill application enables the user to more easily access the various options without needing to scroll through duplicate options, thereby reducing the number of inputs needed to access a desired option.

In some embodiments, the computer system, subsequent to (e.g., in response to and/or at some point after) enabling the virtual account feature for the first asset account, displays, via the display generation component, an option (e.g., 766) to initiate a process to enable the virtual account feature for one or more asset accounts that are different from the first asset account. In some embodiments, the computer system, receives, via the one or more input devices, selection (e.g., 705g) of the option to initiate the process to enable the virtual account feature for one or more asset accounts that are different from the first asset account. In some embodiments, the computer system, in response to receiving selection of the option to initiate the process to enable the virtual account feature for one or more asset accounts that are different from the first asset account, initiates the process to enable the virtual account feature for one or more asset accounts that are different from the first asset account. In some embodiments, the computer system progresses through a process that sequentially enables the virtual account feature for several asset accounts. In some embodiments, the option to enable the virtual account feature for one or more asset accounts that are different from the first asset account is displayed concurrently with an indication that the virtual account feature has been enabled for the first asset account. Displaying an option for the user to enable the virtual account feature for additional asset accounts enables the user to more quickly initiate that process without having to provide more user inputs and provides the user with visual feedback that other accounts are available to have the virtual account feature enabled, thereby providing improved visual feedback.

In some embodiments, the computer system, subsequent to (e.g., in response to and/or at some point after) enabling the virtual account feature for the first asset account, displays, via the display generation component, an option (e.g., 784a, 798) to display account information of the first asset account (e.g., without initiating a process to enable the virtual account feature for one or more asset accounts that are different from the first asset account). In some embodiments, the computer system receives, via the one or more input devices, selection (e.g., 705i, 705k) of the option to display account information of the first asset account. In some embodiments, the computer system, in response to receiving the option to display account information of the first asset account, displays (e.g., without initiating a process to enable the virtual account feature for one or more asset accounts that are different from the first asset account), via the display generation component, a user interface (e.g., 720) for the first asset account, including the first visual representation corresponding to the first asset account (e.g., the user interface for the first asset account does not include the second visual representation corresponding to the second asset account). In some embodiments, the computer system displays, concurrently with the first visual representation corresponding to the first asset account: one or more transfers performed using the first asset account and an indication that the virtual account feature has been enabled for the first asset account. Displaying account information for the first asset account provides the user with additional feedback about the asset account and the state of the computer system, thereby providing the user with improved visual feedback.

In some embodiments, the computer system, while the virtual account feature is enabled for the first asset account, receives, via the one or more input devices, a set of one or more user inputs (e.g., 705i, authentication interface captured during biometric authentication while 788 is displayed) to display a virtual account number based on the virtual account feature being enabled for the first asset account. In some embodiments, the set of one or more user inputs includes user authentication (e.g., biometric authentication (e.g., fingerprint authentication; facial authentication; iris authentication; passcode authentication)). Displaying the virtual account number in response to receiving the set of one or more user inputs provides the user with visual feedback about the virtual account number, thereby providing the user with improved visual feedback.

In some embodiments, the computer system, in response to receiving selection of the first visual representation (e.g., 612a and/or 712a) corresponding to the first asset account, concurrently displays, via the display generation component, the first visual representation corresponding to the first asset account and information (e.g., 622 and/or 722) about one or more transfers performed using the first asset account. In some embodiments, the computer system does not display, in response to receiving selection of the first visual representation corresponding to the first asset account, visual representations corresponding to asset accounts different from the first asset account. Displaying information about one or more transfers performed using the first asset account provides the user with improved visual feedback about the state of the first asset account and how it has been used in the past, which also enables the user to confirm that the account is not being misused, thereby providing the user with increased security.

Note that details of the processes described above with respect to method 800 (e.g., FIG. 8) are also applicable in an analogous manner to the methods described below. For example, method 1400 optionally includes one or more of the characteristics of the various methods described above with reference to method 800. For example, after enabling a virtual account feature for a transfer account, as described with respect to method 800, a virtual card number for the transfer account is, optionally, used to populate one or more fields during a transaction, as described with respect to method 1400. For brevity, these details are not repeated below.

FIGS. 9A-9C illustrate exemplary user interfaces for provisioning a storage account, in accordance with some embodiments. The user interfaces in these figures are used to illustrate the processes described below, including the processes in FIG. 11. In some embodiments, device 900 includes one or more features of devices 100, 300, and/or 500.

In FIG. 9A, electronic device 900 is displaying, on display 902 (e.g., touch screen 702), a user interface 910 of a transfer application (e.g., an electronic wallet application). In some embodiments, user interface 910 includes representations 912 (or portions thereof) corresponding to different accounts (e.g., transfer accounts) provisioned on electronic device 600. As shown, representations 912 include, for instance, representation 912a corresponding to a computer storage management account. In some embodiments, representation 912a corresponds to a first-party manufacturer-issued (or branded) computer storage management account.

In some embodiments, device 900 determines whether one or more computer storage management account are available to be provisioned. In some embodiments, computer storage management account available to be provisioned include computer storage management account that are enabled for an application autofill operation (e.g., an autofill operation of account information) on device 900, but not provisioned on device 900 (e.g., not provisioned into an electronic wallet application of device 900 and/or not stored in a secure element of device 900). In some embodiments, an application autofill operation is performed using a web browsing application of device 900, for instance, during a transfer made using the web browsing application.

At FIG. 9A, if device 900 determines a computer storage management account is available to be provisioned on device 900, device 900 displays, in user interface 910, provision affordance 916, which indicates a computer storage management account (or multiple computer storage management accounts) is available to be provisioned on device 900. In response to selection of provision affordance 916, device 900 displays confirmation interface 930, as shown in FIG. 9B. While displaying confirmation interface 930, device 1000 detects selection of provision affordance 932. In some embodiments, the selection is a tap gesture 905c on provision affordance 932. In response to selection of provision affordance 932, device 900 initiates a process for provisioning a computer storage management account on device 900 (e.g., onto a wallet application of device 900).

As shown in FIG. 9C, once the computer storage management account has been provisioned on device 900, a representation (e.g., representation 912c) corresponding to the provisioned transfer account is included in user interface 910.

FIGS. 10A-10H illustrate exemplary user interfaces for provisioning an account, in accordance with some embodiments. The user interfaces in these figures are used to illustrate the processes described below, including the processes in FIG. 11. In some embodiments, device 1000 includes one or more features of devices 100, 300, and/or 500.

In some embodiments, virtual account numbers described herein are associated with a user account (or multiple user accounts). In some embodiments, the user account is a transfer account. In some embodiments, the transfer account is a first-party transfer account (e.g., a transfer account that is issued or branded by, for example, the manufacturer of the electronic device), and, optionally, provides rewards (e.g., cash back rewards, bonus points rewards) based on the amount of transfers (e.g., payment transactions and/or points transfers) made using the transfer account (e.g., cash back rewards that are based on a certain percentage of the value of each transaction) and/or made using a different account. In some embodiments, the transfer account is a points account (e.g., for meal points, for printer credits, and/or for membership points) that provides rewards (e.g., points rewards) based on the amount of points used using the transfer account.

Generally, FIGS. 10A-10H, described below, demonstrate examples of initiating and/or performing a process to provision a transfer account onto device 1000, and more specifically, into an electronic wallet application of device 1000. In some embodiments, device 1000 is a portable multifunction device and has one or more components described above in relation to one or more of devices 100, 300, and 500.

In FIG. 10A, electronic device 1000 is displaying, on display 1002 (e.g., touch screen 1002), a user interface 1010 of a transfer application (e.g., an electronic wallet application). In some embodiments, user interface 1010 includes representations 1012 corresponding to different transfer accounts (e.g., payment accounts, such as a third-party credit card account, a debit card account, and/or a stored-value account; points accounts; and/or rewards accounts) provisioned on the electronic device. As shown, representations 1012 include, for instance, a representation 1012a corresponding to a first transfer account and a representation 1012b corresponding to a second transfer account. In some embodiments, representation 1012a corresponds to a first-party transfer account. In some embodiments, user interface 1010 includes representations 1014 (e.g., representations 1014a-1014d) corresponding to other various accounts (e.g., transfer accounts, points cards, and/or rewards cards), ID cards (e.g., student ID and/or government-issued ID), and/or tickets (e.g., event ticket and/or boarding pass ticket) provisioned on or otherwise linked to the electronic device 1000.

In some embodiments, device 1000 determines whether one or more transfer accounts are available to be provisioned. In some embodiments, transfer accounts available to be provisioned include transfer accounts that are enabled for an application autofill operation (e.g., an autofill operation of account information and/or payment information) on device 1000, but not provisioned on device 1000 (e.g., not provisioned into an electronic wallet application of device 1000 and/or not stored in a secure element of device 1000). In some embodiments, an application autofill operation is performed using a web browsing application of device 1000, for instance, during a transaction made using the web browsing application.

At FIG. 10A, if device 1000 determines one or more transfer accounts is available to be provisioned on device 1000, device 1000 displays, in user interface 1010, provision affordance 1016, which indicates that one or more transfer accounts is available to be provisioned on device 1000. In response to selection of provision affordance 1016, device 1000 initiates a process for provisioning a transfer account on device 1000 (e.g., onto a wallet application of device 1000), as shown in FIG. 10C.

In some embodiments, device 1000 prompts a user to provision a transfer account on device 1000. By way of example, with reference to FIG. 10B, device 1000 displays, on home interface 1020, prompt 1022, which indicates that one or more transfer accounts are available to be provisioned. In response to selection of prompt 1022, device 1000 initiates a process for provisioning a transfer account. In some embodiments, prompt 1022 is displayed in response to device 1000 performing a transaction, for instance, corresponding to a transfer account that is available to be provisioned on device 1000 or a transfer account that is already provisioned on device 1000.

In FIG. 10C, device 1000 displays confirmation interface 1030. FIG. 10C is displayed, for example, in response to selection of notification 1016 (FIG. 10A) and/or prompt 1022 (FIG. 10B). While displaying confirmation interface 1030, device 1000 detects selection of continue affordance 1032. In some embodiments, the selection is a tap gesture 1005c on continue affordance 1032.

As shown in FIG. 10D, in response to detecting selection of continue affordance 1032, device 1000 displays account selection interface 1040. Account selection interface 1040 includes candidate accounts 1042, each of which corresponds to a transfer account that is available to be provisioned on device 1000. While account selection interface 1040 is displayed, a user may select any number of candidate accounts 1042 (e.g., candidate account 1042a and/or candidate account 1042b) to be provisioned on device 1000. In the example illustrated in FIG. 10D, a user has selected candidate account 1042b to be provisioned on device 1000.

While displaying account selection interface 1040, device 1000 detects selection of continue affordance 1044. In some embodiments, the selection is a tap gesture 1005d on continue affordance 1044. As shown in FIG. 10E, in response to detecting selection of continue affordance 1044, device 1000 displays account interface 1050.

At FIG. 10E, account interface 1050 includes various information regarding the transfer account (e.g., transfer account corresponding to selected candidate account 1042b). As an example, transfer account includes account identifier 1054, which may be an image of a physical card associated with the transfer account in some embodiments. Account interface further includes credential fields 1052. Credential fields 1052a and 1052b are, in some embodiments, fields for a first credential (e.g., an account number) and a second credential (e.g., security code) of the transfer account, respectively. In some embodiments, device 1000 automatically populates (e.g., fills) each of credential fields 1052a and 1052b with the first and second credential, respectively, during display of account interface 1050. In some embodiments, device 100 automatically populates the credential fields using information from the autofill application. In some embodiments, device 1000 populates only credential field 1052a, and credential field 1052b is populated by a user, for instance, to confirm user access to the account.

Once credential fields 1052 have been populated, device 1000 detects selection of continue affordance 1056. In some embodiments, the selection is a tap gesture 1005e on continue affordance 1056. As shown in FIG. 10F, in response to detecting selection of continue affordance 1056, device 1000 displays provisioning interface 1060.

At FIG. 10F, provisioning interface 1060 includes status 1062 indicating that the selected transfer account is being provisioned on device 1000. Optionally, status 1062 includes an animation 1062a which serves as a dynamic indicator that the transfer account is being provisioned.

As shown in FIG. 10G, once the transfer account has been provisioned, device 1000 displays (e.g., replaces display of provisioning interface 1060 with) completion interface 1070. In some embodiments, completion interface 1070 includes status 1074 indicating that the transfer account has been provisioned. Optionally, status 1074 includes indicator 1074a (e.g., a checkmark), providing a non-textual indication that the transfer account has been provisioned.

As shown in FIG. 10H, once the transfer account has been provisioned, a representation (e.g., representation 1012c) corresponding to the provisioned transfer account is included in user interface 1010. Accordingly, device 1000 enables a quick and efficient process by which transfer accounts that are available for an autofill operation using an autofill application can be provisioned onto device 1000.

FIG. 11 is a flow diagram illustrating a method for provisioning an account using a computer system in accordance with some embodiments. Method 1100 is performed at a computer system (e.g., 100, 300, 500, and/or 1000) (e.g., a smart watch, a smart phone, a head mounted device (e.g., a head mounted augmented reality and/or extended reality device), a self-motive device and/or system, and/or a personal computer) that is in communication with a display generation component (e.g., an integrated display, a head mounted display system, and/or a display controller) and one or more input devices (e.g., a touch-sensitive surface (e.g., a touchscreen), a mouse, and/or a keyboard). Some operations in method 1100 are, optionally, combined, the orders of some operations are, optionally, changed, and some operations are, optionally, omitted.

As described below, method 1100 provides an intuitive way for provisioning an account. The method reduces the cognitive burden on a user for provisioning an account, thereby creating a more efficient human-machine interface. For battery-operated computing devices, enabling a user to provision an account faster and more efficiently conserves power and increases the time between battery charges.

In some embodiments, the computer system displays (1102), via the display generation component, a provisioning user interface (e.g., 910 and/or 1010). In some embodiments, the provisioning interface includes an indication (e.g., 916 and/or 1016) that one or more accounts are enabled for (e.g., have account information stored locally or remotely for use in) performing an application (e.g., web browser application or non-web browser application) autofill operation (e.g., account information autofill and/or payment information autofill) at the computer system (e.g., a feature that automatically populates applications forms, such as website forms or non-website forms, with account information (e.g., login/password, payment account information, email information, and/or physical address information) and/or a feature that populates information corresponding to an account into a form or field (e.g., of a website or of an application) displayed by the application based on (e.g., in response to) a user selection of the account) and are not provisioned onto an electronic wallet of the computer system (e.g., a wallet that enables NFC payments using the computer system and/or that stores account credentials in a secure element of the computer system). In some embodiments, credentials of the one or more accounts that are enabled for performing an application autofill operation are not stored in a secure element of the computer system while credentials of accounts provisioned onto an electronic wallet of the computer system are stored in the secure element of the computer system. In some embodiments, a transaction terminal (e.g., a contactless payment terminal) communicates directly with the secure element through an (NFC) controller of the computer system over a dedicated hardware bus of the computer system. In some embodiments, the provisioning interface includes a first selectable user interface object (e.g., 916, 1016, 1022) for initiating a process to provision the one or more accounts onto the electronic wallet of the computer system. In some embodiments, the first selectable user interface object includes the indication.

In some embodiments, the computer system receives (1104), via the one or more input devices, selection (e.g., tap input on or other selection of any of 916, 1016, and/or 1022) of the first selectable user interface object.

In some embodiments, in response to receiving selection of the first selectable user interface object, the computer system initiates (1106) a process to provision a first account of (and, optionally, a second account of and/or all the accounts of) the one or more accounts onto the electronic wallet of the computer system (e.g., as illustrated in FIGS. 9B, 10C, and/or 10D). In some embodiments, the process to provision the first account of the one or more accounts onto the electronic wallet of the computer system uses at least some account information (e.g., information that the application autofill operation populates into an application (e.g., web browser or non-web browser) form, login/password, email information, physical address information, and/or payment account information such as an account number, an account expiration date, an account holder name, and/or a security code) about the first account, wherein the account information is stored for use in the application autofill operation.

In some embodiments, subsequent to receiving selection of the first selectable user interface object, the computer system provisions (1108) the first account onto the electronic wallet of the computer system using at least some account information (e.g., information that the application autofill operation populates into the application form, login/password, email information, physical address information, and/or payment account information such as an account number, an account expiration date, an account holder name, and/or a security code) about the first account, wherein the account information is stored for use in the application autofill operation. In some embodiments, provisioning the first account onto the electronic wallet of the computer system includes storing credential information about the first account in a secure element of the computer system. In some embodiments, provisioning the first account onto the electronic wallet of the computer system includes enabling the computer system to use the first account for NFC and/or other near-field transactions (e.g., transfers and/or payments). Displaying an indication that one or more accounts are enabled for performing an application autofill operation at the computer system and are not provisioned onto an electronic wallet of the computer system provides the user with visual feedback about the state of accounts on the computer system, thereby providing improved visual feedback.

In some embodiments, the computer system performs, via one or more short-range communication radios (e.g., NFC radio(s) and/or short-range communication radio(s)), a transfer using a first account that is provisioned onto the electronic wallet of the computer system. In some embodiments, the computer system, in response to performing the transfer using the first account, in accordance with a determination that one or more accounts are enabled for (e.g., have account information stored locally or remotely for use in) performing an application (e.g., web browser application or non-web browser application) autofill operation (e.g., account information autofill and/or payment information autofill) at the computer system (e.g., a feature that automatically populates applications forms, such as website forms or non-website forms, with account information (e.g., login/password, payment account information, email information, and/or physical address information) and/or a feature that populates information corresponding to an account into a form or field (e.g., of a website or of an application) displayed by the application based on (e.g., in response to) a user selection of the account) and are not provisioned onto the electronic wallet of the computer system, displays, via the display generation component, a notification (e.g., 916, 1016, and/or 1022) (e.g., that is overlaid on another user interface of the computer system) that indicates that one or more accounts are enabled for performing an application autofill operation at the computer system and are not provisioned onto the electronic wallet of the computer system. In some embodiments, the computer system, in response to performing the transfer using the first account, in accordance with a determination that there are no accounts that are enabled for performing an application autofill operation at the computer system and are not provisioned onto the electronic wallet of the computer system (e.g., all accounts enabled for performing the autofill operation are also provisioned onto the electronic wallet or there are no accounts enabled for performing the autofill operation), forgoes display of the notification (e.g., forgoes display of any of 916, 1016, and/or 1022) that indicates that one or more accounts are enabled for performing an application autofill operation at the computer system and are not provisioned onto the electronic wallet of the computer system. In some embodiments, in response to receiving selection of the notification that indicates that one or more accounts are enabled for performing an application autofill operation at the computer system and are not provisioned onto the electronic wallet of the computer system, the computer system initiates a process to provision at least some of the one or more accounts onto the electronic wallet of the computer system. Displaying a notification that indicates that one or more accounts are enabled for performing an application autofill operation at the computer system and are not provisioned onto the electronic wallet of the computer system provides the user with visual feedback about the state of accounts on the computer system, thereby providing improved visual feedback.

In some embodiments, the computer system receives, via the one or more input devices, user input (e.g., 1222a, 1222b, 1322a, and/or 1322b) (e.g., account information for a second account) to enable performing an application (e.g., web browser application or non-web browser application) autofill operation using a second account that is different than the first account. In some embodiments, the computer system, in response to receiving the user input to enable performing the application autofill operation using the second account (and, optionally, in accordance with a determination that the second account is not provisioned onto the electronic wallet of the computer system), displays, via the display generation component, a notification (e.g., 916, 1016, and/or 1022) (e.g., that is overlaid on another user interface of the computer system) that indicates that one or more accounts are enabled for performing an application autofill operation at the computer system and are not provisioned onto the electronic wallet of the computer system. In some embodiments, when the computer system receives user instructions to add a new account to an application for performing an autofill operation (e.g., without provisioning the account and/or enabling the account to use the virtual account feature), the computer system prompts the user with a notification indicating that the accounts can be provisioned onto the computer system. In some embodiments, in response to receiving selection of the notification that indicates that one or more accounts are enabled for performing an application autofill operation at the computer system and are not provisioned onto the electronic wallet of the computer system, the computer system initiates a process to provision at least some of the one or more accounts onto the electronic wallet of the computer system. Displaying a notification that indicates that one or more accounts are enabled for performing an application autofill operation at the computer system and are not provisioned onto the electronic wallet of the computer system provides the user with visual feedback about the state of accounts on the computer system, thereby providing improved visual feedback.

In some embodiments, the computer system, while the first account is provisioned onto the electronic wallet of the computer system, while displaying, via the display generation component, a first user interface of a first application, receives, via the one or more input devices, selection of an option to perform a transfer using an account that is provisioned onto the computer system. In some embodiments, the computer system, in response to receiving selection of the option to perform a transfer using an account that is provisioned onto the computer system, displays, via the display generation component, a second user interface of a second application (e.g., a wallet application corresponding to the electronic wallet and/or an application of the operating system) that identifies the first account for performing the transfer. In some embodiments, the computer system, receives, via the one or more input devices, one or more user inputs that include: authorization to use the first account that is provisioned onto the electronic wallet of the computer system for the transfer, and user authentication (e.g., biometric authentication (e.g., fingerprint authentication; facial authentication; iris authentication; passcode authentication)). In some embodiments, the computer system, in response to receiving the one or more user inputs, transfers credential information (e.g., account information and/or payment information) of the first account from the second application to the first application, wherein the credential information is released, based on the received authorization and user authentication, from a secure element of the computer system. In some embodiments, the authorization indicates that the user wishes to proceed with the transfer and the user authentication confirms that the user is an authorized user of the computer system. Performing a transfer using the first account between a first application and a second application based on user authentication enables the computer system to securely perform the operation, thereby providing improved security.

In some embodiments, the computer system, in response to receiving selection of the first selectable user interface object, displays, via the display generation component, an option (e.g., selection of a “No Thanks” option in FIG. 10C) to cease the process to provision the first account of (and, optionally, a second account of and/or all the accounts of) the one or more accounts onto the electronic wallet of the computer system. In some embodiments, the computer system receives, via the one or more input devices, selection of the option to cease the process to provision the first account. In some embodiments, the computer system, in response to receiving selection of the option to cease the process to provision the first account, ceases the process to provision the first account onto the electronic wallet of the computer system. Providing the user with an option to cease the process provision the first account onto the electronic wallet of the computer system provides the user with visual feedback that the process to provision the first account onto the electronic wallet has been initiated, thereby providing the user with improved visual feedback.

In some embodiments, the indication (e.g., 916, 1016, and/or 1022) that one or more accounts are enabled for performing an application autofill operation at the computer system and are not provisioned onto the electronic wallet of the computer system is displayed based on the one or more accounts being compatible for provisioning onto the electronic wallet of the computer system. In some embodiments, the indication does not include accounts that are enabled to perform the application autofill operation and are not provisioned onto the electronic wallet when those accounts are not compatible for provisioning onto the electronic wallet of the computer system. Displaying the indication based on the one or more accounts being compatible for provisioning onto the electronic wallet of the computer system provides the user with visual feedback that the one or more accounts are compatible for provisioning, thereby providing improved visual feedback.

In some embodiments, the computer system, prior to provisioning the first account onto the electronic wallet of the computer system, receives, via the one or more input devices, a request (e.g., 1222a, 1222b, 1322a, and/or 1322b) to perform an autofill operation using the first account (e.g., automatically filling in account information into a field and/or automatically filling in account information into a payment form). In some embodiments, the computer system, in response to receiving the request to perform an autofill operation using the first account, performs the autofill operation without using a virtual account feature for the first account. In some embodiments, when the virtual account feature is not enabled for the first account, the computer system automatically uses (e.g., transmits via short-range communication radio, such as NFC, auto-populates fields, and/or transmits via a wired or wireless communication channel, such as during a transaction conducted over the Internet, and/or an autofill operation) the same credential information (e.g., the same account number, the same expiration date, the same account holder name, and/or the same security code) for consecutive (e.g., for two consecutive, for three consecutive, and/or for all transactions) transactions performed using the first account. In some embodiments, when the virtual account feature is enabled for the first account, the computer system automatically uses (e.g., transmits via short-range communication radio, such as NFC, auto-populates fields, auto-populates fields, and/or transmits via a wired or wireless communication channel, such as during a transaction conducted over the Internet, and/or an autofill operation) different credential information (e.g., different account numbers that correspond to the same account, different expiration dates, different account holder names (e.g., John Doe vs. John H. Doc), and/or different security codes) for consecutive (e.g., for two consecutive, for three consecutive, and/or for all transactions) transactions performed using the first account. Performing the autofill operation without using the virtual account feature for the first account enables the computer system to re-use the same credential information for consecutive transactions makes it easier for the user to verify that the correct credentials are being used, thereby providing the used with improved visual feedback.

In some embodiments, provisioning the first account onto the electronic wallet of the computer system includes enabling a virtual account feature for the first account. In some embodiments, when the virtual account feature is not enabled for the first account, the computer system automatically uses (e.g., transmits via short-range communication radio, such as NFC, auto-populates fields, and/or transmits via a wired or wireless communication channel, such as during a transaction conducted over the Internet, and/or an autofill operation) the same credential information (e.g., the same account number, the same expiration date, the same account holder name, and/or the same security code) for consecutive (e.g., for two consecutive, for three consecutive, and/or for all transactions) transactions performed using the first account. In some embodiments, when the virtual account feature is enabled for the first account, the computer system automatically uses (e.g., transmits via short-range communication radio, such as NFC, auto-populates fields, auto-populates fields, and/or transmits via a wired or wireless communication channel, such as during a transaction conducted over the Internet, and/or an autofill operation) different credential information (e.g., different account numbers that correspond to the same account, different expiration dates, different account holder names (e.g., John Doe vs. John H. Doc), and/or different security codes) for consecutive (e.g., for two consecutive, for three consecutive, and/or for all transactions) transactions performed using the first account. Performing the autofill operation using the virtual account feature for the first account enables the computer system to use different credential information for consecutive transactions, thereby providing the user with improved security.

In some embodiments, the computer system, subsequent to provisioning the first account onto the electronic wallet of the computer system, receives, via the one or more input devices, a second request (e.g., 1222a, 1222b, 1322a, and/or 1322b) to perform an autofill operation using the first account (e.g., automatically filling in account information into a field and/or automatically filling in account information into a payment form). In some embodiments, the computer system, in response to receiving the second request to perform an autofill operation using the first account, performs the autofill operation using the virtual account feature for the first account. Performing the autofill operation using the virtual account feature for the first account enables the computer system to use different credential information for consecutive transactions, thereby providing the user with improved security.

In some embodiments, the process to provision the first account of (and, optionally, a second account of and/or all the accounts of) the one or more accounts onto the electronic wallet of the computer system includes displaying, via the display generation component, a request for second account information (e.g., a card security code and/or billing address information) about the first account. In some embodiments, the process to provision the first account of (and, optionally, a second account of and/or all the accounts of) the one or more accounts onto the electronic wallet of the computer system includes receiving, via the one or more input devices, the second information (e.g., from the user); and uses the second account information to provision the first account of (and, optionally, a second account of and/or all the accounts of) the one or more accounts onto the electronic wallet of the computer system. Using the second account information to provision the first account improves the security of the first account and the computer system by confirming that the user has access to the second account information before the first account is provisioned (thereby confirming that the user has access to the first account).

In some embodiments, the computer system, in response to detecting a transfer using a second account that is provisioned onto the electronic wallet of the computer system enables a virtual account feature for the second account that is provisioned onto the electronic wallet of the computer system. In some embodiments, the computer system, in response to detecting a transfer using a second account that is provisioned onto the electronic wallet of the computer system configures the autofill application to use the virtual account feature for the second account (e.g., when the browser autofill operation is performed, the autofill operation uses different account information for consecutive autofill operations). In some embodiments, the computer system, in response to detecting a transfer using a second account that is provisioned onto the electronic wallet of the computer system displays, via the display generation component, an indication that the virtual account feature has been enabled for the second account and is available for use in the autofill application. In some embodiments, when the virtual account feature is not enabled for a respective account, the computer system automatically uses (e.g., transmits via short-range communication radio, such as NFC, auto-populates fields, and/or transmits via a wired or wireless communication channel, such as during a transaction conducted over the Internet, and/or an autofill operation) the same credential information (e.g., the same account number, the same expiration date, the same account holder name, and/or the same security code) for consecutive (e.g., for two consecutive, for three consecutive, and/or for all transactions) transactions performed using the respective account. In some embodiments, when the virtual account feature is enabled for the respective account, the computer system automatically uses (e.g., transmits via short-range communication radio, such as NFC, auto-populates fields, auto-populates fields, and/or transmits via a wired or wireless communication channel, such as during a transaction conducted over the Internet, and/or an autofill operation) different credential information (e.g., different account numbers that correspond to the same account, different expiration dates, different account holder names (e.g., John Doe vs. John H. Doc), and/or different security codes) for consecutive (e.g., for two consecutive, for three consecutive, and/or for all transactions) transactions performed using the respective account. Automatically enabling a virtual account feature for a second account that is provisioned onto the electronic wallet of the computer system and configuring the autofill application to use the virtual account feature for the second account reduces the need for the user to provide inputs to enable the virtual account feature and to configure the autofill application, thereby reducing the number of inputs required.

In some embodiments, in accordance with a determination that a respective account is not provisioned onto the electronic wallet of the computer system, the respective account is not available for performing transfers using a communication radio (e.g., an NFC radio and/or a short-range communication radio) of the computer system. In some embodiments, in accordance with a determination that the respective account is provisioned onto the electronic wallet of the computer system, the respective account is available for performing transfers using the communication radio (e.g., an NFC radio and/or a short-range communication radio) of the computer system. In some embodiments, in accordance with a determination that a respective account is not provisioned onto the electronic wallet of the computer system, credential information for the respective account is not stored in a secure element of the computer system (e.g., to be released after authentication and/or authorization for use in a transfer) and in accordance with a determination that the respective account is provisioned onto the electronic wallet of the computer system, credential information for the respective account is stored in the secure element of the computer system (e.g., to be released after authentication and/or authorization for use in a transfer). The account being available for transfers vit the communication radio when provisioned onto the electronic wallet of the computer system enables the computer system to perform transactions using an additional technique (e.g., NFC), thereby making the computer system more efficient.

Note that details of the processes described above with respect to method 1100 (e.g., FIG. 11) are also applicable in an analogous manner to the methods described above and/or below. For example, method 800 optionally includes one or more of the characteristics of the various methods described above with reference to method 1100. For example, after provisioning a transfer account, as described with respect to method 1100, a virtual account feature may be enabled for the provisioned transfer account, as described with respect to method 800. For brevity, these details are not repeated below.

FIGS. 12A-12C illustrate exemplary user interfaces for obfuscating credentials of a storage account, in accordance with some embodiments. The user interfaces in these figures are used to illustrate the processes described below, including the processes in FIG. 14. In some embodiments, device 1200 includes one or more features of devices 100, 300, and/or 500.

In FIG. 12A, electronic device 1200 is displaying, on display 1202 (e.g., touch screen 1302), user interface 1210 corresponding to a first transaction. In some embodiments, the first transaction is a transaction made using a web browsing application. Accordingly, in some embodiments, user interface 1210 is a user interface of a web browsing application (e.g., a website displayed by the web browsing application).

User interface 1210 includes credential fields 1212 corresponding to various credentials of a computer storage management account, respectively. As an example, credential field 1212a is a field for an account number (e.g., virtual account number or physical account number) for the computer storage management account. As another example, credential field 1212b is a field for a name associated with the computer storage management account. As yet another example, credential field 1212c is a field for an expiration date for the account number of the computer storage management account. As yet another example, credential field 1212d is a field for a security code for the computer storage management account.

As shown in FIG. 12A, user interface 1210 further includes keypad 1214, which may be used to manually enter an account number into credential field 1212a, in some embodiments. In FIG. 12A, device 1200 further displays autofill interface 1220. Autofill interface 1220 is overlaid on user interface 1210 in some embodiments.

Autofill interface 1220 includes account affordances 1222, each of which corresponds to a respective computer storage management accounts. In some embodiments, account affordances 1222 correspond only to computer storage management accounts provisioned on device 1200 (e.g., available in an electronic wallet application of device 1200 and/or are stored in a secure element of device 1200). In some embodiments, account affordances 1222 correspond to computer storage management accounts provisioned on device 1200 and computer storage management accounts not provisioned on device 1200, but for which an autofill operation is enabled.

While displaying autofill interface 1220, device 1200 detects selection of account affordance 1222a corresponding to a first computer storage management account (“Star Account”). In some embodiments, the selection is a tap gesture 1205b on account affordance 1222a. As shown in FIG. 12B, in response to detecting selection of account affordance 1222a, device 1200 autofills one or more credential fields 1212 using credentials corresponding to the first computer storage management account.

In some embodiments, a virtual account feature has been enabled for the first computer storage management account. In some embodiments, as a result of enabling the virtual account feature for the first computer storage management account, a virtual account number (e.g., a number ending in “8890”) and/or other virtual credentials have been provided for the first computer storage management account (e.g., “Star Account”). Accordingly, when autofilling credential fields 1212 using credentials corresponding to the first computer storage management account, device 1200 autofills the credential fields using the virtual credentials (e.g., virtual account number and/or rotating security code) of the first computer storage management account. As an example, credential field 1212a is autofilled using a virtual account number for the transfer account (e.g., number ending in “8890”), and credential field 1312d is autofilled using a rotating security code for the transfer account (e.g., number ending in “4”).

With reference to FIG. 12A, account affordance 1222a is shown as an account having an account number ending in “0234”. In some embodiments, the number shown in autofill interface 1320 corresponds to at least a portion of a physical account number for the first computer storage management account. In contrast, in FIG. 12B, the number autofilled in credential field 1212a (e.g., corresponding to the virtual account number for the computer storage management account) is a number ending in “8890”. Accordingly, in some embodiments, device 1200 displays autofill interface 1220 with references to physical account numbers, and autofills using virtual account numbers (e.g., when provided for a computer storage management account).

In some embodiments, one or more virtual credentials are obscured when used to autofill a credential field 1212. As an example, in FIG. 12B, device 1200 obscures at least a portion of the virtual account number autofilled in credential field 1212a and/or the rotating security code autofilled in credentials field 1212d. In some embodiments, the rotating security code autofilled in credentials field 1212d is completely obscured such that none of the digits are legible.

With reference once again to FIG. 12A, device 1200 detects selection of account affordance 1222b corresponding to a second computer storage management account (“Cloud Storage”). In some embodiments, the selection is a tap gesture 1207b on account affordance 1222b. As shown in FIG. 12C, in response to detecting selection of account affordance 1222b, device 1200 autofills one or more credential fields 1212 using credentials corresponding to the second computer storage management account.

In some embodiments, a virtual account feature has not been enabled for the second computer storage management account. Accordingly, when autofilling credential fields 1212 using credentials corresponding to the second computer storage management account, device 13200 autofills the credential fields using physical credentials (e.g., physical account number and/or physical security code) of the second computer storage management account, as illustrated in FIG. 12C. As an example, credential field 1212a of FIG. 12C is autofilled using a physical account number for the second computer storage management account, and credential field 1212d is autofilled using the physical security code for the second computer storage management account.

In some embodiments, physical credentials are displayed without obfuscation (e.g., not obscured) when used to autofill a credential field 1212. As an example, in FIG. 12C, device 1200 displays the physical account number autofilled in credential field 1212a (e.g., number ending in “1234”) and/or the physical security code autofilled in credentials field 1212d (e.g., “777”) without any obfuscation.

FIGS. 13A-13J illustrate exemplary user interfaces for obfuscating credentials of an account, in accordance with some embodiments. The user interfaces in these figures are used to illustrate the processes described below, including the processes in FIG. 14. In some embodiments, device 130000 includes one or more features of devices 100, 300, and/or 500.

Generally, FIGS. 13A-13J describe various examples in which transactions are performed using credentials corresponding to various transfer accounts. As will be described in more detail below, in some embodiments, credentials (e.g., virtual credentials of a transfer account for which a virtual account number has been provided, as described with respect to FIGS. 7A-7M), are selectively obscured during transactions.

FIGS. 13A-13G describe operation of device 1300 during a first transaction. In some embodiments, device 1300 is a portable multifunction device and has one or more components described above in relation to one or more of devices 100, 300, and 500.

In FIG. 13A, electronic device 1300 is displaying, on display 1302 (e.g., touch screen 1302), user interface 1310 corresponding to a first transaction. In some embodiments, the first transaction is a transaction made using a web browsing application. Accordingly, in some embodiments, user interface 1310 is a user interface of a web browsing application (e.g., a website displayed by the web browsing application).

User interface 1310 includes credential fields 1312 corresponding to various credentials of a transfer account, respectively. As an example, credential field 1312a is a field for an account number (e.g., virtual account number or physical account number). As another example, credential field 1312b is a field for a name associated with the transfer account. As yet another example, credential field 1312c is a field for an expiration date for the account number of the transfer account. As yet another example, credential field 1312d is a field for a security code for the transfer account.

While displaying user interface 1310, device 1300 detects selection of credential field 1312a. In some embodiments, the selection is a tap gesture 1305a on credential field 1312a and corresponds to a request for device 1300 to allow entry of an account number into credential field 1312a. As shown in FIG. 13B, in response to detecting selection of credential field 1312a, device 1300 displays keypad 1314, which may be used to manually enter an account number into credential field 1312a, in some embodiments. Further in response to detecting selection of credential field 1312a, device 1300 displays autofill interface 1320. Keypad 1314 and/or autofill interface 1320 are overlaid on user interface 1310 in some embodiments.

Autofill interface 1320 includes account affordances 1322, each of which corresponds to a respective transfer account. In some embodiments, account affordances 1322 correspond only to transfer accounts provisioned on device 1300 (e.g., available in an electronic wallet application of device 1300 and/or are stored in a secure element of device 1300). In some embodiments, account affordances 1322 correspond to transfer accounts provisioned on device 1300 and transfer accounts not provisioned on device 1300, but for which an autofill operation is enabled.

While displaying autofill interface 1320, device 1300 detects selection of account affordance 1322a corresponding to a first transfer account (“Star Card”). In some embodiments, the selection is a tap gesture 1305b on account affordance 1322a. As shown in FIG. 13C, in response to detecting selection of account affordance 1322a, device 1300 autofills one or more credential fields 1312 using credentials corresponding to the first transfer account.

In some embodiments, a virtual account feature has been enabled for the first transfer account. In some embodiments, as a result of enabling the virtual account feature for the first transfer account, a virtual account number (e.g., a number ending in “8890”) and/or other virtual credentials have been provided for the first transfer account (e.g., “Star Card”). Accordingly, when autofilling credential fields 1312 using credentials corresponding to the first transfer account, device 1300 autofills the credential fields using the virtual credentials (e.g., virtual account number and/or rotating security code) of the first transfer account. As an example, credential field 1312a is autofilled using a virtual account number for the transfer account (e.g., number ending in “8890”), and credential field 1312d is autofilled using a rotating security code for the transfer account (e.g., number ending in “4”).

With reference to FIG. 13B, account affordance 1322a is shown as an account having an account number ending in “0234”. In some embodiments, the number shown in autofill interface 1320 corresponds to at least a portion of a physical account number for the first transfer account. In contrast, in FIG. 13C, the number autofilled in credential field 1312a (e.g., corresponding to the virtual account number for the transfer account) is a number ending in “8890”. Accordingly, in some embodiments, device 1300 displays autofill interface 1320 with references to physical account numbers, and autofills using virtual account numbers (e.g., when provided for a transfer account).

In some embodiments, one or more virtual credentials are obscured when used to autofill a credential field 1312. As an example, in FIG. 13C, device 1300 obscures at least a portion of the virtual account number autofilled in credential field 1312a and/or the rotating security code autofilled in credentials field 1312d. In some embodiments, the rotating security code autofilled in credentials field 1312d is completely obscured such that none of the digits are legible.

With reference once again to FIG. 13B, device 1300 detects selection of account affordance 1322b corresponding to a second transfer account (“Debit Card”). In some embodiments, the selection is a tap gesture 1307b on account affordance 1322b. As shown in FIG. 13D, in response to detecting selection of account affordance 1322b, device 1300 autofills one or more credential fields 1312 using credentials corresponding to the second transfer account.

In some embodiments, a virtual account feature has not been enabled for the second transfer account. Accordingly, when autofilling credential fields 1312 using credentials corresponding to the second transfer account, device 1300 autofills the credential fields using physical credentials (e.g., physical account number and/or physical security code) of the second transfer account, as illustrated in FIG. 13D. As an example, credential field 1312a of FIG. 13D is autofilled using a physical account number for the second transfer account, and credential field 1312d is autofilled using the physical security code for the second transfer account.

In some embodiments, physical credentials are displayed without obfuscation (e.g., not obscured) when used to autofill a credential field 1312. As an example, in FIG. 13D, device 1300 displays the physical account number autofilled in credential field 1312a (e.g., number ending in “1234”) and/or the physical security code autofilled in credentials field 1312d (e.g., “777”) without any obfuscation.

With reference once again to FIG. 13B, device 1300 detects a request to scroll account interface 1320. In some embodiments, the request is swipe input 1309b indicating a request to scroll account interface 720 in a leftward direction. As shown in FIG. 13E, in response to swipe input 1309b, device 1300 scrolls account interface 1320 in a leftward direction, revealing scan affordance 1324. While displaying account interface 1320 including scan affordance 1324, device 1300 detects selection of scan affordance 1324. In some embodiments, the selection is a tap gesture 1305e on account affordance 1324. As shown in FIG. 13F, in response to detecting selection of account affordance 1324, device 1300 displays scan interface 1330.

As shown in FIG. 13F, scan interface 1330 allows a user to scan a physical card for a transfer account using device 1300. In scanning the physical card, credentials (e.g., physical credentials) for the transfer account are identified by device 1300 and, optionally, used to complete the transaction. Scan interface 1330 includes frame 1334 for aligning physical card 1332 and image preview 1336 of card 1332. Once credentials corresponding to a transfer account of physical card 1332 have been successfully captured by device 1300, device 1300 resumes display of user interface 1310 and autofills each of the credential fields 1312 using credentials captured from physical card 1332. As shown, because credentials captured form physical card 1332 are physical credentials, the credentials are displayed without obfuscation (e.g., not obscured).

FIGS. 13H-13J describe operation of device 1300 during a second transaction. In FIG. 13H, electronic device 1300 is displaying, user interface 1310 and account interface 1320 while performing a process for a second transaction.

While displaying autofill interface 1320, device 1300 detects selection of account affordance 1322a corresponding to a first transfer account (“Star Card”). In some embodiments, the selection is a tap gesture 1305h on account affordance 1322a. As shown in FIG. 13I, in response to detecting selection of account affordance 1322a, device 1300 autofills one or more credential fields 1312 using virtual credentials corresponding to the first transfer account, as described. As an example, credential field 1312a is autofilled using a virtual account number for the transfer account (e.g., number ending in “8890”), and credential field 1312d is autofilled using a rotating security code for the transfer account (e.g., number ending in “6”). In some embodiments, the rotating security code autofilled in credentials field 1312d of FIG. 13I is completely obscured such that none of the digits are legible.

In some embodiments, security codes for virtual credentials are modified periodically and/or for each transaction. Accordingly, while in the first transaction the security code for the first transfer account ends in “4”, in the second transaction, the security code for the first transfer account ends in “6”.

With reference to FIG. 13H, while displaying autofill interface 1320, device 1300 detects selection of account affordance 1322b corresponding to a second transfer account (“Debit Card”). In some embodiments, the selection is a tap gesture 1307h on account affordance 1322b. As shown in FIG. 13J, in response to detecting selection of account affordance 1322b, device 1300 autofills one or more credential fields 1312 using physical credentials (e.g., physical account number and/or physical security code) of the second transfer account. As an example, credential field 1312a is autofilled using a physical account number for the second transfer account, and credential field 1312d is autofilled using the physical security code for the second transfer account. Because physical credentials are used for the second transfer account, a same physical account number and/or security code is used in each of the first and second transactions and is not obscured.

FIG. 14 is a flow diagram illustrating a method for obfuscating credentials of an account using a computer system in accordance with some embodiments. Method 1400 is performed at a computer system (e.g., 100, 300, 500, 1200, and/or 1300) (e.g., a smart watch, a smart phone, a head mounted device (e.g., a head mounted augmented reality and/or extended reality device), a self-motive device and/or system, and/or a personal computer) that is in communication with a display generation component (e.g., 1202, 1302) (e.g., an integrated display, a head mounted display system, and/or a display controller) and one or more input devices (e.g., a touch-sensitive surface (e.g., a touchscreen), a mouse, and/or a keyboard). Some operations in method 1400 are, optionally, combined, the orders of some operations are, optionally, changed, and some operations are, optionally, omitted.

As described below, method 1400 provides an intuitive way for obfuscating credentials of an account. The method reduces the cognitive burden on a user for autofilling credentials of an account, thereby creating a more efficient human-machine interface. For battery-operated computing devices, enabling a user to perform autofills with credentials of an account faster and more efficiently conserves power and increases the time between battery charges.

In some embodiments, the computer system (e.g., 1200 and/or 1300) displays (1402), via the display generation component, a plurality of selectable user interface objects (e.g., objects 1222 of 1220, 1322 of 1320) (e.g., as part of a scrollable user interface region). In some embodiments, the plurality of selectable user interface objects includes a first selectable user interface object (e.g., 1222a and/or 1322a) that corresponds to a first account (e.g., an asset account, a loyalty account, and/or a payment account) that is provisioned onto an electronic wallet of the computer system (e.g., a wallet that enables NFC payments using the computer system and/or that stores account credentials in a secure element of the computer system). In some embodiments, the plurality of selectable user interface objects includes a second selectable user interface object (e.g., 1222b, 1322b) that corresponds to a second account (e.g., an asset account, a loyalty account, and/or a payment account), different from the first account, that is enabled for (e.g., have account information stored locally or remotely for use in) performing an application (e.g., web browser or non-web browser) autofill operation at the computer system (e.g., a feature that automatically populates fields/forms (e.g., in an application or in a website) with account information (e.g., login/password, payment account information, email information, and/or physical address information) and/or a feature that populates information corresponding to an account into an application and/or webpage based on (e.g., in response to) a user selection of the account) and is not provisioned onto an electronic wallet of the computer system (e.g., a wallet that enables NFC payments using the computer system and/or that stores account credentials in a secure element of the computer system).

In some embodiments, the computer system receives (1404), via the one or more input devices, a user input (e.g., 1205b, 1207b, 1305b, 1307b, and/or 1305e) (e.g., a tap input, a swipe input, and/or a voice input) selecting one of the plurality of selectable user interface objects.

In some embodiments, in response to receiving the user input selecting one of the plurality of selectable user interface objects, in accordance with a determination that the user input corresponds to selection of the first selectable user interface object, the computer system initiates (1406) a process to perform an autofill operation (e.g., application autofill operation and/or a web browser autofill operation) to populate one or more fields (e.g., 1212a-1212d, 1312a-1312d) (e.g., a form in a webpage and/or fields in an application) using credentials of the first account, wherein credentials of the first account populated into a first field (e.g., 1212a, 1212d, 1312a, 1312d) of (and, optionally, a second field of and/or all fields of) the one or more fields are visually obfuscated (e.g., blurred out, displayed as dots, displayed as asterisks, are not legible).

In some embodiments, in response to receiving the user input selecting one of the plurality of selectable user interface objects, in accordance with a determination that the user input corresponds to selection of the second selectable user interface object, the computer system initiates (1408) a process to perform an autofill operation (e.g., a web browser autofill operation and/or a field or form autofill operation) to populate one or more fields (e.g., 1212a-1212d, 1312a-1312d) (e.g., a form/fields in a webpage and/or form/fields in an application) using credentials of the second account. In some embodiments, credentials of the second account populated into a first field (e.g., 1212a, 1212d, 1312a, 1312d) of (and, optionally, a second field of and/or all fields of) the one or more fields are not visually obfuscated (e.g., not blurred out and/or are legible).

In some embodiments, one or more details of provisioned asset accounts are stored in a secure element of the computer system as part of the provisioning process. In some embodiments, a secure element is a hardware component (e.g., a secure microcontroller chip) (e.g., of the computer system) configured to securely store data or an algorithm such that the securely stored data is not accessible by the computer system without proper authentication information from a user of the computer system. Keeping the securely stored data in a secure element that is separate from other storage on the computer system prevents access to the securely stored data even if other storage locations on the computer system are compromised (e.g., by malicious code or other attempts to compromise information stored on the computer system). In some embodiments, the secure element provides (or releases) account information (e.g., an account number and/or a transaction-specific dynamic security code). In some examples, the secure element provides (or releases) the account information in response to the computer system receiving authorization, such as a user authentication (e.g., biometric authentication (e.g., fingerprint authentication; facial authentication; iris authentication; passcode authentication)). In some embodiments, the released account information is transferred or transmitted to perform a transfer (e.g., a transfer of assets).

In some embodiments, credentials of the first account populated into the first field of (and, optionally, a second field of and/or all fields of) the one or more fields are visually obfuscated based on a virtual account feature of the first account being enabled. In some embodiments, credentials of the second account populated into the first field of (and, optionally, a second field of and/or all fields of) the one or more fields are not visually obfuscated based on the virtual account feature of the second account not being enabled. In some embodiments, when the virtual account feature is not enabled for the first account, the computer system automatically uses (e.g., transmits via short-range communication radio, such as NFC, auto-populates, and/or transmits via a wired or wireless communication channel, such as during a transaction conducted over the Internet) the same credential information (e.g., the same account number, the same expiration date, the same account holder name, and/or the same security code) for consecutive (e.g., for two consecutive, for three consecutive, and/or for all transactions) transactions performed using the first account, and when the virtual account feature is enabled for the first account, the computer system automatically uses (e.g., transmits via short-range communication radio, such as NFC, auto-populates, and/or transmits via a wired or wireless communication channel, such as during a transaction conducted over the Internet) different credential information (e.g., different account numbers that correspond to the same account, different expiration dates, different account holder names (e.g., John Doe vs. John H. Doc), and/or different security codes) for consecutive (e.g., for two consecutive, for three consecutive, and/or for all transactions) transactions performed using the first account.

Visually obfuscating credentials of the first account populated into the one or more fields increases the security of the credentials and prevents the user from trying to reuse credentials that will not be valid after the form has been submitted, thereby providing an improved machine-user interaction.

In some embodiments, the computer system displays, via the display generation component, an account entry field (e.g., 1212a-1212d, 1312a-1312d) (e.g., as part of an account entry form that includes multiple account entry fields, such as an account number entry field, an account holder name entry field, and/or an account expiration date entry field). In some embodiments, the computer system receives, via the one or more input devices, selection (e.g., 1205a, 1305a) of the account entry field. In some embodiments, the plurality of selectable user interface objects, including the first selectable user interface object and the second selectable object, is displayed in response to receiving selection of the account entry field. In some embodiments, in response to selection of the account entry, the computer system displays a text input cursor in the account entry field. In some embodiment, the computer system determines (e.g., based on meta data stored about the account entry field) that that account entry field corresponds to a field for entering account information (e.g., account credentials) and, in response, displays the plurality of selectable user interface objects. In some embodiments, the plurality of selectable user interface objects are part of a scrollable user interface region. In some embodiments, the scrollable user interface region is displayed adjacent to (e.g., directly above) a displayed keyboard. In some embodiments, the keyboard is displayed in response to receiving selection of the account entry field. Automatically displaying the plurality of selectable user interface objects when the computer system receives selection of the account entry field reduces the need for the user to provide inputs to access the plurality of selectable user interface objects, thereby reducing the number of inputs required.

In some embodiments, displaying the plurality of selectable user interface objects includes the displaying, via the display generation component, a third selectable user interface (e.g., 1324) object that is associated with one or more cameras of the computer system. In some embodiments, the computer system, in response to receiving the user input selecting one of the plurality of selectable user interface objects: in accordance with a determination that the user input corresponds to selection of the third selectable user interface object, initiates a process to use the one or more cameras of the computer system to determine credentials of a third account to use to perform an autofill operation (e.g., a web browser autofill operation and/or a field or form autofill operation) to populate one or more fields (e.g., a form/fields in a webpage and/or form/fields in an application). In some embodiments, credentials of the third account populated into the first field of (and, optionally, a second field of and/or all fields of) the one or more fields are not visually obfuscated (e.g., not blurred out and/or are legible). In some embodiments, the plurality of selectable user interface objects are part of a scrollable user interface region. In some embodiments, the computer system detects a card (e.g., a payment card, a memory allocation card, and/or a credit card) in a field of view of the one or more cameras and uses the one or more cameras to read the credentials of the card (e.g., an account number, an expiration date, and/or a card security code). In some embodiments, the computer system populates the one or more fields using the credentials read from the card using the one or more cameras. Initiating a process to use the one or more cameras of the computer system to determine credentials of a third account to use to perform an autofill operation to populate one or more fields enables the computer system to automatically fill in the credentials of a physical card (e.g., a physical credit card), thereby reducing the need for the user to manually enter the information, and thus reducing the number of inputs required.

In some embodiments, credentials of the third account populated into a first field of (and, optionally, a second field of and/or all fields of) the one or more fields are not visually obfuscated (e.g., not blurred out and/or are legible). Not visually obfuscating credentials of the third account enables the computer system to provide visual feedback to the user as to the information that was scanned and inputted into the fields, thereby providing improved visual feedback.

In some embodiments, the first selectable user interface object includes a (displayed) portion (e.g., last 4 digits or last 6 digits) of a first account number of the first account (e.g., “card ending in 0234”). In some embodiments, performing the autofill operation (e.g., a web browser autofill operation and/or a field or form autofill operation) to populate the one or more fields (e.g., a form/fields in a webpage and/or form/fields in an application) using credentials of the first account do not include the first account number of the first account. In some embodiments, the autofill operation using credentials of the first account includes autofilling a second account number that corresponds to the first account and that is different from the first account number. In some embodiments, the first account number is different from the second account number based on the virtual account feature being enabled for the first account. Autofilling using an account number other than the first account number of the first account helps to protect the security of the first account number, thereby improving the security of the computer system.

In some embodiments, the second selectable user interface object includes a (displayed) portion (e.g., last 4 digits or last 6 digits) of a third account number of the second account (e.g., “card ending in 1234”). In some embodiments, performing the autofill operation (e.g., a web browser autofill operation and/or a field or form autofill operation) to populate the one or more fields (e.g., a form/fields in a webpage and/or form/fields in an application) using credentials of the second account include the third account number of the second account. In some embodiments, the autofill operation uses credentials of the second account to autofill using the third account number. In some embodiments, the portion of the third account number (same account number as is autofilled) is displayed as part of the second selectable user interface object based on the virtual account feature not being enabled for the second account. Autofilling using the third account number of the second account helps provide the user with visual feedback about the account number used and enables the user to verify that the account number is correct, thereby providing the user with improved visual feedback.

In some embodiments, the computer system visually differentiates, via the display generation component, between the first selectable user interface object that corresponds to the first account and the second selectable user interface object that corresponds to the second account based on a virtual account feature of the first account being enabled and the virtual account feature of the second account not being enabled. In some embodiments, the computer system visually differentiates between the first selectable user interface object and the second selectable user interface object by including, as part of the first selectable user interface object, a first indication that the virtual account feature is enabled for the first account and/or by including, as part of the second selectable user interface object, a second indication that the virtual account feature is not enabled for the second account. Visually differentiating between objects that correspond to accounts that are enabled for the virtual account feature and accounts that are not enabled for the virtual account feature provides the user with visual feedback about which accounts are and are not enabled for the virtual account feature.

In some embodiments, displaying the first selectable user interface object that corresponds to the first account includes displaying (e.g., based on the virtual account feature being enabled for the first account) a visual representation of a physical card (e.g., physical card in 1222a or 1322a) (e.g., an image of a debit card, an ATM card, a credit card, and/or a memory allocation card) that corresponds to the first account. In some embodiments, displaying the second selectable user interface object that corresponds to the second account includes displaying (e.g., based on the virtual account feature not being enabled for the second account) a visual representation of a generic physical card (e.g., generic card in 1222b or 1322b) (e.g., an image of a generic debit card, a generic ATM card, a generic credit card, and/or a generic memory allocation card). In some embodiments, the first selectable user interface object also includes (e.g., based on the virtual account feature being enabled for the first account) a name (e.g., of a vendor of the card and/or of a service provider) corresponding to the first account and/or a portion of an account number corresponding to the first account. In some embodiments, the second selectable user interface object does not include (e.g., based on the virtual account feature not being enabled for the second account) a name (e.g., of a vendor of the card and/or of a service provider) corresponding to the second account and/or a portion of an account number corresponding to the second account. Visually differentiating between objects that correspond to accounts that are enabled for the virtual account feature and accounts that are not enabled for the virtual account feature provides the user with visual feedback about which accounts are and are not enabled for the virtual account feature.

In some embodiments, the computer system, subsequent to performing the autofill operation (e.g., application autofill operation and/or a web browser autofill operation) to populate one or more fields (e.g., a form in a webpage and/or fields in an application) using credentials of the first account, receives, via the one or more input devices, user input (1305h) to perform a second autofill operation using the first account. In some embodiments, the computer system, in response to receiving user input to perform the second autofill operation using the first account, performs the second autofill operation (e.g., application autofill operation and/or a web browser autofill operation) to populate one or more fields (e.g., a form in a webpage and/or fields in an application) using second credentials of the first account that are different from the credentials of the first account. In some embodiments, based on the virtual account feature being enabled for the first account, the computer system automatically uses different credential information (e.g., different account numbers that correspond to the same account, different expiration dates, different account holder names (e.g., John Doe vs. John H. Doc), and/or different security codes) for consecutive (e.g., for two consecutive, for three consecutive, and/or for all transactions) transactions performed using the first account. In some embodiments, the credential information is released from a secure element of the computer system based on user authentication (e.g., biometric authentication (e.g., fingerprint authentication; facial authentication; iris authentication; passcode authentication)). Populating different credentials for different autofill operations for the same account increases the security of the computer system.

In some embodiments, a first account number populated into a field during the autofill operation using the first account is different from a second account number populated into a field during the second autofill operation using the first account. Populating different account numbers for different autofill operations for the same account increases the security of the computer system.

In some embodiments, a first security code (e.g., CVV or CCV) populated into a field during the autofill operation using the first account is different from a second security code populated into a field during the second autofill operation using the first account. Populating different security codes for different autofill operations for the same account increases the security of the computer system.

In some embodiments, a first account expiration date populated into a field during the autofill operation using the first account is the same as a second expiration date populated into a field during the second autofill operation using the first account. In some embodiments, a first account holder name populated into a field during the autofill operation using the first account is the same as a second account holder name populated into a field during the second autofill operation using the first account.

In some embodiments, the computer system, subsequent to performing the autofill operation (e.g., application autofill operation and/or a web browser autofill operation) to populate one or more fields (e.g., a form in a webpage and/or fields in an application) using credentials of the second account, receives, via the one or more input devices, user input (e.g., 1307h) to perform a second autofill operation using the second account. In some embodiments, the computer system, in response to receiving user input to perform the second autofill operation using the second account, performs the second autofill operation (e.g., application autofill operation and/or a web browser autofill operation) to populate one or more fields (e.g., a form in a webpage and/or fields in an application) using second credentials of the second account that are the same as the credentials of the second account. In some embodiments, based on the virtual account feature not being enabled for the second account, the computer system automatically uses the same credential information (e.g., same account numbers that correspond to the same account, same expiration dates, same account holder names (e.g., John Doe vs. John H. Doc), and/or same security codes) for consecutive (e.g., for two consecutive, for three consecutive, and/or for all transactions) transactions performed using the second account. In some embodiments, the credential information is released from a secure element of the computer system based on user authentication (e.g., biometric authentication (e.g., fingerprint authentication; facial authentication; iris authentication; passcode authentication)). Populating the same credentials for the second account when the second account is not enabled for the virtual account feature enables the user to confirm that the correct account information is being used, thereby providing the user with improved visual feedback.

In some embodiments, the plurality of selectable user interface objects are ordered (as part of the scrollable user interface region) with selectable user interface objects corresponding to respective accounts with the virtual account feature enabled being prioritized (e.g., displayed first, displayed earlier, and/or displayed initially) as compared to selectable user interface objects corresponding to respective accounts without the virtual account feature enabled. Ordering or prioritizing the selectable user interface objects based on the virtual account feature being enabled provides the user with feedback about which selectable user interface objects correspond to accounts that have the virtual account feature enabled, thereby providing improved feedback.

In some embodiments, the selectable user interface objects corresponding to respective accounts with the virtual account feature enabled are ordered (as part of the scrollable user interface region) based on frequency of use of the respective accounts. In some embodiments, selectable user interface objects corresponding to respective accounts without the virtual account feature enabled are ordered (as part of the scrollable user interface region) based on frequency of use. In some embodiments, the plurality of selectable user interface objects are part of a scrollable user interface region. Ordering the selectable user interface objects corresponding to respective accounts with the virtual account feature enabled based on frequency of use provides the user with visual feedback about which accounts are used more often, thereby providing improved visual feedback.

Note that details of the processes described above with respect to method 1400 (e.g., FIG. 14) are also applicable in an analogous manner to the methods described above and/or below. For example, method 1100 optionally includes one or more of the characteristics of the various methods described above with reference to method 1400. For example, after provisioning a transfer account as described with respect to method 1100, credentials of the provisioned transfer account can be populated in one or more fields during a transaction and visually obscured, as described with respect to method 1400. For brevity, these details are not repeated below.

FIGS. 15A-15E illustrate exemplary user interfaces for managing orders in accordance with some embodiments. The user interfaces in these figures are used to illustrate the processes described below, including the processes in FIG. 17. In some embodiments, device 1500 includes one or more features of devices 100, 300, and/or 500.

In some embodiments, orders (and information corresponding to the same) described herein are associated with a user account (or multiple user accounts). In some embodiments, the user account is a computer storage management account. In some embodiments, the computer storage management account is a first-party transfer account (e.g., a transfer account that is issued or branded by, for example, the manufacturer of the electronic device).

FIG. 15A illustrates electronic device 1500. In FIG. 15A, electronic device 1500 is a portable multifunction device and has one or more components described above in relation to one or more of devices 100, 300, and 500.

In FIG. 15A, electronic device 1500 is displaying, on display 1502 (e.g., touch screen 702), a user interface 1510 of a transfer application (e.g., an electronic wallet application). In some embodiments, user interface 1510 includes representations 1512 (or portions thereof) corresponding to different accounts (e.g., transfer accounts) provisioned on electronic device 600. As shown, representations 912 include, for instance, representation 1512a corresponding to a computer storage management account and representation 1512b corresponding to a personal storage account (e.g., cloud account). In some embodiments, representation 1512a corresponds to a first-party manufacturer-issued (or branded) computer storage management account.

While displaying user interface 1510, device 1500 detects selection of representation 1512a corresponding to the computer storage management account. In some embodiments, the selection of representation 1512a is a tap gesture 1505a on representation 1512a of the computer storage management account. As shown in FIG. 15B, in response to detecting tap gesture 1505a, device 1500 displays storage account interface 1520.

In some embodiments, storage account interface 1520 includes storage transfer history 1522, which shows a plurality of recent account activities (e.g., transactions and/or orders) corresponding to previously requested transfers (e.g., transfers of storage) associated with the computer storage management account corresponding to representation 1512a. As an example, storage transfer history 1522 includes a first transfer 1522a corresponding to a request to transfer a specified amount (e.g., 50 MB) to the computer storage management account. As another example, storage transfer history 1522 includes a second transfer 1522b corresponding to a request to transfer a specified amount (e.g., 25 MB) from the computer storage management account. As shown, first transfer 1522a and second transfer 1522b of storage transfer history 1522 include respective dates indicating, for example, a date upon which the request for the transfer was made (or when the respective operation was completed).

In some embodiments, a user may wish to review and/or manage one or more orders (e.g., an order corresponding to a computer storage management account provisioned on device 1600), such as orders included in storage transfer history 1222. With reference to FIG. 15A, user interface 1510 includes orders affordances 1514 and 1516, each of which, when selected, enables a user to manage orders corresponding to one or more computer storage management accounts provisioned on device 1500. In some embodiments, orders affordance 1516 is selectively displayed in user interface 1510. For example, in some embodiments, orders affordance 1516 is displayed a single time, or is displayed each time user interface 1510 is accessed until dismissed by a user.

While displaying user interface 1610, device 1500 detects selection of orders affordance 1514 (or orders affordance 1516). In some embodiments, the selection of orders affordance 1514 is a tap gesture 1507a on order affordance 1514. As shown in FIG. 15C, in response to detecting tap gesture 1507a, device 1500 displays orders interface 1530.

Orders interface 1530 includes order affordances 1532, each of which corresponds to a respective order for one or more transfer accounts provisioned on device 1500. As an example, order affordance 1532a corresponds to a service “Photo Cloud”. As another example, order affordance 1532b corresponds to a service “Media Storage”. Orders interface 1530 further includes search field 1534, which may be used to search orders (e.g., pending, cancelled, and/or completed) of orders interface 1530.

While displaying orders interface 1530, device 1500 detects selection of order affordance 1532a. In some embodiments, the selection of order affordance 1532a is a tap gesture 1505b on order affordance 1532a. As shown in FIG. 15D, in response to detecting tap gesture 1505b, device 1500 displays order details interface 1540 for a first order.

At FIG. 15D, order details interface 1540 includes status portion 1542. Status portion 1542 includes various details and/or information regarding the status of an order. By way of example, status portion 1542 includes status bar 1542a and order details 1542b. Status bar 1542a indicates a status of the order, and in some embodiments, is updated as the status of the order changes. As shown, status bar 1542a indicates that the order has a status of “order placed”. Order details 1542b indicates various details of the order, including but not limited to, an order number and time and/or date of the order.

Order details interface 1540 further includes manage affordance 1544, which when selected, allows a user to modify a status of an order. A user may, for instance, cancel an order. Order details interface 1540 further includes contact affordance 1546, which, when selected, allows a user to contact a service representative associated with the order. In response to selection of contact affordance 1546, device 1500 may provide (e.g., display) contact information for the merchant, initiate a call with the representative, and/or generate a draft email for contacting the representative. Order details interface 1540 includes application affordance 1548 which, when selected, causes device 1500 to open (and/or download) an application corresponding to the service (e.g., “Photo Cloud”).

While displaying orders interface 1530, device 1500 detects selection of order affordance 1532b. In some embodiments, the selection of order affordance 1532b is a tap gesture 1507b on order affordance 1532b. As shown in FIG. 15E, in response to detecting tap gesture 1507b, device 1500 displays order details interface 1550 for a second order.

At FIG. 15E, order details interface 1550 includes status portion 1552. Status portion 1552 includes various details and/or information regarding the status of an order. By way of example, status portion 1552 includes status bar 1552a and order details 1552b. Status bar 1552a indicates a status of the order, and in some embodiments, is updated as the status of the order changes. As shown, status bar 1552a indicates that the order has a status of “order placed”. Order details 1552b indicates various details of the order, including but not limited to, an order number and time and/or date of the order.

FIGS. 16A-16L illustrate exemplary user interfaces for managing orders, in accordance with some embodiments. The user interfaces in these figures are used to illustrate the processes described below, including the processes in FIG. 17. In some embodiments, device 1600 includes one or more features of devices 100, 300, and/or 500.

In some embodiments, orders (and information corresponding to the same) described herein are associated with a user account (or multiple user accounts). In some embodiments, the user account is a transfer account. In some embodiments, the transfer account is a first-party transfer account (e.g., a transfer account that is issued or branded by, for example, the manufacturer of the electronic device), and, optionally, provides rewards (e.g., cash back rewards, bonus points rewards) based on the amount of transfers (e.g., payment transactions and/or points transfers) made using the transfer account (e.g., cash back rewards that are based on a certain percentage of the value of each transaction) and/or made using a different account. In some embodiments, the transfer account is a points account (e.g., for meal points, for printer credits, and/or for membership points) that provides rewards (e.g., points rewards) based on the amount of points used using the transfer account.

FIG. 16A illustrates electronic device 1600. In FIG. 16A, electronic device 1600 is a portable multifunction device and has one or more components described above in relation to one or more of devices 100, 300, and 500.

In FIG. 16A, electronic device 1600 is displaying, on display 1602 (e.g., touch screen 1602), a user interface 1610 of a transfer application (e.g., an electronic wallet application). In some embodiments, user interface 1610 includes representations 1612 corresponding to different transfer accounts (e.g., payment accounts, such as a third-party credit card account, a debit card account, and/or a stored-value account; points accounts; and/or rewards accounts) provisioned on the electronic device. As shown, representations 1612 include, for instance, a representation 1612a corresponding to a first transfer account and a representation 1612b corresponding to a second transfer account. In some embodiments, representation 1612a corresponds to a first-party transfer account.

While displaying user interface 1610, device 1600 detects selection of representation 1612a corresponding to the transfer account. In some embodiments, the selection of representation 1612a is a tap gesture 1605a on representation 1612a of the transfer account. As shown in FIG. 16B, in response to detecting tap gesture 1605a, device 1600 displays transfer account interface 1620.

In some embodiments, transfer account interface 1620 includes transfer history 1622, which shows a plurality of recent account activities (e.g., transactions and/or orders) corresponding to previously requested transfers (e.g., transfers of funds) associated with the transfer account corresponding to representation 1612a. As an example, transfer history 1622 includes a first transfer 1622a corresponding to a request to transfer a specified amount (e.g., $76.87) from the transfer account in connection with an order from a first merchant (e.g., “Sportswear Co.”). As another example, transfer history 1622 includes a second transfer 1622b corresponding to a request to transfer a specified amount (e.g., $25.00) from the transfer account in connection with a second order from a second merchant (e.g., “Clothing Co”). As shown, first transfer 1622a and second transfer 1622b of transfer history 1622 include respective dates indicating, for example, a date upon which the request for the transfer was made (or when the respective operation was completed).

In some embodiments, a user may wish to review and/or manage one or more orders (e.g., an order corresponding to a transfer account provisioned on device 1600), such as orders included in transfer history 1622. With reference to FIG. 16A, user interface 1610 includes orders affordances 1614 and 1616, each of which, when selected, enables a user to manage orders corresponding to one or more transfer accounts provisioned on device 1600. In some embodiments, orders affordance 1616 is selectively displayed in user interface 1610. For example, in some embodiments, orders affordance 1616 is displayed a single time, or is displayed each time user interface 1610 is accessed until dismissed by a user.

While displaying user interface 1610, device 1600 detects selection of orders affordance 1614 (or orders affordance 1616). In some embodiments, the selection of orders affordance 1614 is a tap gesture 1607a on order affordance 1614. As shown in FIG. 16C, in response to detecting tap gesture 1607a, device 1600 displays orders interface 1630.

Orders interface 1630 includes order affordances 1632, each of which corresponds to a respective order for one or more transfer accounts provisioned on device 1600. As an example, order affordance 1632a corresponds to an order placed with a merchant “Sportswear Co.”. As another example, order affordance 1632b corresponds to an order (e.g., a pick-up order) placed with a merchant “Sports Store”. As yet another example, order affordance 1632c corresponds to an order (e.g., a cancelled order) placed with a merchant “Make Up Shop”. Orders interface 1630 further includes search field 1634, which may be used to search orders (e.g., pending, cancelled, and/or completed) of orders interface 1630.

While displaying orders interface 1630, device 1600 detects selection of order affordance 1632a. In some embodiments, the selection of order affordance 1632a is a tap gesture 1605b on order affordance 1632a. As shown in FIG. 16D, in response to detecting tap gesture 1605b, device 1600 displays order details interface 1640 (e.g., on a date of March 1).

At FIG. 16D, order details interface 1640 includes status portion 1642. Status portion 1642 includes various details and/or information regarding the status of an order. By way of example, status portion 1642 includes status bar 1642a and order details 1642b. Status bar 1642a indicates a status of the order, and in some embodiments, is updated as the status of the order changes. As shown, status bar 1642a indicates that the order has a status of “order placed”. Order details 1642b indicates various details of the order, including but not limited to, an order number, tracking number, shipping address, and time and/or date of the order.

Order details interface 1640 further includes manage affordance 1644, which when selected, allows a user to modify a status of an order. A user may, for instance, cancel an order, arrange for an item exchange, and/or change a shipping address of an order. Order details interface 1640 further includes contact affordance 1646, which, when selected, allows a user to contact a merchant associated with the order. In response to selection of contact affordance 1646, device 1600 may provide (e.g., display) contact information for the merchant, initiate a call with the merchant, and/or generate a draft email for contacting the merchant. Order details interface 1640 includes application affordance 1648 which, when selected, causes device 1600 to open (and/or download) an application corresponding to the merchant.

In some embodiments, device 1600 notifies a user when a status of an order has changed. In FIG. 16E, for example, device 1600 displays notification 1618 in user interface 1610 (e.g., on a date of March 2). In some embodiments, notification 1618 indicates the updated status of the order (e.g., “Order Shipped”) and, optionally, one or more details corresponding to the updated status (e.g., “Product has shipped and arrives March 3”). In some embodiments, notification 1618, when selected, causes device 1600 to display an order details interface corresponding to the updated order.

For example, while displaying orders interface 1610, device 1600 detects selection of notification 1618. In some embodiments, the selection of notification 1618 is a tap gesture 1605e on notification 1618. As shown in FIG. 16F, in response to detecting tap gesture 1605e, device 1600 displays order details interface 1640 (e.g., on a date of March 2) including an updated status for the order. Status bar 1642a, for instance, indicates that the status of the order is shipped (recall that, in FIG. 16D, status bar 1642a indicated the previous status of the order, “Order Placed”).

Thereafter, as the status of the order changes, device 1600 may notify the user of status updates (e.g., by providing a notification in user interface 1610 and/or one or more other interfaces, such as a device lock screen and/or a device home page), and display order details interface 1640 with the updated status (e.g., when the notification is selected). As an example, in FIG. 16G, the status of the order has changed to “Out for Delivery”, as indicated by status bar 1642a. As another example, in FIG. 16H, the status of the order has changed to “Delivered”, as indicated by status bar 1642a. In some embodiments, when an order is complete (e.g., “delivered”), status bar 1642a is displayed with a completion indicator (e.g., checkmark) to indicate completion of the order.

In some embodiments, device 1600 provides order details for unsuccessful orders (e.g., cancelled and/or failed orders). With reference to FIG. 16C, while displaying orders interface 1630, device 1600 detects selection of order affordance 1632c. In some embodiments, the selection of order affordance 1632c is a tap gesture 1609b on order affordance 1632c. As shown in FIG. 16I, in response to detecting tap gesture 1609b, device 1600 displays order details interface 1650. As illustrated in FIG. 16I, status bar 1652a of status portion 1650 indicates that the order has a status of “Cancelled”. In some embodiments, when an order is cancelled, status bar 1652a is displayed with a cancellation indicator (e.g., an “X”) to indicate cancellation of the order.

In some embodiments, device 1600 provides order details for pick-up orders. With reference to FIG. 16C, while displaying orders interface 1630, device 1600 detects selection of order affordance 1632b. In some embodiments, the selection of order affordance 1632b is a tap gesture 1607b on order affordance 1632b. As shown in FIG. 16J, device 1600 displays (e.g., on a date of March 1) order details interface 1660 for a pick-up order corresponding to a merchant “Sports Store”. As illustrated in FIG. 16J, status bar 1662a indicates that the order has a status of “Pick Up Tomorrow”, indicating that items of the order will be ready for pick-up at the indicated day and/or time.

Thereafter, a status of the pick-up order may be updated. As shown in FIG. 16K, device 1060 displays (e.g., on a date of March 2) order details interface 1660. As shown, status bar 1662a indicates that the order has a status of “Ready for pick-up”, indicating that items of the order are currently available for pick up at a location of the merchant. As shown in FIG. 16L, the status may be updated once again after the user has picked up items of the order. Status bar 1662a, for instance, indicates that the order has a status of “Picked Up.” In some embodiments, when a pick-up order is complete (e.g., “Picked Up”), status bar 1662a is displayed with a completion indicator (e.g., checkmark) to indicate completion of the pick-up order.

FIG. 17 is a flow diagram illustrating a method for managing orders using a computer system in accordance with some embodiments. Method 1700 is performed at a computer system (e.g., 100, 300, 500, 1500, and/or 1600) (e.g., a smart watch, a smart phone, a head mounted device (e.g., a head mounted augmented reality and/or extended reality device), a self-motive device and/or system, and/or a personal computer) that is in communication with a display generation component (e.g., 1502, 1602) (e.g., an integrated display, a head mounted display system, and/or a display controller), one or more input devices (e.g., a touch-sensitive surface (e.g., a touchscreen), a mouse, and/or a keyboard), and one or more communication radios (e.g., near-field communication radio and/or short-range communication radio). Some operations in method 1700 are, optionally, combined, the orders of some operations are, optionally, changed, and some operations are, optionally, omitted.

As described below, method 1700 provides an intuitive way for managing orders. The method reduces the cognitive burden on a user for managing orders, thereby creating a more efficient human-machine interface. For battery-operated computing devices, enabling a user to manage orders faster and more efficiently conserves power and increases the time between battery charges.

In some embodiments, the computer system displays (1702), via the display generation component, a user interface of an electronic wallet application that includes concurrent display of a plurality of selectable user interface objects (e.g., 1512a, 1512b, 1514, 1516, 1612a, 1612b, 1614, and/or 1616). In some embodiments, the plurality of selectable user interface objects includes a first selectable user interface object (e.g., 1512a, 1612a) that corresponds to a first account (e.g., an asset account, a loyalty account, and/or a payment account) that is provisioned onto an electronic wallet of the computer system (e.g., a wallet that enables NFC payments using the computer system and/or that stores account credentials in a secure element of the computer system). In some embodiments, the computer system is configured to perform (e.g., when authorized by a user of the computer system, such as through a passcode or biometric authentication), using near-field communication via the one or more communication radios, transfers (e.g., transfer of memory allocation, transfer of funds or payment information, transfer of loyalty card information, and/or transfers of non-payment information) using the first account. In some embodiments, the plurality of selectable user interface objects includes a second selectable user interface object (e.g., 1512b, 1612b) that corresponds to a second account (e.g., an asset account, a loyalty account, and/or a payment account), different from the first account, that is provisioned onto the electronic wallet of the computer system (e.g., a wallet that enables NFC payments using the computer system and/or that stores account credentials in a secure element of the computer system). In some embodiments, the computer system is configured to perform (e.g., when authorized by a user of the computer system, such as through a passcode or biometric authentication), using near-field communication via the one or more communication radios, transfers (e.g., transfer of memory allocation, transfer of funds or payment information, transfer of loyalty card information, and/or transfers of non-payment information) using the second account. In some embodiments, the plurality of selectable user interface objects includes an order (e.g., purchase or non-purchase) tracking user interface object (e.g., 1514, 1516, 1614, and/or 1616) (e.g., that does not correspond to an asset account for performing transfers and/or does not correspond to a payment account for performing payments) for tracking order statuses.

In some embodiments, the computer system receives (1704) a first user input (e.g., 1505a, 1507a, 1605a, and/or 1607a) (e.g., a tap input, a swipe input, and/or a voice input) selecting one of the plurality of selectable user interface objects.

In some embodiments, in response to receiving the first user input selecting one of the plurality of selectable user interface objects, in accordance with a determination that the first user input corresponds to selection (e.g., 1505a and/or 1605a) of the first selectable user interface object, the computer system ceases (1706) to display the second selectable user interface object and displays (1706), via the display generation component, information about one or more (e.g., one, two, five, and/or a plurality) transfers (e.g., NFC transfers, website transfers, and/or transfers performed using a non-wallet application of the computer system) performed using the first account (e.g., 1522 and/or 1622) (e.g., without displaying information about transfers performed using the second account).

In some embodiments, in response to receiving the first user input selecting one of the plurality of selectable user interface objects, in accordance with a determination that the first user input corresponds to selection (e.g., 1507a and/or 1607a) of the order tracking user interface object, the computer system displays (1708), via the display generation component, a plurality of summaries of orders (e.g., interface 1530 and/or interface 1630) (e.g., purchases, shipment/delivery requests, and/or in-store pickup requests), including a first summary of a first order (e.g., 1532a and/or 1632a) from a first merchant and a second summary of a second order (e.g., 1532b and/or 1632b) from a second merchant that is different from the first merchant.

In some embodiments, while displaying the plurality of summaries of orders, the computer system receives (1710), via the one or more input devices, a second user input (e.g., 1505b, 1507b, 1605b, 1607b, and/or 1609b) (e.g., a tap input, a swipe input, and/or a voice input) selecting one of the plurality of summaries of orders.

In some embodiments, in response to receiving the second user input selecting one of the plurality of summaries of orders, in accordance with a determination that the second user input corresponds to selection of the first summary of the first order, the computer system displays (1712), via the display generation component and using a predefined arrangement (e.g., a template and/or layout), order tracking details (e.g., any of interfaces 1540, 1550, 1640, 1650, and/or 1660) (e.g., a shipping date, an order number, a ship-to address, a ship-from address, a shipping tracking number, an order status, listing of items in the order, an amount paid to the first merchant, and/or a status (e.g., a shipping status and/or an in-store pickup status)) of the first order (e.g., without displaying order tracking details of the second order).

In some embodiments, in response to receiving the second user input selecting one of the plurality of summaries of orders, in accordance with a determination that the second user input corresponds to selection of the second summary of the second order, the computer system displays (1714), via the display generation component and using the predefined arrangement (e.g., a the same template and/or layout), order tracking details (e.g., any of interfaces 1540, 1550, 1640, 1650, and/or 1660) (e.g., a shipping date, an order number, a ship-to address, a ship-from address, a shipping tracking number, an order status, listing of items in the order, an amount paid to the second merchant, and/or a status (e.g., a shipping status and/or an in-store pickup status)) of the second order (e.g., without displaying order tracking details of the first order).

In some embodiments, one or more details of provisioned asset accounts are stored in a secure element of the computer system as part of the provisioning process. In some embodiments, a secure element is a hardware component (e.g., a secure microcontroller chip) (e.g., of the computer system) configured to securely store data or an algorithm such that the securely stored data is not accessible by the computer system without proper authentication information from a user of the computer system. Keeping the securely stored data in a secure element that is separate from other storage on the computer system prevents access to the securely stored data even if other storage locations on the computer system are compromised (e.g., by malicious code or other attempts to compromise information stored on the computer system). In some embodiments, the secure element provides (or releases) account information (e.g., an account number and/or a transaction-specific dynamic security code). In some examples, the secure element provides (or releases) the account information in response to the computer system receiving authorization, such as a user authentication (e.g., biometric authentication (e.g., fingerprint authentication; facial authentication; iris authentication; passcode authentication)). In some embodiments, the released account information is transferred or transmitted to perform a transfer (e.g., a transfer of assets). Displaying, using a predefined arrangement, order tracking details of the first order and/or the second order provides the user with visual feedback about the information that the computer system has received about the first order and/or second order, thereby providing the user with improved visual feedback.

In some embodiments, the computer system, prior to displaying the plurality of summaries of orders (e.g., purchases, shipment/delivery requests, and/or in-store pickup requests) that includes the first summary of the first order from the first merchant and the second summary of the second order from the second merchant, transmits, via a website of the first merchant or an application of the first merchant, a request to place the first order. In some embodiments, the computer system, prior to displaying the plurality of summaries of orders (e.g., purchases, shipment/delivery requests, and/or in-store pickup requests) that includes the first summary of the first order from the first merchant and the second summary of the second order from the second merchant, transmits, via a website of the second merchant or an application of the second merchant, a request to place the second order. Displaying the summaries of orders after the computer system has transmitted requests to place the first order and the second order prior to provides the user with feedback about the orders and enables the user to confirm the status of the orders, thereby providing improved visual feedback.

In some embodiments, displaying the order tracking details of the first order includes displaying a first amount (e.g., amount displayed in any of interfaces 1542, 1552, 1642, 1652, and/or 1662) (e.g., an amount of funds, an amount of processing power, and/or an amount of storage space) transferred (e.g., using the computer system or not using the computer system) to the first merchant as part of the first order. In some embodiments, displaying the order tracking details of the second order includes displaying a second amount (e.g., amount displayed in any of interfaces 1542, 1552, 1642, 1652, and/or 1662) (e.g., different from the first amount, an amount of funds, an amount of processing power, and/or an amount of storage space) transferred (e.g., using the computer system or not using the computer system) to the second merchant as part of the second order. Including an amount paid to the merchant provides the user with feedback about the order and enables the user to confirm that the amount paid is correct, thereby providing the user with improved visual feedback.

In some embodiments, displaying the order tracking details of the first order includes displaying indications of (e.g., name of or image of) one or more items (e.g., items displayed in any of interfaces 1542, 1552, 1642, 1652, and/or 1662) (e.g., a process being performed, an amount of memory allocation, a brand, size, color, and/or name of an item or product) of the first order. In some embodiments, displaying the order tracking details of the second order includes displaying indications of (e.g., name of or image of) one or more items (e.g., items displayed in any of interfaces 1542, 1552, 1642, 1652, and/or 1662) (e.g., different from the one or more items of the first order, a process being performed, an amount of memory allocation, a brand, size, color, and/or name of an item or product) of the second order. Including indications of one or more items of the orders provides the user with feedback about the order and enables the user to confirm that the order is correct, thereby providing the user with improved visual feedback.

In some embodiments, prior to displaying the plurality of summaries of orders (e.g., purchases, shipment/delivery requests, and/or in-store pickup requests) that includes the first summary of the first order from the first merchant and the second summary of the second order from the second merchant, the computer system transfers (e.g., via a website of the first merchant or an application of the first merchant and/or to the first merchant) credentials of the first account (e.g., for payment) to place the first order. In some embodiments, prior to displaying the plurality of summaries of orders (e.g., purchases, shipment/delivery requests, and/or in-store pickup requests) that includes the first summary of the first order from the first merchant and the second summary of the second order from the second merchant, the computer system transmits (e.g., via a website of the second merchant or an application of the second merchant and/or to the second merchant) credentials of the second account (e.g., for payment) to place the second order. Displaying summaries of orders placed using credentials of different accounts enables the computer system to consolidate summaries of multiple orders into a single user interface, thereby providing the user with improved visual feedback.

In some embodiments, displaying the order tracking details of the first order includes displaying a first visual indication of a status of the first order. In some embodiments, displaying a first visual indication of a status (e.g., 1542a, 1552a, 1642a, 1652a, and/or 1662a) of the first order includes, in accordance with a determination that the status of the first order is a first status (e.g., order placed and/or order shipped), displaying, via the display generation component, the first visual indication of the status of the first order at a first location of a user interface of the order tracking details of the first order. In some embodiments, displaying a first visual indication of a status of the first order includes, in accordance with a determination that the status of the first order is a second status (e.g., out for delivery and/or delivered), displaying, via the display generation component, the first visual indication of the status of the first order at a second location of the user interface of the order tracking details of the first order. In some embodiments, displaying the order tracking details of the second order includes displaying a respective visual indication of a status of the second order, including: in accordance with a determination that the status of the second order is the first status (e.g., order placed and/or order shipped), displaying the respective visual indication of the status of the second order at the first location of a user interface of the order tracking details of the second order and in accordance with a determination that the status of the second order is the second status (e.g., out for delivery and/or delivered), displaying the respective visual indication of the status of the second order at the second location of the user interface of the order tracking details of the second order. Displaying the first visual indication of the stat of the first order at different locations based on the status of the first order provides the user with visual feedback about the status of the order, thereby providing improved visual feedback.

In some embodiments, the first visual indication is sequentially displayed at a plurality of predefined locations along a predefined path. In some embodiments, the plurality of predefined locations along the predefined path correspond to a plurality of statuses (e.g., achieved or to be achieved, order placed, order shipped, order out for delivery, and/or order delivered) for completion of the first order. In some embodiments, the predefined path is displayed. In some embodiments, the predefined path is not displayed. In some embodiments, the first location and the second location are along the predefined path. In some embodiments, the predefined path is a line. In some embodiments, the second visual indication is displayed at the predefined locations along the predefined path to indicate the status of the second order. Displaying the first visual indication at different locations along a path based on the status of the first order provides the user with visual feedback about the status of the order, thereby providing improved visual feedback.

In some embodiments, displaying the order tracking details of the first order includes displaying, via the display generation component, a plurality of indications (e.g., markers and or dots) at the predefined locations along the predefined path, wherein the plurality of indications correspond to a plurality of statuses (e.g., achieved or to be achieved, order placed, order shipped, order out for delivery, and/or order delivered) for completion of the first order. Displaying a plurality of indications at the predefined locations along the predefined path indicates to the user the number of status changes that have been made and/or need to be made before completion of the order, thereby providing the user with improved visual feedback.

In some embodiments, displaying the order tracking details of the first order includes: displaying, via the display generation component, a representation (e.g., 1542a, 1552a, 1642a, 1652a, and/or 1662a) of the predefined path. In some embodiments, the representation of the predefined path includes a first visual appearance for a first portion of the predefined path corresponding to one or more order statuses that have been achieved for the first order. In some embodiments, the representation of the predefined path includes a second visual appearance, different from the first visual appearance, for a second portion of the predefined path, different from the first portion of the predefined path, corresponding to one or more order statuses that to be achieved for completion of the first order. In some embodiments, as the first order progresses toward completion, the first portion gets longer and the second portion gets shorter. Displaying the predefined path with differing visual appearances provides the user with feedback about the status of the order, thereby providing the user with improved visual feedback.

In some embodiments, displaying the first visual indication of the status of the first order includes, in accordance with a determination that the status of the first order is one of a first plurality of statuses (e.g., order placed, order shipped, and order out for delivery), displaying, via the display generation component, the first visual indication (e.g., 1542a, 1552a, 1642a, 1652a, and/or 1662a) of the status of the first order with a first appearance (e.g., including an image of a package). In some embodiments, displaying the first visual indication of the status of the first order includes, in accordance with a determination that the status of the first order is not one of the first plurality of statuses (e.g., the first order has been delivered), displaying, via the display generation component, the first visual indication (e.g., 1542a, 1552a, 1642a, 1652a, and/or 1662a) of the status of the first order with a second appearance (e.g., including an image of a check mark) that is different from the first appearance. The first visual indication having a different visual appearance based on the status of the order provides the user with feedback about the status of the order, thereby providing the user with improved visual feedback.

In some embodiments, the computer system receives status information associated with (e.g., corresponding to) the first order. In some embodiments, the computer system, in response to receiving the status information associated with the first order, displays, via the display generation component, a notification (e.g., 1618) based on the status information (e.g., including the status information). In some embodiments, the computer system receives, via the one or more input devices, selection (e.g., 1605c) of (e.g., a tap on and/or a tap and hold on) the notification. In some embodiments, the computer system, in response to receiving selection of the notification, displays, via the display generation component and using the predefined arrangement (e.g., a template and/or layout), the order tracking details (e.g., a shipping date, an order number, a ship-to address, a ship-from address, a shipping tracking number, an order status, listing of items in the order, an amount paid to the first merchant, and/or a status (e.g., a shipping status and/or an in-store pickup status)) of the first order (e.g., without displaying order tracking details of the second order). Displaying the order tracking details of an order after receiving selection of a notification for the order provides the user with feedback about the status of the order, thereby providing improved visual feedback.

In some embodiments, the plurality of selectable user interface objects, displayed via the display generation component as part of the user interface of the electronic wallet application, includes a second order (e.g., purchase or non-purchase) tracking user interface object (e.g., 1514, 1516, 1614, and/or 1616) (e.g., that does not correspond to an asset account for performing transfers and/or does not correspond to a payment account for performing payments), different from the order tracking user interface object, for tracking order statuses. In some embodiments, the computer system receives, via the one or more input devices, selection (e.g., 1507a, 1607a) of the second order tracking user interface object In some embodiments, the computer system receives, in response to receiving selection of the second order tracking user interface object, displays, via the display generation component, the plurality of summaries of orders (e.g., purchases, shipment/delivery requests, and/or in-store pickup requests), including the first summary of the first order from the first merchant and the second summary of the second order from the second merchant that is different from the first merchant. Providing an option, in an electronic wallet and along with representations of various accounts (such as payment accounts and loyalty accounts) to access the plurality of summaries of orders enables the user to quicky view the summaries without the need to provide a large number of inputs, thereby reducing the number of inputs required.

In some embodiments, displaying the order tracking details of the first order includes displaying a first order identifier (e.g., order number of any of 1542b, 1552b, 1642b, 1652b, and/or 1662b) (e.g., an order number and/or an order alphanumeric value) of the first order. In some embodiments, displaying the order tracking details of the second order includes displaying a second order identifier (e.g., order number of any of 1542b, 1552b, 1642b, 1652b, and/or 1662b) (e.g., an order number and/or an order alphanumeric value) of the second order that is different from the first order identifier of the first order. In some embodiments, displaying the order tracking details of the first order includes displaying an option to initiate a communication (e.g., text, email, and/or voice) with the first merchant. Displaying an order identified as part of the order tracking details provides the user with visual feedback about the order identifier and allows the user to confirm that the order is the correct order, thereby providing improved visual feedback.

In some embodiments, displaying the order tracking details of the first order includes a shipping address of a shipment of the first order (e.g., shipping address of any of 1542b, 1552b, 1642b, 1652b, and/or 1662b). In some embodiments, the order tracking details of the first order includes a shipping tracking identifier (e.g., a shipment tracking number). In some embodiments, selection of the shipping tracking identifier causes displays of shipment tracking information of the shipment of the first order (e.g., displays a tracking website). Displaying a shipping address as part of the order tracking details provides the user with visual feedback about the address that the product is being shipped to and allows the user to confirm that the address is correct, thereby providing improved visual feedback.

In some embodiments, displaying the order tracking details of the first order includes an order management option (e.g., 1544 and/or 1644). In such embodiments, the computer system receives, via the one or more input devices, selection of the order management option. In such embodiments, the computer system, in response to receiving selection of the order management option, displays, via the display generation component, an option to initiate a process to cancel the first order. Providing the user an option to manage an order enables the user to make changes to the order and/or cancel the order after reviewing the details of the order, thereby reducing the number of inputs required to manage the order.

In some embodiments, displaying the first summary of the first order from the first merchant includes displaying, via the display generation component, an indication of the first merchant (e.g., merchant name as indicated in 1640, 1650, and/or 1660) (e.g., a name of the merchant and/or a logo of the merchant) and an order status (e.g., order status of 1642, 1652, and/or 1662) (e.g., order received, order shipped, order ready for picked, order delivered) of the first order. Displaying a name of a merchant and an order status as part of the plurality of summaries of orders provides the user with visual feedback about the details of the order, thereby providing improved visual feedback.

In some embodiments, the computer system, in response to receiving the first user input selecting one of the plurality of selectable user interface objects and in accordance with the determination that the first user input corresponds to selection of the order tracking user interface object, displays, via the display generation component and concurrently with the plurality of summaries of orders, a search option (e.g., 1534 and/or 1634). In some embodiments, the computer system receives, via the one or more input devices, entry of a search phrase (e.g., a word or multiple words) into the search option. In some embodiments, the computer system, in response to receiving entry of the search phrase into the search option, displays, via the display generation component, search results that include a plurality of summaries of orders, including a respective order from the first merchant and a respective order from the second merchant. In some embodiments, the search functionality enables the user to search across multiple merchants for pending and/or completed orders. Providing a search option enables the user to quickly and efficiently find an order without the need to scroll through numerous orders, thereby reducing the number of inputs required to access the relevant order.

In some embodiments, an arrangement (e.g., ordering) of the plurality of summaries of orders is not based on a time of receipt of respective notifications of statuses of the respective orders and the arrangement (e.g., ordering) of the plurality of summaries of orders is not based on a time of transmission of respective notifications of status of the respective orders. Not ordering the orders based on when the notification of a status was received enables the user to view the orders based on their relevance, rather than based on when a notification was received.

In some embodiments, an arrangement (e.g., ordering) of the plurality of summaries of orders is based on respective statuses (e.g., recently delivered orders, orders scheduled to be delivered soon, orders that are in transit, orders that are not yet shipped, and then orders that have been delivered) of the respective orders. Ordering the orders based on the respective order statuses allows the user to quickly find the most relevant orders, thereby providing the user with improved visual feedback.

Note that details of the processes described above with respect to method 1700 (e.g., FIG. 17) are also applicable in an analogous manner to the methods described above. For example, method 1100 optionally includes one or more of the characteristics of the various methods described above with reference to method 1700. For example, a representation of a transfer account that has been provisioned in an electronic wallet application, as described with respect to method 1100, may be concurrently displayed in the electronic wallet application with an order tracking user interface object, as described with respect to method 1700. For brevity, these details are not repeated below.

FIG. 18 illustrates an exemplary user interface for managing rewards for an account, in accordance with some embodiments. The user interface in FIG. 18 is used to illustrate the processes described below, including the processes in FIG. 20 and FIG. 21.

In some embodiments, rewards (and information corresponding to the same) described herein are associated with a user account (or multiple user accounts). In some embodiments, the user account is a computer storage management account, such a computer storage management account for storing and/or transferring computer storage resources. In some embodiments, the computer storage management account is a first-party transfer account (e.g., a transfer account that is issued or branded by, for example, the manufacturer of the electronic device).

FIG. 18 illustrates electronic device 1800. In FIG. 18, electronic device 1800 is a portable multifunction device and has one or more components described above in relation to one or more of devices 100, 300, and 500.

In FIG. 18, device 1800 is displaying rewards interface 1850. In some embodiments, rewards interface 1850 is displayed in response to selection of a rewards affordance, for instance, included in an electronic wallet application and/or an interface corresponding to a transfer account.

In some embodiments, rewards interface 1850 includes rewards indicators 1852-1852c. Rewards indicator 1852a indicates rewards accrued over the lifetime of the transfer account. Rewards indicator 1852b indicates rewards accrued over a first period of time (e.g., a week or a month), and rewards indicator 1852c indicates rewards accrued over a second period of time (e.g., a year or year-to-date). In some embodiments, the first period of time and the second period of time are periods of different lengths.

In some embodiments, rewards interface 1850 includes rewards indicator 1854. In some embodiments, rewards indicator 1854 indicates different categories of rewards accrued for the transfer account. For example, as illustrated, rewards indicator 1954 indicates rewards accrued as 1% rewards, 2% rewards, 3% rewards, and bonus rewards, respectively. In some embodiments, 1% rewards are rewards that were accrued from a transfer in which 1% of the amount of the transfer (e.g., 1% of the amount of storage transferred) was provided as rewards for the transfer account. In some embodiments, 2% rewards are rewards that were accrued from a transfer in which 2% of the amount of the transfer (e.g., 2% of the amount of storage transferred) was provided as rewards for the transfer account. In some embodiments, 3% rewards are rewards that were accrued from a transfer in which 3% of the amount of the transfer (e.g., 3% of the amount of storage transferred) was provided as rewards for the transfer account. In some embodiments, bonus rewards are rewards provided as part of a promotion and/or in combination with 1%, 2%, and/or 3% rewards.

In some embodiments, indicator 1854 includes respective portions corresponding to each category of rewards. By way of example, rewards indicator 1854 includes portion 1854a corresponding to 1% rewards. As another example, rewards indicator 1854 includes portion 1854b corresponding to 2% rewards. As another yet example, rewards indicator 1854 includes portion 1854c corresponding to 3% rewards. As another yet example, rewards indicator 1854 includes portion 1854d corresponding to bonus rewards. In some embodiments, the relative sizes of portions 1854a-1854d correspond to the amount of rewards accrued for each category of rewards. In some embodiments, one or more of portions 1854a-1854d are visually highlighted. By way of example, in some embodiments, one or more of portions 1854a-1854d are displayed with a respective color.

Rewards interface 1850 further includes election options 1856. In some embodiments, election options 1856 allow a user to select the manner in which accrued rewards and/or future rewards are applied. In some embodiments, only a single election option 1856 is enabled at a given time. In some embodiments, multiple election options 1856 are enabled at a given time.

Election options 1856 includes election option 1856a, which when enabled, applies (e.g., saves) rewards of the transfer account to another transfer account, such as another computer storage management account (e.g., a computer storage management account of a different cloud storage provider). In some embodiments, election option 1856a is enabled by default (e.g., election option 1856a is enabled if a user has not yet selected an election option 1856).

Election option 1856b, when enabled, applies rewards of the transfer account to a storage savings account. In some embodiments, computer storage resources of the storage savings account is borrowed by other users and in exchange, computer storage resources of the storage savings account accrue interest (e.g., in the form of additional memory). In some embodiments, upon selecting election option 1856b for the first time, device 1800 initiates a process for opening a storage savings account for the user. Thereafter, once the storage savings account has been opened, a user can apply accrued rewards to the storage savings account and/or withdraw computer storage resources from and/or deposit computer storage resources in the storage savings account. In some embodiments, so long as election option 1856b remains enabled, rewards accrued for the transfer account will be applied (e.g., automatically applied and/or applied without user input) to the storage saving account. In this manner, a user can earn interest on rewards accrued for the transfer account.

Election option 1856c, when enabled, applies rewards of the transfer account to a computer resource account. In some embodiments, upon selecting election option 1856c for the first time, device 1800 initiates a process for opening a computer resource account, and optionally, allows a user to select one or more computer resources for the account. In some embodiments, a computer resource account can be used to purchase and/or exchange various types of computer resources, such as CPU, networking, and/or memory computer resources.

Thereafter, once the investment account has been opened, a user can apply accrued rewards to the computer resource account and/or initiate orders to buy and/or sell various computer resources for the computer resource account (e.g., exchange computer storage resources for computer CPU resources). In some embodiments, so long as election option 1856c remains enabled, rewards accrued for the transfer account will be applied (e.g., automatically applied and/or applied without user input) to the computer resource account and, optionally, used to initiate one or more orders of one or more computer resources. In this manner, a user can automatically invest rewards accrued for the transfer account.

FIGS. 19A-19W illustrate exemplary user interfaces for managing rewards for a user account (e.g., a transfer account), in accordance with some embodiments. The user interfaces in these figures are used to illustrate the processes described below, including the processes in FIG. 20 and FIG. 21.

In some embodiments, the user account is a transfer account. In some embodiments, the transfer account is a first-party transfer account (e.g., a transfer account that is issued or branded by, for example, the manufacturer of the electronic device), and, optionally, provides rewards (e.g., cash back rewards and/or bonus points rewards) based on the amount of transfers (e.g., payment transactions and/or points transfers) made using the transfer account (e.g., cash back rewards that are based on a certain percentage of the value of each transaction) and/or made using a different account. In some embodiments, the transfer account is a points account (e.g., for meal points, for printer credits, and/or for membership points) that provides rewards (e.g., points rewards) based on the amount of points used using the transfer account.

FIG. 19A illustrates electronic device 1900. In FIG. 19A, electronic device 1900 is a portable multifunction device and has one or more components described above in relation to one or more of devices 100, 300, and 500.

In FIG. 19A, electronic device 1900 is displaying, on display 1902 (e.g., touch screen 1902), a user interface 1910 of a transfer application (e.g., an electronic wallet application). In some embodiments, user interface 1910 includes representations 1912 corresponding to different transfer accounts (e.g., payment accounts, such as a third-party credit card account, a debit card account, and/or a stored-value account; points accounts; and/or rewards accounts) provisioned on the electronic device. As shown, representations 1912 include, for instance, a representation 1912a corresponding to a first transfer account, a representation 1912b corresponding to a second transfer account, and representation 1912c corresponding to a third transfer account. In some embodiments, one or more of representations 1912a-1912c are first-party transfer accounts (e.g., transfer account provided by a manufacturer of electronic device 1900). In some embodiments, user interface 1910 includes representations 1914 (e.g., representations 1914a-1914d) corresponding to other various accounts (e.g., transfer accounts, points cards, and/or rewards cards), ID cards (e.g., student ID and/or government-issued ID), tickets (e.g., event ticket and/or boarding pass ticket), and/or vaccination cards provisioned on or otherwise linked to electronic device 1900.

While displaying user interface 1910, device 1900 detects selection of representation 1912c. In some embodiments, the selection of representation 1912c is a tap gesture 1905a on representation 1912c. As shown in FIG. 19B, in response to detecting tap gesture 1905a, device 1900 displays transfer account interface 1920 corresponding to the transfer account of representation 1912c.

Transfer account interface 1920 includes transfer history 1922, which shows one or more recent account activities corresponding to previously requested transfers (e.g., transfers of funds) associated with the transfer account. As an example, transfer history 1922 includes a first transfer 1922a corresponding to a request to transfer a specified amount (e.g., $50.00) from the transfer account. As shown, first transfer 1922a of transfer history 1922 includes a date indicating, for example, a date upon which the request for the transfer was made (or when the transfer was completed).

Transfer account interface 1920 includes balance 1924. In some embodiments, balance 1924 indicates a current balance (e.g., an outstanding balance) of the transfer account, and optionally, an amount available for the credit card (e.g., a difference of a credit limit for the transfer account and the balance of the transfer account).

In some embodiments, a user may wish to access and/or view, for a transfer account, rewards accrued for the transfer account. In some embodiments, rewards are viewed using the transfer account interface 1920. By way of example, while displaying transfer account interface 1920, device 1900 detects selection of menu affordance 1926. In some embodiments, the selection is a tap gesture 1905b on menu affordance 1926. In response to detecting selection of menu affordance 1926, device 1900 displays menu 1930 including rewards affordance 1932. While displaying menu 1930, device 1900 detects selection of rewards affordance 1932. In some embodiments, the selection is a tap gesture 1907b on rewards affordance 1932. In response to detecting selection of rewards affordance 1932, device 1900 displays a rewards interface, such as rewards interface 1950 (FIG. 19D).

In some embodiments, a user may access and/or view a more detailed summary of spending for the transfer account. For example, at FIG. 19B, while displaying transfer account interface 1920, device 1900 detects selection of summary affordance 1928. In some embodiments, the selection is a tap gesture 1909b on summary affordance 1928. As shown in FIG. 19C, in response to detecting selection of summary affordance 1928, device 1900 displays summary interface 1940.

At FIG. 19C, summary interface 1940 includes spending summary 1942, which in some embodiments, details spending for the transfer account, for instance, on a monthly basis. Summary interface 1940 further includes rewards portion 1944, which in some embodiments, is used to view rewards accrued for the transfer account. By way of example, while displaying summary interface 1940, device 1900 detects selection of rewards affordance 1944a of rewards portion 1944. In some embodiments, the selection is a tap gesture 1905c on rewards affordance 1944a, as shown in FIG. 19C. In response to detecting selection of rewards affordance 1944a, device 1900 displays a rewards interface, such as rewards interface 1950 (FIG. 19D).

In FIG. 19D, device 1900 is displaying rewards interface 1950. As described, in some embodiments, rewards interface 1950 is displayed in response to selection of a rewards affordance (e.g., rewards affordance 1932 or rewards affordance 1944a).

In some embodiments, rewards interface 1950 includes rewards indicators 1952a-1952c. Rewards indicator 1952a indicates rewards accrued over the lifetime of the transfer account. Rewards indicator 1952b indicates rewards accrued over a first period of time (e.g., a week or a month), and rewards indicator 1952c indicates rewards accrued over a second period of time (e.g., a year or year-to-date). In some embodiments, the first period of time and the second period of time are periods of different lengths.

In some embodiments, rewards interface 1950 includes rewards indicator 1954. In some embodiments, rewards indicator 1954 indicates different categories of rewards accrued for the transfer account. For example, as illustrated, rewards indicator 1954 indicates rewards accrued as 1% rewards, 2% rewards, 3% rewards, and bonus rewards, respectively. In some embodiments, 1% rewards are rewards that were accrued from a transfer in which 1% of the amount of the transfer was provided as rewards for the transfer account. In some embodiments, 2% rewards are rewards that were accrued from a transfer in which 2% of the amount of the transfer was provided as rewards for the transfer account. In some embodiments, 3% rewards are rewards that were accrued from a transfer in which 3% of the amount of the transfer was provided as rewards for the transfer account. In some embodiments, bonus rewards are rewards provided as part of a promotion and/or in combination with 1%, 2%, and/or 3% rewards.

In some embodiments, indicator 1954 includes respective portions corresponding to each category of rewards. By way of example, rewards indicator 1954 includes portion 1954a corresponding to 1% rewards. As another example, rewards indicator 1954 includes portion 1954b corresponding to 2% rewards. As another yet example, rewards indicator 1954 includes portion 1954c corresponding to 3% rewards. As another yet example, rewards indicator 1954 includes portion 1954d corresponding to bonus rewards. In some embodiments, the relative sizes of portions 1954a-1954d correspond to the amount of rewards accrued for each category of rewards. In some embodiments, one or more of portions 1954a-1954d are visually highlighted. By way of example, in some embodiments, one or more of portions 1954a-1954d are displayed with a respective color.

Rewards interface 1950 further includes election options 1956. In some embodiments, election options 1956 allow a user to select the manner in which accrued rewards and/or future rewards are applied. In some embodiments, only a single election option 1956 is enabled at a given time. In some embodiments, multiple election options 1956 are enabled at a given time.

Election options 1956 includes election option 1956a, which when enabled, applies (e.g., saves) rewards of the transfer account to another transfer account, such as a savings account (e.g., a stored value account, a debit account, and/or a spending account). In some embodiments, election option 1956a is enabled by default (e.g., election option 1956a is enabled if a user has not yet selected an election option 1956).

Election option 1956b, when enabled, applies rewards of the transfer account to a savings account, such as a high-yield savings account. In some embodiments, upon selecting election option 1956b for the first time, device 1900 initiates a process for opening a savings account for the user. For example, while displaying rewards interface 1950, device 1900 detects selection of election option 1956b. In some embodiments, the selection is a tap gesture 1905d on election option 1956b. As shown in FIG. 19E, in response to detecting selection of election option 1956b, device 1900 displays savings interface 1960.

Savings interface 1960 includes information 1962 indicating that the savings account allows for a user of device 1900 to earn interest on rewards for the transfer account and/or any additional deposits made in the savings account. Savings interface 1960 includes confirmation affordance 1962, which when selected, causes device 1900 to initiate a process for opening a savings account for a user of device 1900. For example, while displaying savings interface 1960, device 1900 detects selection of confirmation affordance 1964 (e.g., tap gesture 1905e), and in response, initiates a process to open a savings for the user. In some embodiments, the process to open a savings account requires the user to provide personal information and/or answers to one or more financial regulatory questions.

Thereafter, once the savings account has been opened, a user can apply accrued rewards to the savings account. In FIG. 19F, for instance, device 1900 displays deposit interface 1970. In some embodiments, deposit interface 1970 is displayed by device 1900 in response to device 1900 detecting completion of the process to open the savings account. Deposit interface 1970 includes deposit affordance 1972, which when selected transfers accrued rewards for the transfer account to the savings account. For example, while displaying deposit interface 1970, device 1900 detects selection of deposit affordance 1972. In some embodiments, the selection is a tap gesture 1905f on deposit affordance 1972. In response to detection selection of deposit affordance 1972, device 1900 applies accrued rewards of the transfer account to the savings account. As shown in FIG. 19G, further in response to detecting selection of deposit affordance 1972, device 1900 displays savings interface 1980.

In some embodiments, savings interface 1980 includes savings summary 1982. As shown in FIG. 19G, savings summary 1982 illustrates an increase of the balance (e.g., of funds) in the savings account (e.g., an increase from $0.00 to $150.00) corresponding to the rewards from the transfer account that were applied to the savings account. Savings interface 1980 further includes transfer history 1984, which shows one or more recent account activities corresponding to previously requested transfers (e.g., transfers of funds) associated with the savings account. As an example, transfer history 1984 includes a first transfer 1984a corresponding to the transfer of accrued rewards from the transfer account to the savings.

Thereafter, a user of device 1900 can withdraw funds from and/or deposit funds in the savings account using transfer affordances 1986a and 1986b, respectively. In some embodiments, so long as election option 1956b (FIG. 19D) remains enabled, rewards accrued for the transfer account will be applied (e.g., automatically applied and/or applied without user input) to the savings account. In this manner, a user can earn interest on rewards accrued for the transfer account.

With reference to FIG. 19D, election option 1956c, when enabled, applies rewards of the transfer account to an investment account (e.g., an investment account, an asset account, and/or an equities account). In some embodiments, upon selecting election option 1956c for the first time, device 1900 initiates a process for opening an investment account, and optionally, allows a user to select one or more equities and/or assets for the account. For example, while displaying rewards interface 1950, device 1900 detects selection of election option 1956c. In some embodiments, the selection is a tap gesture 1907d on election option 1956c. As shown in FIG. 19H, in response to detecting selection of election option 1956c, device 1900 displays investment interface 1990.

Investment interface 1990 includes information 1992 indicating that the investment account allows a user to select (e.g., purchase) an equity or asset (or multiple equities and/or assets) using rewards accrued for the transfer account. Investment interface 1990 includes confirmation affordance 1992, which when selected, causes device 1900 to initiate a process for opening an investment account for a user of device 1900. For example, while displaying investment interface 1990, device 1900 detects selection of confirmation affordance 1994 (e.g., tap gesture 1905h), and in response, initiates a process to open an investment account for the user. In some embodiments, the process to open an investment account requires the user to provide personal information and/or answers to one or more financial regulatory questions.

Thereafter, once the investment account has been opened, a user can apply accrued rewards to the investment account. In FIG. 19I, for instance, device 1900 displays selection interface 1910A. In some embodiments, selection interface 1910A is displayed by device 1900 in response to device 1900 detecting completion of the process to open the investment account. Selection interface 1910A includes equity affordances 1910Aa-1910Af, each of which corresponds to a respective equity (e.g., stock, ETF share, asset, or bond). For example, equity affordance 1910Aa corresponds to equity “Example 1”, equity affordance 1910Ab corresponds to equity “Example 2”, equity affordance 1910Ac corresponds to equity “Example 3”, equity affordance 1910Ad corresponds to equity “Example 4”, equity affordance 1910Ae corresponds to equity “Example 5”, and equity affordance 1910Af corresponds to equity “Example 6”.

In some embodiments, selection of an equity affordance 1910A allows the user of device 1900 to select an equity for the investment account of the user. For example, while displaying selection interface 1910A, device 1900 detects selection of equity affordance 1920Aa corresponding to equity “Example 1”. In some embodiments, the selection is a tap gesture 1905i on equity affordance 1920Aa. As shown in FIG. 19J, in response to detecting selection of equity affordance 1920Aa, device 1900 displays summary interface 1920A corresponding to equity Example 1.

In some embodiments, summary interface 1920A includes equity summary 1922A including information about equity Example 1. Equity summary 1922A includes, for instance, price history, volume, and/or news corresponding to Equity 1. Summary interface 1920A further includes continue affordance 1924A, which when selected, allows a user to confirm selection of Example 1. For example, while displaying summary interface 1920A, device 1900 detects selection of continue affordance 1924A. In some embodiments, the selection is a tap gesture 1905j on continue affordance 1924A. As shown in FIG. 19K, in response to detecting selection of continue affordance 1924A, device 1900 displays order interface 1930A.

Order interface 1930A includes order affordance 1932A, which when selected, initiates an order to purchase equity Example 1 using accrued rewards of the transfer account. For example, while displaying order interface 1930A, device 1900 detects selection of order affordance 1932A. In some embodiments, the selection is a tap gesture 1905k on order affordance 1932A. In response to detection selection of order affordance 1932A, device 1900 initiates an order to purchase equity Example 1 using accrued rewards of the transfer account. As shown in FIG. 19L, further in response to detecting selection of order affordance 1932A, device 1900 displays investment interface 1940A.

In some embodiments, investment interface 1940A includes investment summary 1942A. As shown in FIG. 19L, investment summary 1942A illustrates an increase in the total equity in the investment account (e.g., an increase from $0.00 to $150.00) corresponding to the accrued rewards of the transfer account that were used to purchase the equity Example 1. Investment interface 1940A further includes transfer history 1944A, which shows one or more recent account activities corresponding to previously requested transfers (e.g., transfers of funds) associated with the investment account. As an example, transfer history 1944A includes a first transfer 1944Ab corresponding to the transfer of accrued rewards to the investment account and transfer 1944Aa corresponding to the purchase of equity Example 1 using the accrued rewards.

Thereafter, a user of device 1900 can initiate orders to buy and/or sell equities (e.g., Example 1) using transfer affordances 1946Aa and 1946Ab, respectively. In some embodiments, so long as election option 1956c (FIG. 19D) remains enabled, rewards accrued for the transfer account will be applied (e.g., automatically applied and/or applied without user input) to the investment account and, optionally, used to initiate one or more orders of equity Example 1 (and/or one or more other equities). In this manner, a user can automatically invest rewards accrued for the transfer account.

In FIG. 19M, device 1900 is displaying rewards interface 1950 (e.g., in response to selection 19051 and/or following selection of election option 1956c). In some embodiments, rewards interface 1950 includes offers portion 1957 and merchant offer affordances 1958, such as merchant offer affordances 1958a-1958c. In some embodiments, offers portion 1957 indicates one or more offers available to a user of device 1900. In some embodiments, an offer indicates a manner in which the user can accrue extra rewards and/or other benefits. As an example, an offer may indicate that the user will accrue additional rewards upon completion of transfers corresponding to one or more specific categories of transfers (e.g., gas, electronics). Offers portion 1957 indicates the duration of the offer, in some embodiments. As another example, an offer may indicate that the user will accrue additional rewards upon completion of transfers of a particular transfer account.

In some embodiments, merchant offer affordances 1958 indicate various offers for one or more merchants. As shown in FIG. 19M, for instance, merchant offer affordances 1958a-1958c correspond, respectively, to merchants offering a 3% reward on transfers. In some embodiments, merchant offer affordances 1958 are arranged based on offer type. Accordingly, merchant offer affordances 1958a-1958c are grouped in rewards interface 1950 in some embodiments. It will be appreciated that rewards interface 1950 can include any number of merchant offer affordances 1958 corresponding to any number of offer types.

In some embodiments, only a subset of merchants offering rewards are shown in rewards interface 1950. Accordingly, in some embodiments, rewards interface 1950 includes a view affordance, which when selected, causes device 1900 to display all merchants offering rewards (e.g., for a particular offer type). For example, while displaying rewards interface 1950, device 1900 detects selection of view affordance 1959. In some embodiments, as shown in FIG. 19M, the selection is a tap gesture 1905m on view affordance 1959. As shown in FIG. 19N, in response to detecting selection of view affordance 1959, device 1900 displays merchant interface 1950A.

In some embodiments, merchant interface 1950A includes a list of merchants offering rewards. In some embodiments, merchant interface 1950A includes a list of merchants offering rewards of a particular type (e.g., 1% rewards or 3% rewards). Merchants 1952Aa includes merchant 1952Aa corresponding to a merchant “Computer Co.”, merchant 1952Ab corresponding to a merchant “Pow! Comics”, merchant 1952Ac corresponding to a merchant “Titanium Coolers”, and merchant 1952Ad corresponding to a merchant “Action Sports”.

In some embodiments, merchants 1952A include one or more affordances. In some embodiments, affordances of merchants 1952A include affordances accessing various services associated with the merchant. For example, merchant 1952Ab includes application affordance 1954Aa which when selected causes device 1900 to display an interface for accessing (e.g., downloading and/or installing) an application corresponding to the merchant.

As another example, merchant 1952Ab includes location affordance 1954Ab which when selected causes device 1900 to display a location corresponding to the merchant (e.g., a location of a store). In some examples, the location is displayed using a web browser and/or a maps application.

As yet another example, merchant 1952Ac includes application affordance 1954Ac which when selected causes device 1900 to open (e.g., execute and/or display) an application corresponding to the merchant 1952Ac.

As yet another example, merchant 1952Ab includes website affordance 1954Ad which when selected causes device 1900 to display a website corresponding to the merchant. In some embodiments, displaying the website includes launching (e.g., opening and/or executing) a web browser and accessing the website using the web browser.

Thereafter, the website of the merchant can be used to initiate one or more transfers. For example, in FIG. 19O, device 1900 displays a webpage 1960A of the merchant website corresponding to a product provided by the merchant (e.g., “Titanium Coolers”). While displaying webpage 1960A, device 1900 detects selection of buy affordance 1962A. In some embodiments, the selection is a tap gesture 19050 on buy affordance 1962A. As shown in FIG. 19P, in response to detecting selection of buy affordance 1962A, device 1900 displays confirmation interface 1970A for confirming a purchase of the product. Confirmation interface 1970A is overlaid webpage 1960A in some embodiments.

Confirmation interface 1970A includes details 1972A, including transfer account details 1972Aa. Transfer account details specify the transfer account to be used in the transfer and, optionally, an offer associated with the transfer (e.g., 3% rewards offer).

While displaying confirmation interface 1970A, device 1900 detects input 1905p (e.g., a double press of button 1903) indicating user confirmation of the purchase, and in response, device 1900 completes the purchase of the product. In FIG. 19Q, device 1900 displays transfer account interface 1920. As shown, the transfer corresponding to the purchase is listed in transfer history 1922 as transfer 1922b. In some embodiments, transfer 1922b indicates that the transfer was associated with an offer (e.g., using indicator 1922ba) and/or indicates a type of offer (e.g., a 3% reward offer) associated with the transfer (using indicator 1922bb).

In FIG. 19R, device 1900 is initiating a transfer using a wireless communication protocol (e.g., NFC and/or WiFi), for instance with an external device, such as a payment terminal. In some embodiments, the transfer is a transfer of $110.00 to merchant “Computer Co.”. As shown, while initiating the transfer, device 1900 displays authentication interface 1980A, prompting a user to authenticate (e.g., biometrically authenticate) with device 1900. Once authenticated, device 1900 performs the transfer.

In FIG. 19S, device 1900 displays transfer account interface 1920 after completion of the transfer to merchant “Computer Co.” In some embodiments, transfer account interface 1920 is displayed in response to completion of the transfer to merchant “Computer Co.” As shown, the transfer to merchant “Computer Co.” is listed in transfer history 1922 as transfer 1922c. In some embodiments, transfer 1922c is associated with an offer. For example, as shown, transfer 1922c indicates that the transfer was associated with an offer (e.g., using indicator 1922ca) and/or indicates a type of offer (e.g., a 3% reward offer) associated with the transfer (using indicator 1922cb).

While displaying transfer account interface 1920, device 1900 detects selection of done affordance 1934. In some embodiments, the selection is a tap gesture 1905s on done affordance 1934. As shown in FIG. 19T, in response to detecting selection of done affordance 1934, device 1900 displays rewards interface 1950.

In some embodiments, rewards interface 1950 is updated as rewards for a transfer account are accrued and/or applied to one or more accounts. For example, as shown, following transfers 1922b (e.g., with merchant Titanium Coolers) and 1922c (e.g., with merchant Computer Co.), rewards interface 1950 indicates updated reward totals for the transfer account. As an example, rewards indicator 1954 is updated to reflect a current distribution of different reward types. In some embodiments, updating rewards indicator 1954 in this manner includes adjusting the relative sizes of portions 1954a-1954d. As another example, rewards indicators 1952b and 1952c may be updated to include rewards accrued from transfers 1922b and 1922c. For instance, indicators 1922b and 1922c may be each increased by $2.70 ($90.00*3%) to include rewards accrued from transfer 1922b and increased by $3.30 ($110.00*3%) to include rewards accrued from transfer 1922c. As yet another example, the total for election option 1956c may be increased (recall that election option 1956c is the option selected such that rewards are applied to an investment account corresponding to election option 1956c) reflecting that rewards accrued for the transfer account have been applied to the investment account associated with election option 1956c.

In some embodiments, a user may wish to review rewards accrued for a transfer account. For example, in FIG. 19U, device 1900 displays user interface 1910 of a transfer application (e.g., an electronic wallet application). As described, in some embodiments, user interface 1910 includes representations 1912 corresponding to different transfer accounts provisioned on the electronic device. While displaying user interface 1910, device 1900 detects selection of representation 1912a. In some embodiments, the selection of representation 1912a is a tap gesture 1905u on representation 1912a. As shown in FIG. 19V, in response to detecting tap gesture 1905u, device 1900 displays transfer account interface 1990A corresponding to the transfer account of representation 1912a.

Transfer account interface 1990A includes transfer history 1994A, which shows one or more recent account activities corresponding to previously requested transfers (e.g., transfers of funds) associated with the transfer account. As an example, transfer history 1994A includes transfer 1994Aa corresponding to the transfer of rewards (e.g., $6.00 accrued from transfers 1922b, 1922c) to the transfer account.

While displaying transfer account interface 1994A, device 1900 detects selection of transfer 1994Aa. In some embodiments, the selection is a tap gesture 1905v on transfer 1994Aa. In response to detecting selection of transfer 1994Aa, device 1900 displays rewards summary 1910B.

Rewards summary 1910B includes rewards history 1912B indicating (e.g., listing) the rewards received during a particular timeframe (e.g., day and/or week). For example, as shown, rewards history 1912B includes rewards transfer 1912Ba corresponding to transfer 1922c and rewards transfer 1912Bb corresponding to transfer 1922b. In some embodiments, rewards history 1912B indicates rewards for multiple timeframes and/or all rewards accrued for the transfer account. For example, as shown, transfer history 1912B can indicate rewards received during a longer timeframe (e.g., month and/or year).

FIG. 20 is a flow diagram illustrating a method for managing rewards for an account using a computer system in accordance with some embodiments. Method 2000 is performed at a computer system (e.g., 100, 300, 500, 1800, and/or 1900) (e.g., a smart watch, a smart phone, a head mounted device (e.g., a head mounted augmented reality and/or extended reality device), a self-motive device and/or system, and/or a personal computer) that is in communication with a display generation component (e.g., 1802 and/or 1902) (e.g., an integrated display, a head mounted display system, and/or a display controller), one or more input devices (e.g., a touch-sensitive surface (e.g., a touchscreen), a mouse, and/or a keyboard), and one or more communication radios (e.g., near-field communication radio and/or short-range communication radio). Some operations in method 2000 are, optionally, combined, the orders of some operations are, optionally, changed, and some operations are, optionally, omitted.

As described below, method 2000 provides an intuitive way for managing rewards for an account. The method reduces the cognitive burden on a user for managing rewards for an account, thereby creating a more efficient human-machine interface. For battery-operated computing devices, enabling a user to manage rewards faster and more efficiently conserves power and increases the time between battery charges.

In some embodiments, the computer system displays (2002), via the display generation component (e.g., as part of a user interface of an electronic wallet application), a plurality of selectable user interface options (e.g., 1856, 1856a-1856c, 1956, and/or 1956a-1956c) (e.g., a first selectable option, a second selectable option, and/or a third selectable option) for applying future (and/or, optionally, accumulated) rewards (e.g., bonus storage, cash back, and/or rewards points) of a first asset account (e.g., a memory account, a credit card account, and/or a payment account). In some embodiments, the plurality of selectable user interface options includes a first selectable option (e.g., 1856a and/or 1956a) for applying (e.g., without further user input and/or after reviewing/approving relevant requirements and terms) the future (and/or, optionally, accumulated) rewards of the first asset account to a second asset account (e.g., a stored-value account, a memory account for readily storing content, a debit account, and/or a spending account). In some embodiments, the computer system is configured to perform (e.g., when authorized by a user of the computer system, such as through a passcode or biometric authentication), using near-field communication via the one or more communication radios, transfers (e.g., transfer of memory allocation, transfer of funds or payment information, transfer of loyalty card information, and/or transfers of non-payment information) using the second asset account (and, accordingly, rewards accumulated using the first account and applied to the second asset account) that is different from the first asset account. In some embodiments, the plurality of selectable user interface options includes a second selectable option (e.g., 1856c, 1956c) for applying (e.g., without further user input and/or after reviewing/approving relevant requirements and terms) the future (and/or, optionally, accumulated) rewards of the first asset account to a third asset account (e.g., an investment account, an account used for investing in assets (e.g., memory allocation types, stocks, and/or bonds) and/or an account where the quantity of assets appreciate/depreciate based on supply/demand) that is different from the first asset account and the second asset account.

In some embodiments, the computer system receives (2004), via the one or more input devices (e.g., 1802 and/or 1902), a first user input (e.g., 1905d and/or 1907d) (e.g., a tap input, a swipe input, and/or a voice input) selecting one of the plurality of selectable user interface options for applying future (and/or, optionally, accumulated) rewards of the first asset account to a respective asset account.

In some embodiments, in response (2006) to receiving the first user input selecting one of the plurality of selectable user interface options, in accordance with a determination that the first user input corresponds to selection of the first selectable option, the computer system initiates (2008) a process for applying future rewards (and/or, optionally, accumulated) of the first asset account to the second asset account (without applying the accumulated and/or future rewards of the first asset account to the third asset account). In some embodiments, in response to receiving the first user input selecting one of the plurality of selectable user interface options, in accordance with a determination that the first user input corresponds to selection of the second selectable option, the computer system initiates (2010) a process for applying future (and/or, optionally, accumulated) rewards of the first asset account to the third asset account (without applying the accumulated and/or future rewards of the first asset account to the second asset account).

In some embodiments, subsequent to completing the process for applying future rewards of the first asset account to the respective account (e.g., the second asset account or the third asset account), the computer system performs (2012), using near-field communication via the one or more communication radios, a transfer (e.g., transfer of memory allocation, transfer of funds or payment information, transfer of loyalty card information, and/or transfers of non-payment information) using the first asset account. In some embodiments, a reward based on (e.g., a percentage of and/or a fixed amount) the transfer using the first asset account is applied to the respective (user-selected) account (e.g., the second asset account or the third asset account).

In some embodiments, the computer system displays (2014), via the display generation component (e.g., as part of a user interface of an electronic wallet application), a balance (e.g., as indicated by 1856a, 1856b, 1856c, 1956a, 1956b, 1956c, 1982, 1942A) (e.g., storage, funds, and/or points) of the respective account that includes the applied reward.

In some embodiments, the first asset account, the second asset account, and/or the third asset accounts are accounts that have been provisioned onto an electronic wallet of the computer system. In some embodiments, the transfer using the first asset account is performed at a merchant using a transfer card (e.g., a debit card, a credit card, and/or memory allocation card) (e.g., presented to a merchant), rather than using near-field communication. In some embodiments, asset accounts belong to a user of the computer system and/or are provisioned onto the computer system. In some embodiments, one or more details of the provisioned asset accounts are stored in a secure element of the computer system as part of the provisioning process. In some embodiments, a secure element is a hardware component (e.g., a secure microcontroller chip) (e.g., of the computer system) configured to securely store data or an algorithm such that the securely stored data is not accessible by the computer system without proper authentication information from a user of the computer system. Keeping the securely stored data in a secure element that is separate from other storage on the computer system prevents access to the securely stored data even if other storage locations on the computer system are compromised (e.g., by malicious code or other attempts to compromise information stored on the computer system). In some embodiments, the secure element provides (or releases) account information (e.g., an account number and/or a transaction-specific dynamic security code). In some examples, the secure element provides (or releases) the account information in response to the computer system receiving authorization, such as a user authentication (e.g., biometric authentication (e.g., fingerprint authentication; facial authentication; iris authentication; passcode authentication)). In some embodiments, the released account information is transferred or transmitted to perform a transfer (e.g., a transfer of assets).

Displaying an updated account balance that includes the applied reward provides the user with visual feedback about the state of the computer system and the account, thereby providing improved visual feedback.

In some embodiments, displaying the plurality of selectable user interface options for applying future rewards of the first asset account includes displaying, via the display generation component and concurrently with the first selectable option and the second selectable option, a third selectable option (e.g., 1856b, 1956b) for applying (e.g., without further user input and/or after reviewing/approving relevant requirements and terms) the future (and/or, optionally, accumulated) rewards of the first asset account to a fourth asset account (e.g., a savings account, an account used for saving assets (e.g., memory allocation types and/or funds) and/or an account where interest is paid by an institution (e.g., a merchant, a vendor, and/or a bank) based on the assets in the fourth asset account) that is different from the first asset account, the second asset account, and the third asset account. In some embodiments, in response to receiving the first user input selecting one of the plurality of selectable user interface options, in accordance with a determination that the first user input corresponds to selection of the third selectable option, the computer system initiates a process for applying future rewards (and/or, optionally, accumulated) of the first asset account to the fourth asset account (without applying the accumulated and/or future rewards of the first asset account to the second or third asset account). Automatically applying future rewards to the fourth asset account enables the computer system to perform the operation without requiring additional user input, thereby reducing the number of required inputs.

In some embodiments, the second asset account accrues interest over time (e.g., weekly, monthly, and/or yearly) at a first rate (e.g., 0%, 2%, or 4%) and the fourth asset account accrues interest over time (e.g., weekly, month, and/or yearly) at a second rate (e.g., non-zero, 0.05%, 1%, or 5%) that is different from the first rate. Different accounts having different interest rates provides the user with different selection options, thereby improving the man-machine interface.

In some embodiments, subsequent to completing the process for applying future rewards of the first asset account to the respective account (e.g., the second asset account or the third asset account), the computer system performs (e.g., using near-field communication via the one or more communication radios and/or using an in-application process that does not use near-field communication), a transfer (e.g., transfer of memory allocation, transfer of funds or payment information, transfer of loyalty card information, and/or transfers of non-payment information) using a fifth asset account that is provisioned onto the electronic wallet (e.g., corresponding to interface 1910) of the computer system and that is different from the first asset account, the second asset account, the third asset account, and the fourth asset account. In some embodiments, no reward based on (e.g., a percentage of and/or a fixed amount) the transfer using the fifth asset account is applied to the respective (user-selected) account (e.g., to the second asset account, the third asset account, or the fourth asset account). In some embodiments, the fifth asset account has been provisioned onto the electronic wallet of the computer system. Not applying a reward based on a transfer using the fifth asset account provides the user with feedback that the fifth asset account does not earn rewards, thereby providing improved user feedback.

In some embodiments, the computer system concurrently displays, via the display generation component, a portion (e.g., all or less than all) of a first visual representation (e.g., 1912a-1912c) corresponding to the second asset account that has been provisioned onto an electronic wallet of the computer system and a portion of a second visual representation (e.g., 1912a-1912c) different from the first visual representation, corresponding to a sixth asset account (e.g., a memory asset account, a debit account, a credit card, and/or the same as the fifth asset account) that has been provisioned onto the electronic wallet of the computer system and that is different from the second asset account. In some embodiments, the portion of the first visual representation and the portion of the second visual representation are displayed as part of an electronic wallet application of the computer system. In some embodiments, while concurrently displaying the portion of the first visual representation and the portion of the second visual representation, the computer system receives, via the one or more input devices, a selection input (e.g., 1905a and/or 1907b) (e.g., via a tap input on and/or via a press-and-hold on). In some embodiments, in response to receiving the selection input, in accordance with a determination that the selection input corresponds to selection of the first visual representation corresponding to the second asset account, the computer system concurrently displays, via the display generation component: a representation of the second asset account (e.g., 1856a, 1956a) that indicates an asset balance of the second asset account, a representation of the third asset account (e.g., 1856c, 1956c) that indicates an asset balance of the third asset account, and a representation of the fourth asset account (e.g., 1856b, 1956b) that indicates an asset balance of the fourth asset account. In some embodiments, in response to receiving the selection input, in accordance with a determination that the selection input corresponds to selection of the second visual representation corresponding to the sixth asset account, the computer system forgoes display of the asset balance for the second asset account, the asset balance for the third asset account, and the asset balance for the fourth asset account. In some embodiments, in response to receiving the selection input and in accordance with a determination that the selection input corresponds to selection of the first visual representation corresponding to the second asset account, the computer system concurrently displays, via the display generation component, the representation of the second asset account that indicates an asset balance of the second asset account with one of (and not both of) the representations of the third and fourth asset accounts. Concurrently displaying balances of multiple accounts provides the user with visual feedback about the status of those accounts, thereby providing improved visual feedback while reducing the number of inputs required to see the balances.

In some embodiments, while concurrently displaying the representation of the second asset account, the representation of the third asset account, and the representation of the fourth asset account, the computer system receives, via the one or more input devices, a second selection input (e.g., selection of 1956a, 1905d, 1907d). In some embodiments, in response to receiving the second selection input, in accordance with a determination that the second selection input corresponds to the representation of the second asset account, the computer system displays, via the display generation component, additional information (e.g., historical balance over time, interest rate information, and/or history of transactions) about the second asset account without displaying additional information about the third asset account and without displaying additional information about the fourth asset account. In some embodiments, in response to receiving the second selection input, in accordance with a determination that the second selection input corresponds to the representation of the third asset account, the computer system displays, via the display generation component, additional information (e.g., 1982, 1984a) (e.g., historical balance over time, interest rate information, and/or history of transactions) about the third asset account without displaying additional information about the second asset account and without displaying additional information about the fourth asset account. In some embodiments, in response to receiving the second selection input, in accordance with a determination that the second selection input corresponds to the representation of the fourth asset account, the computer system displays, via the display generation component, additional information (e.g., 1942A, 1944A) (e.g., historical balance over time, interest rate information, and/or history of transactions) about the fourth asset account without displaying additional information about the second asset account and without displaying additional information about the third asset account. Displaying additional information about a respective account provides the user with additional visual details about the account, thereby providing improved user feedback.

In some embodiments, in accordance with a determination that the fourth asset account is not open (e.g., has not been opened or is closed), the computer system initiates a process to open the fourth asset account (e.g., through a merchant, vendor, and/or bank) (e.g., without initiating process to open the second or third asset accounts). In some embodiments, the process to open the fourth asset account includes receiving information entered from the user (e.g., legal name and/or mailing address). Automatically initiating a process to open the fourth asset account when the fourth asset account hasn't been previously opened provides the user with feedback about the status of the fourth asset account and reduces the number of user inputs required to open the account.

In some embodiments, subsequent to initiating the process to open the fourth asset account, the computer system displays, via the display generation component, an option (e.g., 1972) to transfer (e.g., all or less than all) assets from the second asset account to the fourth asset account. Displaying an option to transfer assets from the second asset account to the fourth asset account enables the user to quickly make the transfer without the need to navigate a cumbersome hierarchy of menus, thereby reducing the number of user inputs required.

In some embodiments, initiating the process for applying future rewards of the first asset account to the third asset account includes, in accordance with a determination that the third asset account is not open (e.g., has not been opened or is closed), initiating a process to open the third asset account (e.g., through a merchant, vendor, and/or broker) (e.g., without initiating process to open the second or fourth asset accounts). In some embodiments, the process to open the third asset account includes receiving information entered from the user (e.g., legal name and/or mailing address). Automatically initiating a process to open the third asset account when the third asset account hasn't been previously opened provides the user with feedback about the status of the third asset account and reduces the number of user inputs required to open the account.

In some embodiments, subsequent to initiating the process to open the third asset account, the computer system displays, via the display generation component, a user interface (e.g., 1910A) for selecting an investment (e.g., selecting a mutual fund and/or stock) for investing in the third asset account. In some embodiments, the computer system receives uses input identifying an investment (e.g., a mutual fund and/or stock) for investing in the third asset account and rewards directed to the third asset account are automatically invested in the selected investment. Displaying a user interface to select an investment for investing enables the user to make the selection without the need to navigate a cumbersome hierarchy of menus, thereby reducing the number of user inputs required.

In some embodiments, subsequent to initiating the process to open the third asset account, the computer system displays, via the display generation component, an option to transfer (e.g., all or less than all) assets from the second asset account to the third asset account (and, optionally, automatically using those assets to purchase the selected investment). Displaying an option to transfer assets enables the user to initiate the transfer of the assets, thereby improving the man-machine interface.

In some embodiments, the computer system displays, via the display generation component, a user interface (e.g., 1970) for transferring funds between an asset account (e.g., the first asset account, a storage account, and/or a bank account) (e.g., different from the first asset account) and the fourth asset account (e.g., a savings account, an account used for saving assets (e.g., memory allocation types and/or funds) and/or an account where interest is paid by an institution (e.g., a merchant, a vendor, and/or a bank) based on the assets in the fourth asset account) (or the second asset account, or the third asset account). In some embodiments, while displaying the user interface for transferring funds, the computer system receives, via the one or more input devices, user input specifying an amount of funds to transfer. In some embodiments, subsequent to receiving the user input specifying the amount of funds to transfer and in response to receiving user authorization, the computer system transfers the specified amount of funds between (e.g., out of the second, third, or fourth asset account or into the second, third, or fourth asset account) the asset account and the fourth asset account. Transferring a specified amount of funds between asset accounts enables the user to control the location of funds, thereby providing an improved man-machine interface.

Note that details of the processes described above with respect to method 2000 (e.g., FIG. 20) are also applicable in an analogous manner to the methods described above. For example, method 2000 optionally includes one or more of the characteristics of the various methods described above with reference to method 700. For example, a transfer account interface used to assign a virtual account number, as described with respect to method 700, may be also used to access a rewards interface for selecting an election option, as described with respect to method 2000. For brevity, these details are not repeated below.

FIG. 21 is a flow diagram illustrating a method for managing rewards for an account using a computer system in accordance with some embodiments. Method 2100 is performed at a computer system (e.g., 100, 300, 500, 1800, and/or 1900) (e.g., a smart watch, a smart phone, a head mounted device (e.g., a head mounted augmented reality and/or extended reality device), a self-motive device and/or system, and/or a personal computer) that is in communication with a display generation component (e.g., 1802, 1902) (e.g., an integrated display, a head mounted display system, and/or a display controller), and one or more communication radios (e.g., near-field communication radio and/or short-range communication radio). Some operations in method 2100 are, optionally, combined, the orders of some operations are, optionally, changed, and some operations are, optionally, omitted.

As described below, method 2100 provides an intuitive way for managing rewards for an account. The method reduces the cognitive burden on a user for managing rewards for an account, thereby creating a more efficient human-machine interface. For battery-operated computing devices, enabling a user to manage rewards faster and more efficiently conserves power and increases the time between battery charges.

In some embodiments, the computer system concurrently displays (2102) (e.g., as part of an electronic wallet application that includes one or more asset accounts of an electronic wallet of the computer system), via the display generation component, a total amount of lifetime reward (2104) (e.g., 1852a, 1952a) received for a first asset account. In some embodiments, the first asset account (e.g., a memory allocation account, a printing allocation account, a transit system account, a payment account, or a store loyalty account) and a second asset account (e.g., a memory allocation account, a printing allocation account, a transit system account, a payment account, or a store loyalty account) have been provisioned onto an electronic wallet of the computer system. In some embodiments, the computer system concurrently displays (e.g., as part of an electronic wallet application that includes one or more asset accounts of an electronic wallet of the computer system), via the display generation component and with the total amount of lifetime reward, a visual object (2106) (e.g., 1854, 1954) (e.g., a bar, a line, a rectangle, and/or a disc) corresponding to the total amount of lifetime reward received for the first asset account. In some embodiments, a first portion (e.g., 1854a-1854d, 1954a-1954d) of the visual object that corresponds to a first type of reward received for the first asset account is visually differentiated from a second portion (e.g., 1854a-1854d, 1954a-1954d) of the visual object that corresponds to a second type of reward received for the first asset account. In some embodiments, an area of the first portion of the visual object is a first size that is based on an amount of the first type of reward received relative to the total amount of lifetime reward received for the first asset account. In some embodiments, an area of the second portion of the visual object is a second size that is based on an amount of the second type of reward received relative to the total amount of lifetime reward received for the first asset account.

In some embodiments, subsequent (2108) to concurrently displaying the total amount of lifetime reward received for the first asset account and the visual object (e.g., a bar, a line, a rectangle, and/or a disc) corresponding to the total amount of lifetime reward received for the first asset account, the computer system performs (2110), via the one or more communication radios (e.g., using short-range communication and/or near-field communication), a first transfer (e.g., a transfer of memory allocation or a transfer of funds) using the first asset account. In some embodiments, subsequent (2108) to concurrently displaying the total amount of lifetime reward received for the first asset account and the visual object (e.g., a bar, a line, a rectangle, and/or a disc) corresponding to the total amount of lifetime reward received for the first asset account, the computer system performs (2112), via the one or more communication radios (e.g., using short-range communication and/or near-field communication), a second transfer (e.g., a transfer of memory allocation or a transfer of funds) using the second asset account.

In some embodiments, subsequent to performing the first transfer and the second transfer, the computer system concurrently displays (2114) (e.g., as part of an electronic wallet application that includes one or more asset accounts of an electronic wallet of the computer system), via the display generation component, the total amount of lifetime reward (2116) received for the first asset account. In some embodiments, the total amount of lifetime reward is updated to include a reward received based on the first transfer without including any reward received based on the second transfer (e.g., the updated total amount of lifetime reward received for the first asset account does not include reward information corresponding to transfers using the second asset account).

In some embodiments, subsequent to performing the first transfer and the second transfer, the computer system concurrently displays (2114) (e.g., as part of an electronic wallet application that includes one or more asset accounts of an electronic wallet of the computer system), via the display generation component, the visual object (2118) (e.g., a bar, a line, a rectangle, and/or a disc) corresponding to the updated total amount of lifetime reward received for the first asset account (e.g., as shown in FIG. 19T). In some embodiments, the area of the first portion of the visual object is updated to a third size that is larger than the first size, the third size being based on the reward received based on the first transfer corresponding to the first type of reward. In some embodiments, the area of the second portion of the visual object is updated to a fourth size that is smaller than the second size, the fourth size being based on the reward received based on the first transfer not corresponding to the second type of reward. Displaying a total amount of lifetime reward received for the first asset account provides the user with visual feedback about the state of the computer system and the first asset account, thereby providing improved visual feedback.

In some embodiments, one or more details of provisioned asset accounts are stored in a secure element of the computer system as part of the provisioning process. In some embodiments, a secure element is a hardware component (e.g., a secure microcontroller chip) (e.g., of the computer system) configured to securely store data or an algorithm such that the securely stored data is not accessible by the computer system without proper authentication information from a user of the computer system. Keeping the securely stored data in a secure element that is separate from other storage on the computer system prevents access to the securely stored data even if other storage locations on the computer system are compromised (e.g., by malicious code or other attempts to compromise information stored on the computer system). In some embodiments, the secure element provides (or releases) account information (e.g., an account number and/or a transaction-specific dynamic security code). In some examples, the secure element provides (or releases) the account information in response to the computer system receiving authorization, such as a user authentication (e.g., biometric authentication (e.g., fingerprint authentication; facial authentication; iris authentication; passcode authentication)). In some embodiments, the released account information is transferred or transmitted to perform a transfer (e.g., a transfer of assets). In some embodiments, lifetime describes the lifetime of the first asset account (e.g., the complete duration for which the first asset account has been active, which may span weeks, months, and/or years). In some embodiments, the rewards received for the first asset account are applied to another account, such as a second or third transfer account.

In some embodiments, visually differentiating the first portion of the visual object from the second portion of the visual object includes displaying the first portion of the visual object with a first color and the second portion of the visual object with a second color that is different from the first color. In some embodiments, the first portion of the visual object is differentiated from the second portion of the visual object using a visual characteristic (e.g., pattern and/or shape) that is different from color. Differentiating different portions of the visual object using colors provides the user with a visuals means to understand the types of received rewards, thereby providing the user with improved visual feedback.

In some embodiments, a transition from the first portion of the visual object and the second portion of the visual object is a third color, different from the first color and the second color, that is a combination (e.g., blending and/or mixing) of the first color and the second color. Displaying a transition that uses a third (different) color enables the user to better recognize the transition between the first portion and the second portion, thereby providing improved visual feedback.

In some embodiments, the first type of reward received for the first asset account is a percentage-based reward (e.g., 1%, 2%, or 3% of transfers using another account) and the second type of reward received for the first asset account is not a percentage-based reward (e.g., is a predefined amount and/or an amount that is independent of the amount of transfer using the other account). Displaying the visual breakdown of the different types of rewards that are percentage-based and are not percentage based provides the user with feedback about the types of rewards received, thereby providing improved visual feedback.

In some embodiments, the computer system displays, via the display generation component and concurrently with the total amount of lifetime reward received for the first asset account and the visual object corresponding to the updated total amount of lifetime reward received for the first asset account, an amount of reward received for the first asset account for a first period (e.g., 1852c, 1952c) (e.g., the current month or the current year) that is less than the lifetime of the first asset account. Displaying an amount of reward received for the first asset account for a period that is less than the lifetime of the first asset account provides the user with feedback about rewards received during that period, thereby providing improved visual feedback.

In some embodiments, the computer system displays, via the display generation component and concurrently with the total amount of lifetime reward received for the first asset account, the visual object corresponding to the updated total amount of lifetime reward received for the first asset account, and the amount of reward received for the first asset account for the first period, an amount of reward received for the first asset account for a second period (e.g., 1852b, 1952b) (e.g., the current week or the current month) that is less than the first period (e.g., is shorter than the first period and/or is a subset of and less than the first period). Displaying an amount of reward received for the first asset account for a period that is less than the lifetime of the first asset account provides the user with feedback about rewards received during that period, thereby providing improved visual feedback.

In some embodiment, the computer system displays, via the display generation component and concurrently with the total amount of lifetime reward received for the first asset account and the visual object corresponding to the updated total amount of lifetime reward received for the first asset account, an indication (e.g., 1957) corresponding to directions for meeting conditions to get additional rewards for the first asset account. In some embodiments, the indication includes the directions. In some embodiments, the computer system displays the directions in response to receiving user selection of the indication (without including the directions in the indication). In some embodiments, the directions for meeting conditions to get additional rewards includes performing a plurality of tasks, each task of the plurality of tasks represented by a location on a virtual punch card (e.g., displayed with the directions or displayed separate from the directions). In some embodiments, the directions for meeting conditions to get additional rewards includes downloading and/or installing a specific application on the computer system. In some embodiments, the computer system provides a link that initiates the downloading and/or installing of the specific application. Displaying indication corresponding to directions for meeting conditions to get additional rewards for the first asset account provides the user with feedback about the conditions, thereby providing improved visual feedback.

In some embodiments, the computer system displays, via the display generation component and concurrently with the total amount of lifetime reward received for the first asset account and the visual object corresponding to the updated total amount of lifetime reward received for the first asset account, representations of a first plurality (e.g., 3, 5, or 7) of merchants offering enhanced rewards (e.g., 1958, 1958a-1958c) (e.g., higher percentage (e.g., 2.5% or 3%) than typical/average and/or bonus fixed amounts) for the first asset account. In some embodiments, the indication includes a portion of the listing of merchants. In some embodiments, the computer system displays a portion of the listing of the merchants in response to receiving user selection of the indication (without including the portion of the listing of merchants in the indication). Displaying representations of merchants offering enhanced rewards provides the user with feedback about which merchants are offering the enhanced rewards, thereby providing improved visual feedback.

In some embodiments, the computer system displays, via the display generation component and concurrently with the total amount of lifetime reward received for the first asset account, the visual object corresponding to the updated total amount of lifetime reward received for the first asset account, and the representations of a first plurality (e.g., 3, 5, or 7) of merchants, an option (e.g., 1959) to access representations of a second plurality of merchants offering the enhanced rewards for the first asset account. In some embodiments, the first plurality of merchants is a subset that is less than the second plurality of merchants. In some embodiments, the computer system receives, via the one or more input devices, selection of the option to access representations of the second plurality of merchants. In some embodiments, in response to receiving selection of the option to access representations of the second plurality of merchants, the computer system displays, via the display generation component, a merchants user interface (e.g., 1950A) that includes (e.g., in alphabetical order, in geographical order, and/or in order of products/services sold) the second plurality of merchants offering enhanced rewards (e.g., higher percentage (e.g., 2.5% or 3%) than typical/average and/or bonus fixed amounts) for the first asset account. Displaying representations of merchants offering enhanced rewards provides the user with feedback about which merchants are offering the enhanced rewards, thereby providing improved visual feedback.

In some embodiments, the computer system displays, via the display generation component and as part of an application for an electronic wallet of the computer system, representations (e.g., 1922) of a plurality of transfers performed using the first transfer account, including a first representation (e.g., 1922b, 1922c) of a first transfer of the plurality of transfers. In some embodiments, in accordance with a determination that the first transfer resulted in a percentage-based reward, the computer system displays an indication (e.g., 1922cb) of the percentage (e.g., 1%, 2%, or 3%) of the reward as part of the first representation. In some embodiments, in accordance with a determination that the first transfer did not result in a percentage-based reward, forgoing display of the indication of the percentage of the reward (e.g., 1%, 2%, or 3%) as part of the first representation. In some embodiments, in accordance with a determination that the first transfer resulted in an enhanced reward, the computer system displays an indication (e.g., 1922ca) of the enhanced reward as part of the first representation (e.g., concurrently with the indication of the percentage of the reward). In some embodiments, in accordance with a determination that the first transfer did not result in an enhanced reward, the computer system forgoes display of the indication of the enhanced reward as part of the first representation. In some embodiments, the first representation includes an amount of the transfer, an indication of the date of the transfer, the name of the merchant, and/or an image corresponding to the merchant. Displaying indication of the enhanced reward as part of a transaction list for transactions with the enhanced reward provides the user with feedback about transactions earned enhanced rewards, thereby providing improved visual feedback.

In some embodiments, the computer system receives, via the one or more input devices, selection (e.g., 19050) of an option (e.g., 1962A) to initiate a transfer to a merchant. In some embodiments, in response to receiving selection of the option to initiate the transfer using the first transfer account, the computer system displays, via the display generation component, a transfer user interface (e.g., 1970A) that includes an indicate that the first transfer account is selected for use in the transfer. In some embodiments, in accordance with a determination that the transfer to the merchant will result in a reward of a first predetermined percentage (e.g., 3%), the transfer user interface includes an indication (e.g., as shown in 1972Aa) of the first predetermined percentage (without including an indication of the second predetermined percentage). In some embodiments, in accordance with a determination that the transfer to the merchant will result in a reward of a second predetermined percentage (e.g., 1% or 2%) that is different from the first predetermined percentage, the transfer user interface does not include an indication of the second predetermined percentage (or the first predetermined percentage). Displaying indications of percentages of rewards for particular merchants provides the user with feedback about enhanced rewards, thereby providing improved visual feedback.

In some embodiments, in accordance with a determination that the transfer to the merchant will result in a reward of the second predetermined percentage (e.g., 1% or 2%) that is different from the first predetermined percentage, the computer system displays, via the display generation component and as part of the transfer user interface, a balance for a third asset account (e.g., a stored-value account, a memory account for readily storing content, a debit account, and/or a spending account) that is different from the first asset account. In some embodiments, in accordance with a determination that the transfer to the merchant will result in a reward of a first predetermined percentage (e.g., 3%), the computer system forgoes display of the balance for the third asset account. Displaying indications of percentages of rewards for particular merchants provides the user with feedback about enhanced rewards, thereby providing improved visual feedback.

Note that details of the processes described above with respect to method 2100 (e.g., FIG. 21) are also applicable in an analogous manner to the methods described above. For example, method 2100 optionally includes one or more of the characteristics of the various methods described above with reference to method 2000. For example, a rewards interface used to select an election option, as described with respect to method 2000, may be further be used to access offers provided by merchants, as described with respect to method 2100. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the case of use of accounts. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to present account information to the user. Accordingly, use of such personal information data enables users to better review their account information. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of accounts on an electronic device, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, accounts can be presented to users by inferring preferences based on non-personal information data or a bare minimum amount of personal information, such as the content being requested by the device associated with a user, other non-personal information available to the account management services, or publicly available information.

What is claimed is:

1. A computer system configured to communicate with a display generation component, one or more input devices, and one or more communication radios, comprising:
one or more processors; and
memory storing one or more programs configured to be executed by the one or more processors, the one or more programs including instructions for:
displaying, via the display generation component, a user interface of an electronic wallet application that includes concurrent display of a plurality of selectable user interface objects, including:
a first selectable user interface object that corresponds to a first account that is provisioned onto an electronic wallet of the computer system, wherein the computer system is configured to perform, using near-field communication via the one or more communication radios, transfers using the first account;
a second selectable user interface object that corresponds to a second account, different from the first account, that is provisioned onto the electronic wallet of the computer system, wherein the computer system is configured to perform, using near-field communication via the one or more communication radios, transfers using the second account; and
an order tracking user interface object for tracking order statuses;
receiving a first user input selecting one of the plurality of selectable user interface objects;
in response to receiving the first user input selecting one of the plurality of selectable user interface objects:
in accordance with a determination that the first user input corresponds to selection of the first selectable user interface object, ceasing to display the second selectable user interface object and displaying, via the display generation component, information about one or more transfers performed using the first account; and
in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant;
while displaying the plurality of summaries of orders, receiving, via the one or more input devices, a second user input selecting one of the plurality of summaries of orders; and
in response to receiving the second user input selecting one of the plurality of summaries of orders:
in accordance with a determination that the second user input corresponds to selection of the first summary of the first order, displaying, via the display generation component and using a predefined arrangement, order tracking details of the first order; and
in accordance with a determination that the second user input corresponds to selection of the second summary of the second order, displaying, via the display generation component and using the predefined arrangement, order tracking details of the second order.

2. The computer system of claim 1, the one or more programs further including instructions for:
prior to displaying the plurality of summaries of orders that includes the first summary of the first order from the first merchant and the second summary of the second order from the second merchant:
transmitting, via a website of the first merchant or an application of the first merchant, a request to place the first order; and
transmitting, via a website of the second merchant or an application of the second merchant, a request to place the second order.

3. The computer system of claim 1, wherein:
displaying the order tracking details of the first order includes displaying a first amount transferred to the first merchant as part of the first order; and
displaying the order tracking details of the second order includes displaying a second amount transferred to the second merchant as part of the second order.

4. The computer system of claim 1, wherein:
displaying the order tracking details of the first order includes displaying indications of one or more items of the first order; and
displaying the order tracking details of the second order includes displaying indications of one or more items of the second order.

5. The computer system of claim 1, the one or more programs further including instructions for:
prior to displaying the plurality of summaries of orders that includes the first summary of the first order from the first merchant and the second summary of the second order from the second merchant:
transferring credentials of the first account to place the first order; and
transmitting credentials of the second account to place the second order.

6. The computer system of claim 1, wherein:
displaying the order tracking details of the first order includes displaying a first visual indication of a status of the first order, including:
in accordance with a determination that the status of the first order is a first status, displaying, via the display generation component, the first visual indication of the status of the first order at a first location of a user interface of the order tracking details of the first order; and
in accordance with a determination that the status of the first order is a second status, displaying, via the display generation component, the first visual indication of the status of the first order at a second location of the user interface of the order tracking details of the first order.

7. The computer system of claim 6, wherein the first visual indication is sequentially displayed at a plurality of predefined locations along a predefined path, wherein the plurality of predefined locations along the predefined path correspond to a plurality of statuses for completion of the first order.

8. The computer system of claim 7, wherein displaying the order tracking details of the first order includes:
displaying, via the display generation component, a plurality of indications at the predefined locations along the predefined path, wherein the plurality of indications correspond to a plurality of statuses for completion of the first order.

9. The computer system of claim 7, wherein displaying the order tracking details of the first order includes:
displaying, via the display generation component, a representation of the predefined path that includes:
a first visual appearance for a first portion of the predefined path corresponding to one or more order statuses that have been achieved for the first order, and
a second visual appearance, different from the first visual appearance, for a second portion of the predefined path, different from the first portion of the predefined path, corresponding to one or more order statuses that to be achieved for completion of the first order.

10. The computer system of claim 6, wherein:
displaying the first visual indication of the status of the first order includes:
in accordance with a determination that the status of the first order is one of a first plurality of statuses, displaying, via the display generation component, the first visual indication of the status of the first order with a first appearance; and
in accordance with a determination that the status of the first order is not one of the first plurality of statuses, displaying, via the display generation component, the first visual indication of the status of the first order with a second appearance that is different from the first appearance.

11. The computer system of claim 1, the one or more programs further including instructions for:
receiving status information associated with the first order;
in response to receiving the status information associated with the first order, displaying, via the display generation component, a notification based on the status information;
receiving, via the one or more input devices, selection of the notification; and
in response to receiving selection of the notification, displaying, via the display generation component and using the predefined arrangement, the order tracking details of the first order.

12. The computer system of claim 1, wherein the plurality of selectable user interface objects, displayed via the display generation component as part of the user interface of the electronic wallet application, includes a second order tracking user interface object, different from the order tracking user interface object, for tracking order statuses, and the one or more programs further include instructions for:
receiving, via the one or more input devices, selection of the second order tracking user interface object; and
in response to receiving selection of the second order tracking user interface object, displaying, via the display generation component, the plurality of summaries of orders, including the first summary of the first order from the first merchant and the second summary of the second order from the second merchant that is different from the first merchant.

13. The computer system of claim 1, wherein:
displaying the order tracking details of the first order includes displaying a first order identifier of the first order; and
displaying the order tracking details of the second order includes displaying a second order identifier of the second order that is different from the first order identifier of the first order.

14. The computer system of claim 1, wherein:
displaying the order tracking details of the first order includes a shipping address of a shipment of the first order. In some embodiments, the order tracking details of the first order includes a shipping tracking identifier.

15. The computer system of claim 1, wherein displaying the order tracking details of the first order includes an order management option, and the one or more programs further include instructions for:
receiving, via the one or more input devices, selection of the order management option; and
in response to receiving selection of the order management option, displaying, via the display generation component, an option to initiate a process to cancel the first order.

16. The computer system of claim 1, wherein displaying the first summary of the first order from the first merchant includes:
displaying, via the display generation component, an indication of the first merchant and an order status of the first order.

17. The computer system of claim 1, the one or more programs further including instructions for:
in response to receiving the first user input selecting one of the plurality of selectable user interface objects and in accordance with the determination that the first user input corresponds to selection of the order tracking user interface object, displaying, via the display generation component and concurrently with the plurality of summaries of orders, a search option;
receiving, via the one or more input devices, entry of a search phrase into the search option; and
in response to receiving entry of the search phrase into the search option, displaying, via the display generation component, search results that include a plurality of summaries of orders, including a respective order from the first merchant and a respective order from the second merchant.

18. The computer system of claim 1, wherein an arrangement of the plurality of summaries of orders is not based on a time of receipt of respective notifications of statuses of the respective orders and the arrangement of the plurality of summaries of orders is not based on a time of transmission of respective notifications of status of the respective orders.

19. The computer system of claim 1, wherein an arrangement of the plurality of summaries of orders is based on respective statuses of the respective orders.

20. A non-transitory computer-readable storage medium storing one or more programs configured to be executed by one or more processors of a computer system that is in communication with a display generation component, one or more input devices, and one or more communication radios, the one or more programs including instructions for:
displaying, via the display generation component, a user interface of an electronic wallet application that includes concurrent display of a plurality of selectable user interface objects, including:
a first selectable user interface object that corresponds to a first account that is provisioned onto an electronic wallet of the computer system, wherein the computer system is configured to perform, using near-field communication via the one or more communication radios, transfers using the first account;
a second selectable user interface object that corresponds to a second account, different from the first account, that is provisioned onto the electronic wallet of the computer system, wherein the computer system is configured to perform, using near-field communication via the one or more communication radios, transfers using the second account; and
an order tracking user interface object for tracking order statuses;
receiving a first user input selecting one of the plurality of selectable user interface objects;
in response to receiving the first user input selecting one of the plurality of selectable user interface objects:
in accordance with a determination that the first user input corresponds to selection of the first selectable user interface object, ceasing to display the second selectable user interface object and displaying, via the display generation component, information about one or more transfers performed using the first account; and
in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant;
while displaying the plurality of summaries of orders, receiving, via the one or more input devices, a second user input selecting one of the plurality of summaries of orders; and
in response to receiving the second user input selecting one of the plurality of summaries of orders:
in accordance with a determination that the second user input corresponds to selection of the first summary of the first order, displaying, via the display generation component and using a predefined arrangement, order tracking details of the first order; and
in accordance with a determination that the second user input corresponds to selection of the second summary of the second order, displaying, via the display generation component and using the predefined arrangement, order tracking details of the second order.

21. A method, comprising:
at a computer system that is in communication with a display generation component, one or more input devices, and one or more communication radios:
displaying, via the display generation component, a user interface of an electronic wallet application that includes concurrent display of a plurality of selectable user interface objects, including:
a first selectable user interface object that corresponds to a first account that is provisioned onto an electronic wallet of the computer system, wherein the computer system is configured to perform, using near-field communication via the one or more communication radios, transfers using the first account;
a second selectable user interface object that corresponds to a second account, different from the first account, that is provisioned onto the electronic wallet of the computer system, wherein the computer system is configured to perform, using near-field communication via the one or more communication radios, transfers using the second account; and
an order tracking user interface object for tracking order statuses;
receiving a first user input selecting one of the plurality of selectable user interface objects;
in response to receiving the first user input selecting one of the plurality of selectable user interface objects:
in accordance with a determination that the first user input corresponds to selection of the first selectable user interface object, ceasing to display the second selectable user interface object and displaying, via the display generation component, information about one or more transfers performed using the first account; and
in accordance with a determination that the first user input corresponds to selection of the order tracking user interface object, displaying, via the display generation component, a plurality of summaries of orders, including a first summary of a first order from a first merchant and a second summary of a second order from a second merchant that is different from the first merchant;
while displaying the plurality of summaries of orders, receiving, via the one or more input devices, a second user input selecting one of the plurality of summaries of orders; and
in response to receiving the second user input selecting one of the plurality of summaries of orders:
in accordance with a determination that the second user input corresponds to selection of the first summary of the first order, displaying, via the display generation component and using a predefined arrangement, order tracking details of the first order; and
in accordance with a determination that the second user input corresponds to selection of the second summary of the second order, displaying, via the display generation component and using the predefined arrangement, order tracking details of the second order.
